(19) United States
(12) Patent Application Publication
(10) Pub. No.: US 2025/0033482 A1
(43) Pub. Date: Jan. 30, 2025

(54) RANGE EXTENDING METHOD AND APPARATUS FOR EVS

(71) Applicant: Nathalie Athena Safwat, Kailua Kona, HI (US)

(72) Inventor: Nathalie Athena Safwat, Kailua Kona, HI (US)

(21) Appl. No.: 18/715,733

(22) PCT Filed: Dec. 9, 2022
(86) PCT No.: PCT/US2022/081315

§ 371 Date: Jun. 3, 2024

Related U.S. Application Data
(60) Provisional application No. 63/287,970, filed on Dec. 9, 2021.
(60) Provisional application No. 63/314,358, filed on Feb. 25, 2022.
(60) Provisional application No. 63/349,046, filed on Jun. 4, 2022.
(60) Provisional application No. 63/358,152, filed on Jul. 4, 2022.

(51) Int. Cl. B60L 1/00; B60L 50/60; B60L 53/14; B60L 53/53; B63H 21/17

(52) U.S. Cl. CPC B60L 1/006; B60L 50/66; B60L 53/14; B60L 53/53; B63H 21/17; B60L 2200/32; B60L 2200/36

(57) ABSTRACT

A method for powering at least one Power Electronics Controller included in a first EV. The method including step of:
i) supplying electrical energy from a Powered Watercraft EV's battery pack to the first EV's at least one Power Electronics Controller.

### CLAIM OF PROVISIONAL APPLICATION RIGHTS

The priority of the following earlier US Provisional Patent Applications is hereby claimed:

### Filing Date (Day/Month/Year) Number of Earlier Application

9 Dec. 2021 63287970
25 Feb. 2022 63314358
4 Jun. 2022 63349046
4 Jul. 2022 63358152
   This Application also claims priority from PCT/US 22/81315

### TECHNICAL FIELD

The present disclosure relates to the field of electric vehicles, known as EVs.

### BACKGROUND ART

A main factor hindering the adoption of All-Electric Pickup Trucks is that most North American Pickup Truck owners want to be able to tow a boat with their Pickup truck and, problematically, towing a boat with an All-Electric Pickup results in range losses of greater than fifty percent and usually greater than 66% as trailering a boat or other watercraft is ranked among the most energy draining towing type, if not the most energy draining towing that a Pickup truck typically encounters, due to poor aerodynamics generated by the combination of a boat or other watercraft on a trailer designed to carry such boat or other watercraft. Thus, Pickup owners who want to be able to tow a boat or other watercraft with their Pickup truck, which is about over half if not about seventy percent of Pickup truck owners in North America, are forced to choose between driving a pollutive ICE Pickup and reaching their recreational boating destination without lengthy forced recharge events consuming scant vacation time or driving an All-Electric Pickup and incurring forced recharge events that detract substantial time away from their desired recreational and watersport activity, significantly degrading the user experience. This dilemma is forcing the continued use of ICE Pickups in North America at a rate that clearly would be much lesser if it was possible to tow a trailered boat to a desired fishing or other watersport destination using an All-Electric Pickup without being forced to recharge en route. A similar problem as described for Pickup trucks exists to a lesser extent for All Electric SUVs, Vans, Hummer type vehicles and even sedans as these also are used to tow recreational boats and watercraft as they typically are heavy enough and powerful enough to handle the towing.

Compounding the above described problem is the fact that All-Electric boats and other watercrafts can be considerably heavier than their ICE counterparts, due to the additional weight battery packs add to the already excessive towing resistance at highway speeds of trailered boats and other watercraft in comparison to towing other typical loads of even heavier weights but of less poor aerodynamics, thus requiring even more energy to tow an All-Electric boat or other watercraft compared to towing its ICE counterpart. This makes it even less range efficient to tow an All-Electric boat or other watercraft with an All-Electric Pickup (or SUV or other EV) compared to towing an ICE counterpart. This problem means that more and more recreational boaters and fisherman are disincentivized to adopt All-Electric versions of those vehicles and are in fact incentivized to continue using ICE Pickups and other ICE EV's to tow their boats, even when those drivers might otherwise be supportive of the switch to All-Electric vehicles, boats and other watercrafts.

Thus, it readily can be appreciated that a long felt need continues to exist for a solution to the above described problems. Thus also, it readily can be appreciated that a long felt need and in fact an urgent need exists for a solution to the above described problems that would allow an All-Electric Pickup truck or other EV to tow a trailered All-Electric boat or other watercraft without mandatory recharge events en route to a desired reservoir, lake or other watersport recreational location, and, preferably, with similar or even greater range as achievable with an ICE Pickup or other ICE EV.

It is one object of the present disclosure to provide a system, apparatus and method that would allow an All-Electric Pickup truck or other EV to tow a trailered All-Electric boat or other watercraft with similar, same or even greater range as achievable with an ICE Pickup or other ICE EV.

It is another object of the present disclosure to provide a system, apparatus and method that would allow an All-Electric Boat or other All-Electric watercraft to be capable of being trailered by said All-Electric Pickup or other EV with similar, same or even greater range as achievable with an ICE Pickup or other ICE EV.

It is yet another object of the present disclosure to provide boat trailers and other watercraft trailers with a system, apparatus and method that would allow boat trailers as well as trailers for other watercrafts to permit enacting the other objects of the present disclosure, including permitting an All-Electric Boat or other All-Electric watercraft to be combinable with and/or detachably connectable to an All-Electric Pickup truck or other EV so as to permit said All-Electric boat or other watercraft to be trailered by said All-Electric Pickup or other EV with similar, same or even greater range as achievable with an ICE Pickup or other ICE EV.

It further can be appreciated that the above described problems also are hindering the adoption of All-Electric boats and watercraft because recreational boaters often choose for the sake of convenience to choose to own both an ICE Pickup and ICE boat, that typically are less expensive than All-Electric alternatives, and simply drive unencumbered by mandatory recharge events rather than spend their precious free time in lengthy and unpleasant forced recharge events en route to their recreational watersport destination. This is especially problematic because ICE boats and their fossil fuel dispensing fuel docks discharge extremely toxic and carcinogenic pollutants directly into reservoirs and water bodies where they are used and installed, where most of the reservoirs are in fact drinking water reservoirs, thus poisoning large populations of persons and animals. This unacceptable status quo has continued until this day in many of North America's reservoirs and water bodies despite large opposition due to the onerous hindrance of excessive range loss during towing of boats and other watercrafts with All-Electric Pickups and other EVs, although progress is being made in restricting more and more reservoirs to electric only boats and watercraft. Thus, it can be appreciated that a long felt need continues to exist for a solution to the above described problems, the solution of which are objects of the present disclosure.

Counterintuitively, the restriction of increasing numbers of water reservoirs to All-Electric only boats and watercraft, while increasing the adoption of All-Electric boats and watercraft, is hindering the adoption of All-Electric Pickups because the difficulties described above in towing boats with All-Electric Pickups and other EVs has resulted in many recreational boaters choosing to drive an ICE Pickup rather than incur lengthy forced recharge events. That is, the decision to avoid the lengthy recharge events associated with driving an All-Electric Pickup or other EV while towing a boat or watercraft of any propulsion type has resulted in many boaters opting to retain using ICE Pickups in order to reach whatever boating destination is preferred, whether that be water bodies restricted to only All-Electric boats or one permitting ICE boats. An additional byproduct of these policies and circumstances further is that many boaters having already opted to continue using an ICE pickup to tow their boat to a waterbody have further opted to tow to waterbodies permitting ICE boats, reasoning that as long as they have an ICE pickup they might as well make what in many instances is a longer but nonetheless more convenient drive lacking recharge events to an ICE permitting reservoir or waterbody and use the faster and less expensive ICE boats and watercraft, and thus are not making the switch to All-Electric boats and watercraft. Thus, it readily can be appreciated that the continued pollution of North America's and other parts of the world's drinking water supply and habitat for animals by exceptionally toxic and carcinogenic products associated with ICE watercraft exits due to the fact that despite the existence of All-Electric Pickups and other EVs and also the existence of All-Electric Boats, that most recreational boaters and pickup owners continue to opt for ICE alternatives due to the dramatic reduction in driving range an All-Electric Pickup or other EV incurs when towing a boat of any propulsion type.

Thus also, it is axiomatic to understand that should a solution to the above problems exist that permits achieving a similar, same, or greater range while towing an All-Electric boat or other watercraft with an All-Electric Pickup or other EV in comparison to using ICE alternatives, that a major hindrance precluding adoption of both All-Electric Pickups as well as All-Electric boats and watercraft would be removed, and in fact the use of such would be preferable due both to their non-pollutive aspects as well as due to the fact that a larger number of recreational water bodies would be accessible to the boater as they can deploy their All-Electric boat in reservoirs and water bodies both restricted to only All-Electric as well as those permitting ICE boats and watercraft, although the goal is to minimize the later and convert those to requiring All-Electric boats and watercraft.

In regard to the latter point, it is understandable that should all the described driving range limitations be removed, that increasing numbers of reservoirs and other water bodies could more readily be restricted to All-Electric boats and watercrafts, which is essential to the health and wellbeing of humans and animals depending upon drinking water reservoirs and aquatic habitats.

Thus, it can be appreciated that a long felt need exists to the problem that towing a boat or other watercraft with an All-Electric Pickup or other EV causes over fifty percent and often over sixty-six percent range reduction, resulting in onerous and time consuming recharge events that the majority of boat owners in North America have indicated by their purchasing preferences for ICE vehicles and boats are excessively onerous and hindering the adoption of All-Electric alternatives to ICE vehicles.

It is important to increase the distance traveled per kilowatt-hour achieved by EVs in order to reduce the amount of pollution per transportation unit and to increase the convenience and practicality of use, and thus the rate of adoption of EVs, so as to reduce or eliminate ICE vehicles in order to reduce or eliminate global fossil fuel pollution.

One of the main factors cited as a reason for non-adoption or non-endorsement of electric vehicles (EVs) vs. internal combustion engine (ICE) vehicles is range, and also “range anxiety”. An example of range anxiety is the concern that an electric vehicle will run out of battery capacity before reaching a desired and planned charging location for a desired and planned charging event.

Furthermore, the greater distance traveled per kilowatt-hour achieved by an EV, the less expensive it is to operate the EV. Consumers and EV engineers are acutely aware of these facts. In fact, amongst both consumers as well as EV manufacturers, EV's are most often compared to one another in terms of their driving range. Accordingly, the goal of increasing the distance traveled per kilowatt-hour is a long and acutely felt need in the EV industry, with the improvement of distance traveled per kilowatt-hour being a primary goal of those of skilled in the field. In fact, it would not be an exaggeration to say that improving distance traveled per kilowatt-hour is the most heavily worked goal of those in the field, with a multitude of entities attempting a multitude of different approaches and solutions to this problem, including different battery types, different battery chemistries, different electric motor and electric drive train constructions, different software range aids, and other EV vehicle engineering.

A particularly serious and long felt example of range anxiety hindering the adoption of EVs into the general market of citizen drivers and perpetuating fossil fuel pollution is that EVs lose range rather quickly when used to tow a boat. The range loss can easily exceed fifty percent. This fact is especially problematic for the adoption of EVs because the most commonly sold ICE vehicle in many regions is a Pickup Truck, and most Pickup Truck owners desire to be able to use their personal vehicle to tow, including and especially to tow a trailered boat. This preference of the market to be able to use their personal Pickup Trucks to tow a trailered boat is particularly serious because range loss during towing typically is most extreme when the load is a trailered boat, due to the disproportionately high drag in comparison to other typically trailered items generated by the poor aerodynamics formed by the combination of an out of water boat and the boat trailer upon which it is situated being towed at highway speeds.

The range loss is compounded even more in the event of towing an electric boat, because electric boats are well known to be considerably heavier than their ICE counterparts. This is due to the presence of rather large batteries, as rather large batteries are required due to the fact that propelling boats across water is exceptionally energy inefficient in comparison to propelling wheeled vehicles on a paved roadway.

When these factors are considered in light of the fact that Pickup Trucks and large SUVs are disproportionately more fuel consumptive in comparison to smaller personal vehicles even when not towing a load, it can readily be appreciated that it is vitally important to develop a solution to the problem of range loss by a Pickup Truck or any EV when trailering a power boat so as to remove the rather large hindrance this problem continues to pose to the adoption of EV Pickup Trucks or other EVs useful for trailering.

Thus, it can be readily appreciated that it is especially important to increase the towing range when trailering an EV boat in order to promote adoption both of EVs as well as of electric boats and personal watercraft so as to eliminate their ICE counterparts as a source of fossil fuel pollution, it being well known that powerboats and personal watercraft are exceptionally and disproportionately pollutive compared to wheeled vehicles, with much of this pollution being delivered directly to drinking water reservoirs and delicate marine environments.

In addition to ICE boats, another significant source of fossil fuel pollution as well as pollution directly to waterways, drinking water reservoirs, and delicate aquatic environments is the use of Internal Combustion Engine (ICE) personal watercraft (PWC) such as Jet Skis, Sea Doos, and Waverunners. However, while all-electric versions of boats and PWC already exist, another major problem hindering their adoption in addition to the above described problem of range loss incurred while towing, is the difficulty of charging them at their location of use, as charge points often are not readily available where such craft usually are deployed.

However, none of the art has of yet disclosed a method to permit improving the range that an EV has while towing an electric boat or electric personal watercrafts, nor of charging electric boats or electric personal watercraft in remote locations without the use of a commercial charge point, and these problems continue to be a long felt need in the industry.

One current method used by the industry to redress range anxiety is to provide an internal combustion engine powered generator integral with the otherwise electric vehicle, where the generator runs usually on gasoline and creates electrical energy to recharge the battery that powers the vehicle's electric drive system. Such a vehicle is known as a “plug-in hybrid vehicle”, and is also referred to in this text as a PHEV, also known as a “hybrid vehicle”, also referred to as a HEV. This particular solution to the problem of range anxiety is not a true solution because, unlike a pure electric EV (also known in this text as an “all-electric vehicle”, an “EV”, a “Battery EV”, or “BEV”), the operation of PHEVs and HEVs continues to create fossil fuel pollution at a scale disproportionately greater than the energy harnessed. This is because ICE engines located on individual vehicles are incapable of operating all of the time at truly clean operating parameters, unlike industrial scale electricity production, that is able to be optimized to an essentially 100% clean generation of electrical energy. The use of PHEV's and HEV's is especially troublesome as the use of a small engine to create electricity to charge an EV's battery is more pollutive than creating electricity by other means on an industrial scale and using such industrial scale created energy to charge EVs.

Bi-directional charging (that in this text shall also include “vehicle to vehicle charging” as well as “Vehicle to Load” charging as well as “Vehicle to Grid” charging, and the like), which is useful to allow an EV to charge the battery of another EV, has not yet been adopted into the mainstream of the industry, but it appears to be increasingly likely that it shall be. However, Bi-directional charging does not solve the long felt problems that the present disclosure seeks to solve.

A company named Colorado Teardrops produces and markets a towable camping trailer branded “The Boulder” that has a bank of EV batteries built into the trailer frame that enables recharging a towing EV's batteries to return the towing electric vehicle to its pre-towing range—or better.

Australian published patent application number AU2015358297A1 discloses a towable trailer having an external power source that can be towed by an electric vehicle and used to charge the electric vehicle.

However, none of the known art has yet proposed a practical method and apparatus for extending the range of EVs used in towing EV boats and EV personal watercraft that is disclosed herein.

Furthermore, none of the art has yet proposed the method and apparatus for improving the practicality of use of EV boats and EV personal watercraft by facilitating their charging and recharging remotely from charge points that is disclosed herein.

It can thus be appreciated that, as of this writing, the only option to permit towing the types of commonly trailered vehicles that cause the greatest amount of range loss while towing, that is EV boats, without being forced to cope with a towing range that is at least forty to sixty percent reduced from normal, and without also be forced either to cope with range anxiety and/or to tolerate frequent lengthy recharge events is to use ICE (Internal Combustion Engine) vehicles. This is not an acceptable or sustainable status quo for the environmental health of the world. Thus, it can readily be appreciated that there exists a continuing long felt need for a solution to this problem, that is hindering widespread adoption of EVs by a large percentage of the population who would like to trailer a boat or personal watercraft and the like using their personal vehicle, resulting in continued fossil fuel consumption and pollution when it otherwise would not be necessary to do so. Thus, also, it can readily be appreciated that this problem is hindering the adoption of EV boats and EV personal watercraft, which is vital to eliminate a large source of pollution to delicate and important environments caused by their ICE counterparts.

Thus, it can readily be appreciated that it is important to facilitate the adoption of EV's, as well as EV boats and EV personal watercraft. Thus, also, it can readily be appreciated that in order to facilitate the adoption of EVs as well as EV boats and EV personal watercraft, that it is important to provide a practical solution to the problem of range loss by EVs when used in towing applications, especially when used in towing EV boats and EV personal watercraft.

As of this writing, none in the industry have yet proposed a working solution to the above described important problem that continues to be a long-felt need in the industry, the solution of which is important for the environmental health of the world.

Thus it can readily be appreciated that a long felt need continues to exist for an apparatus and method to extend the range of EVs towing EV boats and EV personal watercraft, so as not to disincentive from adopting an EV as their primary automobile the rather large portion of drivers who desire to tow personal EV watercraft and EV boats, and to facilitate conversion of that rather large portion of drivers from employing pollutive fossil fuel dependent means of transportation to a green electrical means of transportation.

Furthermore, it can readily be appreciated that by improving the practicality of use of EV boats and EV personal watercrafts by permitting their charging and recharging remotely from and without use of a charge point, that adoption of Powered Watercraft EVs would likely be accelerated, and that such accelerated adoption is of utmost importance due to the disproportionately high pollution source that ICE boats and ICE personal watercraft present, and due to the fact that said pollution is present in delicate environments, especially marine and aquatic environments, including drinking reservoirs and nursery habitats critical to the preservation of many of the earth's species.

Thus, it also can be appreciated that a long-felt need continues to exist for an apparatus and method to charge and recharge without a charge point EV boats and EV personal watercraft so as to remove hindrances to their adoption and eliminate ICE boats and personal watercraft as a source of fossil fuel pollution.

### Definitions

An “Electric Boat” shall mean any boat or ship configured at least to carry and transport at least one or more persons and whose primary propulsion technology comprises an electric drive system configured to use energy stored in an onboard battery pack and/or batteries, and shall also be known as an “EV Boat”. Examples of EV boats of the present disclosure include but are not limited to a motorboat or powerboat (including, for example, a jetboat, a fishing boat, a bass boat, a waterski boat, a wake boat, and a pontoon boat) whose primary propulsion technology comprises an electric drive system configured to use energy stored in an onboard battery pack and/or batteries.

An “Electric Personal Watercraft” shall mean any personal watercraft (PWC) whose primary propulsion technology comprises an electric drive system configured to use energy stored in an onboard battery pack and/or batteries and shall also be known as an “EV personal watercraft”. Examples of EV personal watercraft of the present disclosure include but are not limited to a Jet Ski, Sea Doo, or Waverunner whose primary propulsion technology comprises an electric drive system configured to use energy stored in an onboard battery pack and/or batteries.

Hybrid variants of an Electric Boat and/or an Electric Personal Watercraft shall mean any Electric Boat and/or Electric Personal Watercraft as defined herein and above whose primary propulsion technology comprises an internal combustion engine in combination with one or more electric drive system(s) that use energy stored in an onboard battery pack and/or batteries, where the electric drive system is capable of propelling, and is configured to propel, the boat at or near its intended maximal speed for sustained periods of time when the internal combustion engine is not operating.

In this text, the term “Powered Watercraft EV”, and its plural form, shall be synonymous with the terms “Electric Boat” (including “EV Boat”) and “Electric Personal Watercraft” (including “EV Personal Watercraft”), as defined herein and above, and their plural forms, respectively, including hybrid variants of such vehicles as defined herein and above.

In this text, the terms “JetSki” and “Jet Ski”, and their plural forms, also shall include the terms “Sea Doo” and “WaveRunner”, as well as all similarly configured personal watercraft, and their plural forms.

In this text, the term “first electric vehicle” is interchangeable with the terms “first EV and “towing EV”, both when the first EV is stationary as well as when it is actively towing upon a trailer capable of having removably situated upon it one or more Powered Watercraft EVs of the present disclosure.

In this text, the terms “electrical component” and/or “electrical feature” shall be interchangeable and shall include but not be limited to meaning “a component dependent on electric currents or electromagnetic fields to work properly”.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The terms “comprises”, “comprising”, “has”, “have”, “having”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

In the following text, the terms “battery”, “cell”, and “battery cell” may be used interchangeably and may refer to any of a variety of different battery configurations and chemistries. Typical battery chemistries include, but are not limited to, lithium ion, lithium ion polymer, nickel metal hydride, nickel cadmium, nickel hydrogen, nickel zinc, and silver zinc. The term “battery pack” as used herein refers to an assembly of one or more batteries electrically interconnected to achieve the desired voltage and capacity, where the battery assembly is typically contained within an enclosure. The terms “electric vehicle” and “EV” may be used interchangeably.

Although an exemplary embodiment is described as using a plurality of units to perform the exemplary process, it is understood that the exemplary processes may also be performed by one or a plurality of modules. Additionally, it is understood that the term controller/control unit refers to a hardware device that includes a memory and a processor. The memory preferably is configured to store the modules and the processor preferably is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

An object and an effect of the present invention may be naturally understood or may become clearer from the following description, and the object and the effect of the present invention are not restricted only by the following description. In addition, in the description of the present invention, the specific descriptions of publicly known technologies relate with the present invention will be omitted when it is determined that the specific descriptions may unnecessarily obscure the subject matter of the present invention.

### OBJECTS OF THE PRESENT DISCLOSURE

It is an object of the present disclosure to provide a method and apparatus for extending the range of an EV especially a BEV during towing and especially during towing of one or more Powered Watercraft EVs.

It is an object of the present disclosure to provide a method and apparatus for extending the range of an EV especially a BEV during towing and especially during towing of one or more Powered Watercraft EVs, such as BEV jet skis, jet boats, motor boats, inboard/outboard motorboats, and other EV powered watercrafts.

It is an object of the present disclosure to provide a method and apparatus for extending the range of an EV especially a BEV while under motion and during towing and especially during towing of one or more Powered Watercraft EVs and especially Powered Watercraft EVs.

It is an object of the present disclosure to provide a method and apparatus for extending the range of an EV especially a BEV while under motion and during towing and especially during towing of one or more Powered Watercraft EVs and especially Powered Watercraft EVS, such as BEV jet skis, jet boats, motor boats, inboard/outboard motorboats, and other EV powered watercrafts.

It is an object of the present disclosure to provide a method and apparatus for charging and/or recharging the battery pack of an EV and especially of a Powered Watercraft EV during towing and especially while under motion and during towing of one or more Powered Watercraft EVs and especially Powered Watercraft EVS.

It is an object of the present disclosure to provide a method and apparatus for charging and/or recharging the battery pack of an EV especially a BEV during towing and especially while under motion and during towing of one or more Powered Watercraft EVs and especially Powered Watercraft EVS, such as BEV jet skis, jet boats, motor boats, inboard/outboard motorboats, and other EV powered watercrafts.

It is an object of the present disclosure to provide a method and apparatus for charging and/or recharging the battery pack of an EV and especially of a BEV attached to a trailer upon which is carried one or more Powered Watercraft EVs and especially Powered Watercraft EVS.

It is an object of the present disclosure to provide a method and apparatus for charging and/or recharging the battery pack of an EV especially a BEV attached to and configured to tow upon a trailer upon which is carried one or more Powered Watercraft EVs and especially Powered Watercraft EVS, such as BEV jet skis, jet boats, motor boats, inboard/outboard motorboats, and other EV powered watercrafts.

It is an object of the present disclosure to provide a method and apparatus for extending the range of an EV especially a BEV during towing and especially during towing of one or more Powered Watercraft EVs and especially Powered Watercraft EVS.

It is an object of the present disclosure to provide a method and apparatus for eliminating or reducing, or in general mitigating, range anxiety incurred by using an EV and especially a BEV to tow one or more Powered Watercraft EVs and especially Powered Watercraft EVS, so as to remove obstacles to the adoption of and so as to speed the adoption of both EVs as well as Powered Watercraft EVs, as is important for the health of the world's climate and environments

It is an object of the present disclosure to provide a method and apparatus without the use of a charging point for charging and recharging Powered Watercraft EVs and especially Powered Watercraft EVS, such as BEV jet skis, jet boats, motor boats, inboard/outboard motorboats, and other EV powered watercrafts.

It is an object of the present disclosure to provide a method and apparatus for multiple charging and recharging events for Powered Watercraft EVS far from and without the use of a charging point so as to improve their practicality of use and to remove disincentives to their adoption, as necessary to protect delicate environments from fossil fuel pollution.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. A provides a block diagram of an exemplary Range Extending System for use with a preferred embodiment of the present disclosure.

FIG. A-A provides a block diagram of an alternate exemplary Range Extending System of that illustrated in FIG. A for use with an alternate preferred embodiment of the present disclosure.

FIG. B provides a block diagram of another exemplary Range Extending System for use with an alternate preferred embodiment of the present disclosure.

FIG. C provides a block diagram of another exemplary Range Extending System for use with an alternate preferred embodiment of the present disclosure.

FIG. D provides a block diagram of another exemplary Range Extending System for use with another alternate preferred embodiment of the present disclosure, where the System shown in FIG. D includes the systems shown in all of FIGS. A, B and C.

FIG. E illustrates the basic methodology of the invention in accordance with a preferred embodiment.

FIG. F illustrates a modified methodology based on that shown in FIG. E.

FIG. G illustrates a modified methodology based on that shown in FIG. E and FIG. F.

FIG. H illustrates a modified methodology based on that shown in FIG. E>

FIG. 1 illustrates a modified methodology based on that shown in FIG. F.

FIG. J illustrates a modified methodology based on that shown in FIG. G.

FIG. K illustrates an abbreviated and modified methodology based upon that shown in FIG. E.

FIG. 1 illustrates another alternate methodology of the present disclosures system.

FIG. M illustrates another alternate methodology of the present disclosure's system.

FIG. N illustrates another alternate methodology of the present disclosure's system.

FIG. O illustrates another alternate methodology of the present disclosure's system.

FIG. P illustrates an abbreviated and modified methodology based upon that shown in FIG. G.

FIG. Q illustrates another alternate methodology of the present disclosure's system.

FIG. R illustrates another alternate methodology of the present disclosure's system.

FIG. S illustrates a methodology of the present disclosure's system for automatically first charging the Powered Watercraft EV's battery pack from an external charger detachably connected to the first EV followed by charging the first EV's battery pack

FIG. T illustrates a methodology of the present disclosure's system that essentially reverses the order in which the Powered Watercraft EV's battery pack and the first EV's battery pack are charged in the method of FIG. S

FIG. U illustrates a methodology of the present disclosure's system that essentially combines the methods of FIG. S and FIG. T.

FIG. V illustrates a methodology of the present disclosure's system that enables simultaneously automatically charging two or more Powered Watercraft EV's battery packs from an external charger detachably connected to the first EV

FIG. W illustrates a methodology of the present disclosure's system that enables simultaneously automatically charging two or more Powered Watercraft EV's battery packs as well as the first EV's battery pack from an external charger.

FIG. X illustrates a side view of a first EV towing a trailer removably carrying a Powered Watercraft EV and depicting the invention in the environment.

FIG. Y illustrates a top view of an embodiment of the present disclosure where multiple Powered Watercraft EVs are connected to the first EV.

FIG. Z-1 to FIG. Z-4 illustrate various trailer plug configurations useful for effecting the present disclosure.

FIG. 6 illustrates a top view of a portion of a parking lot where a plurality of speed bump shaped external chargers 30 of the present disclosure are set crosswise at the interior terminal end of a plurality of parking stalls.

FIG. 7 illustrates a top view of a portion of an alternate parking lot where a plurality of speed bump shaped external chargers 31 of the present disclosure are set parallel to the long length of the parking stalls.

FIG. 8A, FIG. 8B and FIG. 8C illustrate various possible cross sectional shapes for the cross section of the speed bump shaped chargers of the present disclosure taken in a plane perpendicular to their long axis.

FIG. 9 and FIG. 10 illustrate possible side plan views of the long dimension of two alternate speed bump shaped chargers of the present disclosure.

FIG. 11 illustrates a top view of a boat launch parking lot where a plurality of speed bump shaped external chargers of the present disclosure are set crosswise about midpoint along the length of parking stalls having a length and width typically found in boat launch parking lots, that is, long enough and wide enough to accommodate parking and parking maneuvers of a typical large pickup towing a typical large boat trailer.

FIG. 12-FIG. 12A and FIG. 13, and FIG. 14 illustrate alternative embodiments of FIG. X.

FIG. 15 and FIG. 16 illustrate alternative embodiments of FIG. Y.

### BEST MODE FOR CARRYING OUT THE DISCLOSURE

It is noted that all examples provided in the present disclosure are prophetic examples and are not working examples.

### DISCLOSURE

The present disclosure is based upon the surprising and unexpected discovery that the driving range of an EV during towing of a Powered Watercraft EV such as an EV Boat or Personal Watercraft EV can be improved in comparison to the range obtainable when towing their ICE counterparts, despite the fact that Powered Watercraft EVs typically are heavier than their ICE counterparts, which such result is contrary to the state of the art and against the trend of the industry, and against the widely held beliefs of those in the field.

In certain embodiments of the present invention, especially during towing by an EV such as an EV Pickup Truck of a relatively large Powered Watercraft EV such as an EV boat having a heavy and large battery pack, the driving range of an EV during towing is surprisingly and unexpectedly maintained and even bettered. Such result is contrary to the state of the art and against the trend of the industry and against the widely held beliefs of those in the field.

The surprising and unexpected results and benefits of the present disclosure thereby promote adoption of EVs, that is necessary to redress global pollution from ICE vehicles. Although EV boats are far heavier than their ICE counterparts, and although boats have the greatest air drag of all loads commonly towed for personal purposes and said greatest air drag in combination with the exceeding weight of EV boats should cause the towing range to be substantially lesser when towing an EV boat in comparison to when towing an ICE boat, it has been found, surprisingly, unexpectedly and contrary to the state of the art and against the trend of knowledge in the industry, that the towing range of an EV vehicle can be extended in comparison to the towing range of a similarly powerful ICE vehicle when towing these heavier than their ICE counterpart EV boats using an electric vehicle such as an electric Pickup or electric SUV.

In addition to the range bettering embodiments reference above, the present disclosure also provides a method and apparatus that results in the ability to charge and recharge a Powered Watercraft EV remote from and without the use of a charge point, thereby aiding the adoption of green Powered Watercraft EVs to replace their highly pollutive ICE counterparts.

Briefly, in a preferred embodiment of the present disclosure, a first electric vehicle (EV) that may be an EV Pickup is removably connected to and/or tows upon a trailer upon which is removably situated a powered watercraft EV, that may be an EV personal watercraft or an EV boat, the method comprising electrically connecting the powered watercraft EV and the first EV and further comprising using electrical energy contained in the battery pack (including “traction battery pack”) of the Powered Watercraft EV to supply electrical energy to power the first (and towing) EV just as if the battery of the Powered Watercraft EV was the battery of the first EV.

Preferably, the present disclosure's method comprises using electrical energy held by the battery pack (including “traction battery pack”) of the Powered Watercraft EV to supply electrical energy to power the first (and towing) EV and especially to power the first EV's electric traction motor(s), especially by powering the first EV's Power Electronic Controller(s) that in turn manages the flow of the electrical energy sourced and/or delivered from the Powered Watercraft EV's traction battery so as to control the speed of the first EV's electric traction motor(s) and the torque it and/or they produce.

It is understood that the teachings of the present disclosure disclosing sourcing and/or directing and/or supplying electrical energy from the Powered Watercraft EV's battery pack and/or traction battery to the first EV's Power Electronics Controller includes that the first EV's Power Electronic Controller in turn manages the flow of the electrical energy sourced and/or delivered from the Powered Watercraft EV's traction battery so as to control the speed of the first EV's electric traction motor and the torque it produces.

In one embodiment of the present disclosure, electrical energy is directed and/or supplied from the Powered Watercraft EV's battery to the first EV's Power Electronics Controller (see FIG. A and FIG. A-A).

In another embodiment of the present disclosure, electrical energy is directed and/or supplied from the Powered Watercraft EV's battery to the first EV's onboard charging system. (See FIG. B)

In another embodiment of the present disclosure, electrical energy is directed and/or supplied from the Powered Watercraft EV's onboard charging system to the first EV's onboard charging system (see FIG. C).

In those embodiments of the present disclosure illustrated in reference to FIG. A and FIG. A-A, the First EV's control unit, and, when useful, the Powered Watercraft EV's control unit, are configured to permit electrical energy contained in and/or sourced from the Powered Watercraft EV's battery pack to flow directly to the First EV's motor controller (Power Electronics Controller) even while the First EV is turned on and/or in motion and driving, or even while it is stationary and/or turned off. The draw of electrical energy from the Powered Watercraft EV's battery pack is regulated by the First EV's control unit just as if it was drawing electrical energy from the First EV's own battery pack. In this way, the First EV's motor controller can be supplied electrical energy contained in and/or sourced from the Powered Watercraft EV's battery pack while the First EV is in motion just the same as if it were sourcing electrical energy from its own battery pack.

In those embodiments of the present disclosure illustrated in reference to FIG. B, the First EV's control unit, and, when useful, the Powered Watercraft EV's control unit, are configured to permit electrical energy contained in and/or sourced from the Powered Watercraft EV's battery pack to flow directly to the First EV's onboard charging system while the First EV is turned on and/or in motion and driving or even while it is stationary and/or turned off. The draw of electrical energy from the Powered Watercraft EV's battery pack is regulated by the First EV's control unit just as if it was drawing electrical energy from the First EV's own battery pack. In this way, the First EV's battery pack can be charged and/or recharged by electrical energy contained in and/or sourced from the Powered Watercraft EV's battery pack while the First EV is in motion and sourcing electrical energy from its own battery pack to power its motor controller.

In those embodiments of the present disclosure illustrated in reference to FIG. C, the First EV's control unit, and, when useful, the Powered Watercraft EV's control unit, are configured to permit electrical energy contained in and/or sourced from the Powered Watercraft EV's battery pack to flow first to the Powered Watercraft EV's onboard charging system and then to the First EV's onboard charging system while the First EV is turned on and/or in motion and driving or even while it is stationary and/or turned off. The draw of electrical energy from the Powered Watercraft EV's battery pack and really from its onboard charging system is regulated by the First EV's control unit just as if it was drawing electrical energy from the First EV's own battery pack. In this way, the First EV's battery pack can be charged and/or recharged by electrical energy contained in and/or sourced from the Powered Watercraft EV's battery pack while the First EV is turned on and/or in motion and sourcing electrical energy from its own battery pack to power its motor controller (as well as when the First EV is stationary and/or turned off, so as to recharge and/or charge the first EV's battery pack from electrical energy contained in and/or sourced from the Powered Watercraft EV's battery pack).

In another embodiment of the present disclosure (see FIG. D), the system of the present disclosure is configured to enable a combination of any or all of:
i) directing and/or supplying electrical energy from the Powered Watercraft EV's battery to the first EV's Power Electronics Controller;
ii) directing and/or supplying electrical energy from the Powered Watercraft EV's battery to the first EV's onboard charging system, for direction and/or supply to the first EV's Power Electronics Controller; and,
iii) directing and/or supplying electrical energy from the Powered Watercraft EV's battery via the Powered Watercraft EV's onboard charging system to the first EV's onboard charging system, for direction and/or supply to the first EV's Power Electronics Controller.

In further detailed embodiments of the present disclosure:

### In Reference to FIG. A and FIG. A-A:

In one further detailed embodiment of the present disclosure, electrical energy is directed and/or supplied from the Powered Watercraft EV's battery to the first EV's Power Electronics Controller, preferably while bypassing the Powered Watercraft EV's charging system, and also while bypassing the first EV's charging system, including while the first EV is turned on and in motion and driving towing upon a trailer carrying the Powered Watercraft EV, or when the First EV is stationary and/or turned off, and the First EV's and the Powered Watercraft EV's control units are configured to permit said electrical energy direction and/or supply.

The First EV's control unit, and, if necessary, the Powered Watercraft EV's control unit, are configured to permit electrical energy in and/or sourced from the Powered Watercraft EV's battery pack to flow to the First EV's motor controller while the First EV is driving and in motion, and, preferably, even while the First EV is stationary. The draw of electrical energy from the Powered Watercraft EV's battery pack is regulated by the First EV's motor controller and/or control unit just as if it was drawing electrical energy from the First EV's own battery pack.

The First EV's control unit, and, when useful, the Powered Watercraft EV's control unit, are configured to permit electrical energy in the Powered Watercraft EV's battery pack to flow along a conductor connected to the Powered Watercraft EV's battery back directly to a terminal end of said conductor where said terminal end is configured to be detachably connected to detachable connector assembly 11 (and, where said conductor bypasses the Powered Watercraft EV's onboard charging system), and, through the detachable connector 11 to another conductor that is integral the First EV and is connected at one end to that portion of detachable connector assembly 11 that is integral the first EV and is connected at another of its ends to the First EV's motor controller (Power Electronics Controller). That portion of connector assembly 11 integral the first EV and that portion of connector assembly 11 integral the Powered Watercraft EV are detachably connected to one another either by one directly mating and/or otherwise connecting to the other; or, by an intermediary cable that is an electrically conductive cable that appears similar to a charging cable except that it has a charging plug at both ends, and where a conductive cable is provided in additional to conventional conductive cables normally integral a charging cable, where said additional conductive cable includes a conductor that detachably connects to the conductor connecting to the Powered Watercraft EV's battery pack, at one end of the cable, and connects to the conductor routed directly to the First EV's motor controller at another end of the cable).

In other embodiments, the intermediary cable has at one end a plug end configured to mate to the terminal end of the conductive cable connected to the Powered Watercraft EV's battery pack (which said terminal end might be a socket or plug type terminal end, such as for example a typical charging port that, preferably, is adapted to include a conductive end connected to the conductor connecting directly to the Powered Watercraft EV's battery pack), and having at its other end a plug end configured to mate to that portion of connector 11 that is integral the First EV (where that portion of the connector 11 that is integral the first EV can be configured as a trailer plug type connector); and, preferably, the intermediary cable also includes all conductors and terminal ends needed to allow the cable to also serve as the charging cable for the Powered Watercraft EV and also for the First EV, and, preferably, the Powered Watercraft EV is configured with a charging port that includes a terminal end for that conductor that connects directly to the Powered Watercraft EV's battery pack (including a post of its battery pack). In this way, by plugging the intermediary cable into the charge port of the Powered Watercraft EV, and into a charge port integral the First EV that can serve as that portion of connector 11 that is integral the First EV, the charging systems of the Powered Watercraft EV and of the First EV are connected, and, in addition, and direct connection between the Powered Watercraft EV's battery pack and also the First EV's motor controller also is established. If it is desired to connect only the charging system of the Powered Watercraft EV to the charging system of the First EV, so as to permit bi-directional charging and/or vehicle to vehicle charging and/or vehicle to load charging between the Powered Watercraft EV and the First EV, including while the First EV is turned on and/or in motion and towing upon the trailer carrying the Powered Watercraft EV, and also including when the First EV is parked and/or turned off, then the conductor that connects directly to the Powered Watercraft EV's battery pack (including a post of its battery pack) at one end and to that portion of connector 11 associated with the First EV at its other end is not required, nor is required the conductor that connects directly from the First EV's motor controller to that portion of connector 11 integral the first EV.

Optionally, and preferably, a switch permits connecting/disconnecting the electrical connection between the Powered Watercraft EV's battery and the first EV's Power Electronics Controller, said switch being controlled by the system controller, that is configured to close the switch (i.e. make the electrical connection) upon having verified that the properties of electrical energy sourced from the Powered Watercraft EV's battery pack are compatible with the First EV's motor controller. However, this is not necessarily required when the First EV's motor controller includes an inverter suitably configured to manage the Voltage from the Powered Watercraft EV's battery pack. Closing the switch connects the Powered Watercraft EV's battery to the first EV's Power Electronic Controller (motor controller) thereby enabling the first EV to use the battery energy contained in the Powered Watercraft EV's battery just the same as if said energy was contained in the battery of the first EV.

The connection to the Powered Watercraft EV's battery pack is made by connecting an electrical conductor integral with the powered watercraft EV to a detachable connector and/or plug and/or trailer plug connected to the first EV, where, preferably, a conductor such as a conductive cable is routed directly from the Powered Watercraft EV's battery (and or its batteries post) to a terminal plug, that can be a male or female end, as desired, where the terminal plug is configured to connect and/or to mate to a plug and/or connector and/or trailer plug connected to and preferably integral with the first EV, where such plug and/or connector and/or trailer plug connected to and preferably integral the first EV completes the electrical connection from the Powered Watercraft EV's battery to the First EV's Power Electronics Controller (Motor Controller). Preferably, incorporated into a same wiring harness and bundle and terminating into different male and/or female conductive terminal ends of a plug are all other electrical conductors required and included in an electrical plug that also serves as the charging cable and/or plug for the Powered Watercraft EV, and also the connector 11 is configured to both mate to the direct electrical conductor sourced from the Powered Watercraft EV's battery pack as well as to serve as a charge port/charge port plug for the first EV, such as to permit charging of the First EV from an external charger, or to permit bi-directional charging and vehicle to vehicle charging and vehicle to load charging and vehicle to grid charging between the first EV and, at least, the Powered Watercraft EV and any other external loads or charge sources. Optionally, equipment designed to ensure compatibility of electrical energy contained in and/or sourced from the Powered Watercraft EV's battery pack and the electronic architecture of the First EV and/or of the First EV's Motor Controller (and in subsequent described embodiments of the First EV's onboard charging system) is situated in line between the First EV's Motor Controller and the aforementioned plug and/or connector and/or trailer plug, to provide circuit protection to the First EV's Motor Controller (or, for subsequently described embodiments, to the First EV's onboard charging system).

Thus, the present disclosure also teaches a Powered Watercraft EV having an electrical conductor providing direct electrical communication from and between the battery pack (including a post of the battery pack) of the Powered Watercraft EV and a terminal end of the electrical conductor that is configured so as to be detachably connected to an EV vehicle such as a wheeled EV such as an EV pickup or an EV SUV, either directly or through an intermediate plug and harness incorporated into a trailer configured to removably carry the Powered Watercraft EV and to be towed upon by the first EV, where such electrical conductor can also be included in a bundle with other electrical conductors needed for use and operation of the Powered Watercraft EV's onboard charging system, and where such terminal end of said electrical conductor also can be adapted to be part of a larger terminal end unit that includes the terminal ends of the other electrical conductors needed for use and operation of the Powered Watercraft EV's onboard charging system, and in some instances even of the trailer's electrical equipment, and where such terminal end of said electrical conductor is included in said larger end unit that includes the terminal ends of the other electrical conductors needed for use and operation of the Powered Watercraft EV's onboard charging system, which said charging system can also include capability for any and all of bi-directional charging and vehicle to vehicle charging and vehicle to load charging and vehicle to grid charging between the first EV and, at least, the Powered Watercraft EV and any other external loads or charge sources. The present disclosure's control unit is capable of allowing electrical energy to flow directly from the Powered Watercraft EV's battery pack to the First EV's motor controller without permitting an electrical connection between the first EV's onboard charging system and/or motor controller and any of the other electrical conductors needed for use and operation of the Powered Watercraft EV's onboard charging system, by opening and closing switches as needed. Thus, electrical energy can be drawn from the Powered Watercraft EV's battery pack and provided directly to the First EV's motor controller.

(Or, as described further herein, in other operations, electrical energy can be provided from the Powered Watercraft EV's battery pack to the First EV's onboard charging system (either directly or by first passing through the Powered Watercraft EV's own onboard charging system); or, in further other operations described further herein, electrical energy can be provided from the First EV's battery pack to the Powered Watercraft EV's onboard charging system.

### In Reference to FIG. B:

In another further detailed embodiment of the present disclosure, electrical energy is directed and/or supplied from the Powered Watercraft EV's battery to the first EV's onboard charging system, including while the first EV is turned on and in motion and driving towing upon a trailer carrying the Powered Watercraft EV, or when the First EV is stationary and/or turned off, and the First EV's and the Powered Watercraft EV's control units are configured to permit said electrical energy direction and/or supply, preferably while bypassing the Powered Watercraft EV's charging system, where said electrical energy is for use either or both to supply the first EV's Power Electronics Controller; or, to charge the first EV's battery pack, as can be selected using a switch disposed between the first EV's onboard charging system and the first EV's Power Electronics Controller and also between the first EV's onboard charging system and the first EV's battery pack (See FIG. B).

In another further detailed embodiment of the present disclosure, electrical energy is directed and/or supplied from the Powered Watercraft EV's battery to the Powered Watercraft EV's onboard charging system to the first EV's onboard charging system (see FIG. C), where the Powered Watercraft EV's battery is the supply source of said electrical energy to the Powered Watercraft EV's charging system, including while the first EV is turned on and in motion and driving towing upon a trailer carrying the Powered Watercraft EV, or when the First EV is stationary and/or turned off, and the First EV's and the Powered Watercraft EV's control units are configured to permit said electrical energy direction and/or supply, where said electrical energy is for use either or both to supply the first EV's Power Electronics Controller; or, to charge the first EV's battery pack, as can be selected using a switch disposed between the first EV's onboard charging system and the first EV's Power Electronics Controller and also between the first EV's onboard charging system and the first EV's battery pack.

Accordingly, in one embodiment of the present disclosure, both the first EV and the Powered Watercraft EV each include their own onboard charging systems, where each of their own onboard charging systems are capable of bi-directional charging including vehicle to vehicle charging, vehicle to load charging, and other. The method comprises configuring the control unit of the first EV and when useful configuring the control unit of the powered watercraft EV to permit sourcing electrical energy from the powered watercraft EV's battery pack to power the first EV and/or to charge the first EV's battery pack while the first EV is in motion and driving and simultaneously sourcing energy from its own battery pack to power its own motor controllers. Alternatively, the method also comprises configuring the control unit of the first EV and also of the powered watercraft EV to permit sourcing electrical energy from the first EV's battery pack to charge the powered watercraft EV's battery pack, including while the first EV is driving and in motion or parked and turned off.

In another more detailed embodiment of the present disclosure (see FIG. D), the system of the present disclosure is configured to enable a combination of any or all of:
iv) directing and/or supplying electrical energy from the Powered Watercraft EV's battery (preferably directly) to the first EV's Power Electronics Controller (that in turn manages the flow of the electrical energy sourced and/or delivered from the Powered Watercraft EV's traction battery, thereby managing the speed of the first EV's electric traction motor and the torque it produces);
v) directing and/or supplying electrical energy from the Powered Watercraft EV's battery to the first EV's onboard charging system, for direction and/or supply either to the first EV's Power Electronics Controller (that in turn manages the flow of the electrical energy sourced and/or delivered from the Powered Watercraft EV's traction battery, thereby managing the speed of the first EV's electric traction motor and the torque it produces); or to charge the first EV's battery pack, as can be selected using a switch disposed between the first EV's onboard charging system and the first EV's Power Electronics Controller and also between the first EV's onboard charging system and the first EV's battery pack; and,
vi) directing and/or supplying electrical energy from the Powered Watercraft EV's battery via the Powered Watercraft EV's onboard charging system to the first EV's onboard charging system, for direction and/or supply either to the first EV's Power Electronics Controller (that in turn manages the flow of the electrical energy sourced and/or delivered from the Powered Watercraft EV's traction battery, thereby managing the speed of the first EV's electric traction motor and the torque it produces); or to charge the first EV's battery pack, as can be selected using a switch disposed between the first EV's onboard charging system and the first EV's Power Electronics Controller and also between the first EV's onboard charging system and the first EV's battery pack.

In a preferred embodiment of the present disclosure, using the apparatus and system of the present disclosure, especially as taught in reference to FIG. C and FIG. D, the first EV supplies electrical energy from its own battery pack to its own Power Electronics Controller and thus traction motor while in use and driving and towing upon the Powered Watercraft EV while simultaneously recharging its own battery pack using electrical energy sourced from the battery pack of the Powered Watercraft EV.

In such embodiments, the present disclosure comprises a method for extending the range and/or the towing range of a first EV while the first EV is in use and towing upon a Powered Watercraft EV, the method comprising steps of: supplying electrical energy from the first EV's own battery pack to the first EV's own Power Electronics Controller while the first EV is in use and driving and towing upon a trailer upon which is removably situated the Powered Watercraft EV, while simultaneously recharging the first EV's own battery pack using electrical energy sourced from the battery pack of the Powered Watercraft EV.

In another preferred embodiment of the present disclosure, using the apparatus and system of the present disclosure, especially as taught in reference to FIG. C and FIG. D, the first EV supplies electrical energy from its own battery pack to its own Power Electronics Controller and thus traction motor while in use and driving and towing upon the Powered Watercraft EV, and, upon detecting a certain state of charge (SOC) of its own battery pack, switches to drawing electrical energy from the battery pack of the Powered Watercraft EV and directing said electrical energy sourced from the battery pack of the Powered Watercraft EV to the first EV's Power Electronics Controller.

In another preferred embodiment of the present disclosure, using the apparatus and system of the present disclosure, especially as taught in reference to FIG. C and FIG. D, while in use and driving and towing upon the Powered Watercraft EV, the first EV draws electrical energy from the battery pack of the Powered Watercraft EV and directs and/or supplies said electrical energy to the first EV's Power Electronics Controller.

In another preferred embodiment of the present disclosure, using the apparatus and system of the present disclosure, especially as taught in reference to FIG. C and FIG. D, while in use and driving and towing upon the Powered Watercraft EV, the first EV draws electrical energy from the battery pack of the Powered Watercraft EV and directs and/or supplies said electrical energy to the first EV's Power Electronics Controller, and, upon detecting a certain state of charge (SOC) of the Powered Watercraft EV's battery pack, switches to drawing electrical energy from the battery pack of the first EV and directing said electrical energy sourced from the battery pack of the first EV to the first EV's Power Electronics Controller.

### DETAILED DESCRIPTION OF THE DRAWINGS

### In Reference to FIG. A and FIG. A-A:

FIG. A provides a block diagram of an exemplary Range Extending System 300 for use with a preferred embodiment of the present disclosure, where that portion of System 300 that preferably is integral with the first EV is indicated by reference arrow 201; and that portion of the System 300 that preferably is integral with the Powered Watercraft EV is indicated by reference arrow 202; and, with system portions 201 and 202 detachably and mechanically connected by and at disconnectable connector 11, that can be a plug and/or connector and/or trailer plug of the present disclosure. When in use to effect the methods and system and apparatus of the present disclosure, the first EV system portion 201 and the second EV system portion 202 are mechanically connected to one another by disconnectable connector 11, that, in the most preferred embodiments of the present disclosure, comprises a trailer plug configured in accordance with the teachings of the present disclosure as is described more fully herein. Connecting the first EV to the Powered Watercraft EV by closing/connecting the detachable connection at connector 11 creates a direct conductive link and/or path between and joining any or all of the first EV's Power Electronics Controller(s) 514 and the Powered Watercraft EV's battery pack. While the block diagrams of FIG. A to FIG. D visibly show a single Power Electronics Controller (i.e. “motor controller”) in system portion 201 integral the first EV, such is for simplicity only and to not clutter the diagram, it being understood that the first EV may have a plurality of motor controllers, for example two, or three, or four motor controllers, where each motor controller is associated with an electric traction motor associated with at least one wheel of the first EV. When the first EV comprises multiple motor controllers, the first EV's system portion 201 may comprise a distinct electrical conductor electrically connecting any or all of said multiple motor controllers to the detachable connector 11, so that conceFting the first EV to the Powered Watercraft EV by closing/connecting the detachable connection at connector 11 creates a direct electrically conductive link between and joining any or all of the first EV's Power Electronics Controller(s) 514 and the Powered Watercraft EV's battery pack.

In this text, for simplicity, although it is understood that the first EV may comprise a plurality of motor controllers, the text shall refer to any or all motor controllers integral the first EV as a motor controller in the singular, although in some instances the plural is used. Also, in this text, the term “Powered Watercraft EV” is mainly present in its singular form for ease of comprehension of the text, however, it is understood that in this text the term “Powered Watercraft EV” is not limited to the singular, and can mean its plural form.

Preferably, the first EV's motor controller is configured to comprise an electrical switch in communication with and regulated by the first EV's control unit 109 (which in turn may be regulated by a user/driver/operator or by presets) where said electrical switch is configured to at least permit opening and closing an electrically conductive connection between said motor controller and at least two distinct electrical conductors leading into and/or attaching to said motor controller, where at least one of said electrical conductors is configured to conduct and supply electrical energy to the first EV's motor controller from the first EV's own battery pack; and, where at least another of said electrical conductors is configured to conduct and supply electrical energy to the first EV's motor controller from the Powered Watercraft EV's battery pack upon electrical connection of the first EV to the Powered Watercraft EV and especially upon electrical connection of the first EV's motor controller to the Powered Watercraft EV's battery pack, such as for example by closing/connecting the detachable connection at connector 11. Said switch integral the first EV's motor controller preferably is controlled by the first EV's control unit 109, so that the control unit performs the function of either opening or closing the electrical connection and/or path to and between the first EV's motor controller and either: the first EV's own battery pack; or, the Powered Watercraft EV's battery pack, according to whether it is desired to supply electrical energy to the first EV's motor controller solely and/or mainly from the Powered Watercraft EV's battery pack; or solely and/or mainly from the first EV's battery pack; or, simultaneously from both of said battery packs, including as described in greater detail further herein.

As described above, in the most preferred embodiment said electrical switch is integral the first EV's motor controller, where said electrical switch is configured to permit opening or closing (disconnecting or connecting) an electrically conductive connection between the first EV's motor controller and any of: the first EV's own battery pack; and, the Powered Watercraft EV(s)′ battery pack(s). However, in an alternate embodiment, illustrated in FIG. A-A, the function of said switch is performed by two distinct switches 55 and 53, where switch 55 is in-line between the first EV's motor controller and the Powered Watercraft EV's battery pack; and, where switch 53 is in-line between the first EV's motor controller and the first EV's battery pack.

Optionally again, but not shown in the drawings, an alternate switch can perform the function of switches 55 and 53, where such alternate switch is in-line between the first EV's motor controller and both of said battery packs. That is, where a conductive link and/or patch connects the first EV's battery pack to said alternate switch and a different conductive link and/or path connects the Powered Watercraft EV's battery pack also to said alternate switch, and said alternate switch also is in communication with the system controller 109, and where said alternate switch opens or closes the electrical connection and/or circuit between:
the first EV's motor controller and the first EV's battery pack; and,
the first EV's motor controller and the Powered Watercraft EV's battery pack, so that electrical energy is supplied to the first EV's motor controller from either one or the other of said battery packs, or, optionally, is simultaneously supplied to the first EV's motor controller from both of said battery packs.

### In Continuing Reference to FIG. A:

In one further detailed embodiment of the present disclosure, electrical energy is directed and/or supplied from the Powered Watercraft EV's battery 512 to the first EV's Power Electronics Controller 515, preferably while bypassing the Powered Watercraft EV's charging system 513, and also while bypassing the first EV's charging system 513. The first EV's motor controller preferably is configured with an electrical switch that permits connecting/disconnecting the electrical connection between the first EV's Power Electronics Controller (motor controller) and:
(i) the Powered Watercraft EV's battery; and
(ii) the first EV's battery pack, said switch being controlled by the system controller 109, as stated above. When it is desired to supply electrical energy from the Powered Watercraft EV's battery pack to the first EV's motor said controller, switch opens (disconnects) the electrically conductive path to and between the first EV's battery pack and the first EV's motor controller, and closes (connects) the electrically conductive path between the first EV's motor controller and the Powered Watercraft EV's battery pack (or, in the case of a plurality of Powered Watercraft EVs, to the battery packs of a plurality of Powered Watercraft EVs).

In continuing reference to FIG. A and FIG. A-A: Connect and Disconnect Sensor 417 permits the first EV's control unit 109 to detect the presence or absence of a Powered Watercraft EV of the present disclosure, and especially of its electrical system, and especially of elements and aspects of the Powered Watercraft EV's electrical system and/or components that the first EV's control unit 109 ideally monitors and is in communication/electrical communication with, including but not limited to the Powered Watercraft EV's battery pack and, preferably but optionally, the Powered Watercraft EV's control unit 109P, and, preferably but optionally, the Powered Watercraft EV's battery state of charge (SOC) and/or state of energy (SOE) sensor(s), as well as any of the Powered Watercraft EV's electrical power sensor(s) identifying Volts, Amperage, Ohms, Wattage and other properties of electrical energy able to be sourced from the Powered Watercraft EV's battery pack. At minimum, the system is arranged so as to permit the first EV's control unit 109 to detect the Powered Watercraft EV's battery pack. Preferably, the first EV's control unit 109 and the second EV's control unit 109P are configured and programmed to communicate with one another so as to permit at least the first EV to utilize the information detected and known to the Powered Watercraft EV'S control unit, such as, for example, to access information from the Powered Watercraft EV's battery SOC/SOE sensor 113; and, preferably, as well as to identify Volts, Amperage, Ohms, Wattage and other properties of electrical energy able to be sourced from the Powered Watercraft EV's battery pack and electrical architecture in general. Otherwise, the first EV's system portion 201 is itself configured to detect and ascertain and monitor the SOC/SOE of the Powered Watercraft EV's battery charge level; and, preferably as well, to detect and ascertain and monitor Volts, Amperage, Ohms, Wattage and other properties of electrical energy able to be sourced from the Powered Watercraft EV's battery pack and electrical architecture in general, so as to ensure compatibility of electrical energy sourced from the Powered Watercraft EV's battery pack with the electrical architecture and components of the first EV.

Although in the most preferred embodiment of the present disclosure the first EV's control unit/system controller 109 performs all functions for the system 300 that are performed by a control unit, it is envisioned that in some cases it may be desired that a similar designed and configured control unit be integral with a Powered Watercraft EV of the present disclosure. At the least, it is envisioned that any Powered Watercraft EV of the present disclosure would comprise a control unit 109P that either is configured by the manufacturer and/or receives updates so as to cause it to be configured to be capable of communicating with and informing the control unit 109 of the first EV of the identity of the Powered Watercraft EV as well as to relay to the first EV's control unit any/all information about the Powered Watercraft EV that is useful for enacting the methods of the present disclosure and for forming the system of the present disclosure, including information informing the first EV's control unit of the Powered Watercraft EV's electrical architecture and/or voltage architecture; battery pack voltage and capacity; battery pack SOC/SOE; charging system's capabilities, the properties of the electrical energy able to be sourced from the Powered Watercraft EV's battery pack, and other features necessary to most ideally enact the present disclosure's teachings. Communication between the first EV's control unit and the Powered Watercraft EV's control unit can also be provided through direct electrical link or, by over the air updates employing Communication Link 407. However, for safety reasons, direct physical monitoring and ascertaining of the Powered Watercraft EV's battery pack and the properties of electrical energy able to be sourced from its battery pack is important and preferred.

Preferably, the first EV and the Powered Watercraft EV are built with the same electrical architecture and/or same voltage architecture, for example, both the first and the Powered Watercraft EV are built with a 900 Volt architecture, or with a 1000 Volt architecture, or any desired same volt electrical vehicle architecture. However, it is not practically feasible that various different manufacturers of EV boats and EV PWC shall always make their various Powered Watercraft EVs with a same voltage and/or electrical architecture as a particular EV manufacturer makes their EV Pickups or EV SUVs or other EVs. Therefore, the apparatus and method of the present disclosure is capable of functioning when the first (and towing) EV and the towed and Powered Watercraft EV have differing voltage and/or electrical architectures. Preferably, as taught above, the first EV's Power Electronic Controller/motor controller by nature functions as an inverter but also comprises and functions as a circuit protector for the first EV's motor controller and thus electric traction motor; and, the first EV's onboard charging system and/or onboard bi-directional charging system also comprises and functions as an inverter and/or converter and as a circuit protector for electrical systems of the first EV.

Optionally, electrical circuit protection such as a circuit protector designed to ensure compatibility of electrical energy sourced from the Powered Watercraft EV's battery pack and the First EV's motor controller can be built into the First EV's motor controller (and. optionally, also into the First EV's onboard charging system). However, electrical circuit protection equipment such as a circuit protector can be installed anywhere inline between the connector 11 and the First EV's motor controller and/or its charging system.

### In Continuing Reference to FIG. A and FIG. A-A:

Upon detecting the presence of the Powered Watercraft EV, the first EV's control unit preferably makes a determination as to whether or not sufficient energy is contained in the Powered Watercraft EV's battery pack to be useful for powering at least the Motor Controller (and thus traction motor) of the first EV, which could be verifying that the SOC of the Powered Watercraft EV's battery is equal to or greater than a certain preset, and, preferably, notifies the user/driver of the SOC/SOE of the Powered Watercraft EV's battery pack as well as that of the first EV's battery pack. The user/driver may then opt to select to use the Powered Watercraft EV's battery pack energy to power the first EV's motor controller. This process is aided by the first EV communicating either with the Powered Watercraft EV's control unit so as to receive information as to the SOC of the Powered Watercraft EV's battery, as the Powered Watercraft EV monitors its own Battery SOC sensor; or, by the first EV directly communicating with and/or reading the Battery SOC sensor of the Powered Watercraft EV's battery through electrical communication via connector 11, or through an over the air communication, if desired.

When it is desired to use electrical energy from the Powered Watercraft EV's battery pack to power the first EV's motor controller and thus electric traction motor, the first EV's control unit causes connection of the first EV's motor controller directly to the Powered Watercraft EV's battery pack by closing/connecting the electrically conductive path between the first EV's motor controller and the Powered Watercraft EV's battery pack (such as either by the first EV's motor controller comprising a switch that allows connection/disconnection with the conductive paths as needed, as illustrated and described above in reference to FIG. A; or, alternately and in reference to FIG. A-A: such as by closing the switch 55) and, also prevents suitable electrically conductive connection of the first EV's own battery pack to and with the first EV's motor controller, such as by opening/disconnecting the electrically conductive patch between the first EV's motor controller and the first EV's own battery pack (such as either by the first EV's motor controller comprising a switch that allows connection/disconnection with the conductive paths as needed, as illustrated and described above in reference to FIG. A; or, alternately and in reference to FIG. A-A: such as by opening switch 53). Closing and/or connecting the conductive path between the Powered Watercraft EV's battery pack to the first EV's Power Electronic Controller (motor controller) enables the first EV to use electrical energy contained in the Powered Watercraft EV's battery pack just the same as if said electrical energy was contained in the first EV's battery pack.

Subsequently, after using electrical energy sourced from the Powered Watercraft EV's battery pack, such as to power the first EV's motor controller and thus traction motor for a certain driving distance, and/or when the control unit detects that the SOC of the Powered Watercraft EV's battery is below a certain level, that can be a preset, or, when the user/driver/system operator selects to do so, the control unit causes the first EV to use its own battery energy to power its Power Electronic Controller (i.e. “motor controller”), by steps that comprise opening/disconnecting the electrically conductive path between the first EV's motor controller and the Powered Watercraft EV's battery pack; and, closing/connecting the electrically conductive path between the first EV's motor controller and the first EV's own battery pack, thereby essentially causing the first EV to use its default power settings for powering its own motor controller.

At this point, or when such occurs, i.e. when the Powered Watercraft EV's battery charge has been consumed to power the first EV and/or has fallen to and/or otherwise is detected at or below a certain SOC, that may be a preset, it may be desired to, without interrupting the driving trip, supply electrical energy from regenerative brakes integral the first EV to charge the battery of the Powered Watercraft EV, and in such case the present disclosure's systems as shown in reference to FIG. B and FIG. C, as well as FIG. D, is most useful. Or, it might be desired to recharge the Powered Watercraft EV's battery pack, either while driving and from the battery pack of the first EV; or, upon reaching a certain destination and perhaps connecting the first EV to an external charger including a fast charger and then either choosing to supply charge directly from the charger to the Powered Watercraft EV's battery pack using the onboard charging system of the first EV as well as the system 300 of the present disclosure; or, to the first EV's battery pack and subsequently to the Powered Watercraft EV's battery pack, and in such case the systems as shown in reference to FIG. B and FIG. C, as well as FIG. D, are useful.

In continuing reference to FIG. A: Most preferably, the electrical connection between the first EV and the Powered Watercraft EV is made in such a way that the battery of the Powered Watercraft EV is directly connected to the Power Electronics Controller of the first EV, where, preferably, said Power Electronics Controller is configured so as to comprise circuit protection enabling ensuring that electrical energy drawn from the battery of the Powered Watercraft EV is suitable for use by the remaining components of the Power Electronics Controller. Thus, the Power Electronics Controller can itself comprise a circuit protector configured to ensure that electrical energy drawn from the battery of the Powered Watercraft EV is suitable for use by the remaining components of the Power Electronics Controller; or, alternatively, or additionally, the system can comprise a separate circuit protector situated in line between the battery of the Powered Watercraft EV and the Power Electronics Controller of the first EV (said circuit protector not shown).

Alternately and not preferred, and not shown in the drawing figures, the present disclosures teachings in reference to FIG. A and FIG. A-A can be used where rather than forming an electrically conductive path between the Powered Watercraft EV's battery pack and the first EV's motor controller, an electrically conductive path is be formed between the Powered Watercraft EV's charging system and the first EV's motor controller, and otherwise the teachings of the present disclosure as taught in reference to FIG. A and FIG. A-A apply. However, as stated, such is not presently preferred.

### In Reference to FIG. B:

FIG. B provides a block diagram of an exemplary Range Extending System 300′ for use with a preferred embodiment of the present disclosure, where that portion of the System that preferably is integral with the first EV is indicated by reference arrow 201′, and that portion of the System that preferably is integral with the Powered Watercraft EV is indicated by reference arrow 202′. The first EV system portion 201′ and the second EV system portion 202′ preferably are detachedly connected to one another by disconnectable connector 11, that, in the most preferred embodiments of the present disclosure, comprises a trailer plug configured in accordance with the teachings of the present disclosure as is described more fully herein.

The essential difference between the two alternate systems of the present disclosure depicted in FIG. A and FIG. B, is that in system 300′ depicted in FIG. B, the battery pack 512 of the Powered Watercraft EV is electrically connected to the first EV's onboard bi-directional charging system 513, rather than being directly connected to the first EV's motor controller (via switch 55), as in system 300 depicted in FIG. A.

If desired, the systems 300 and 300′ of FIG. A and FIG. B can be combined into a single system, thus permitting the advantages of both.

### In Further Reference to FIG. B:

Electrical energy is directed and/or supplied from the Powered Watercraft EV's battery 512 to the first EV's onboard charging system 513, preferably while bypassing the Powered Watercraft EV's charging system, where said electrical energy is for use either or both to supply the first EV's Power Electronics Controller/motor controller 515; or, to charge the first EV's battery pack 514, as can be selected using a switch 518 disposed between the first EV's onboard charging system and the first EV's Power Electronics Controller and also between the first EV's onboard charging system and the first EV's battery pack.

The present disclosure's system 300′ depicted in FIG. B functions similarly with respect to communicating with the Powered Watercraft EV's control unit and battery SOC sensor. However, electrical energy is sourced from the Powered Watercraft EV's battery pack to the first EV's onboard charging system, where it is directed either directly to the first EV's motor controller, for purposes of powering and regulating the first EV's traction motor; or, where it is directed to the first EV's battery pack 514, for purposes of charging the first EV's traction battery pack 514.

For example, when the control unit detects the connection of the Powered Watercraft EV to the first EV as described above in reference to FIG. A, and determines that sufficient charge is contained in the Powered Watercraft EV's battery pack for purposes of, for example, powering the first EV's traction motor for a certain drive, or according to a preset, by example as described above in reference to FIG. A, the first EV's control unit also ascertains the SOC of its own battery pack. The first EV's system controller can then direct electrical energy from the Powered Watercraft EV's battery pack either to the first EV's own battery pack, in order to charge the first EV's own battery pack; or, the first EV's motor controller, for purposes of controllably powering the first EV's traction motor, while preserving charge in the first EV's battery pack for future use.

For example, when the battery pack of the first EV is at or above a desired SOC, such as by way of example considered “fully charged”, and when the Powered Watercraft EV's battery pack also is at or above a desired state of charge, such as by way of example considered “fully charged”, the system's control unit can choose to use and supply electrical energy from the Powered Watercraft EV's battery pack to the first EV's motor controller via the first EV's onboard charging system; and then, when the battery charge level of the Powered Watercraft EV's battery back is at or below a certain SOC, can direct the first EV to resort to using electrical energy from its own battery pack to supply the first EV's motor controller, that is, to operate at its default setting of using electrical energy from its own battery pack to supply its motor controller.

### In Reference to FIG. C:

FIG. C provides a block diagram of an exemplary Range Extending System 300″ for use with a preferred embodiment of the present disclosure, where that portion of the System that preferably is integral with the first EV is indicated by reference arrow 201″, and that portion of the System that preferably is integral with the Powered Watercraft EV is indicated by reference arrow 202″. The first EV system portion 201″ and the second EV system portion 202″ preferably are detachedly connected to one another by disconnectable connector 11, that, in the most preferred embodiments of the present disclosure, comprises a trailer plug configured in accordance with the teachings of the present disclosure as is described more fully herein.

The essential difference between the two alternate systems of the present disclosure depicted in FIG. B and FIG. C, is that in system 300′ depicted in FIG. B, the battery pack 512 of the Powered Watercraft EV is electrically connected to the first EV's onboard bi-directional charging system 513, rather than being directly connected to the first EV's motor controller (via switch 55), as in system 300 depicted in FIG. A. However, in FIG. C, the battery pack 512 of the Powered Watercraft EV is electrically connected first to an onboard bi-directional charging system 511 integral the Powered Watercraft EV; and the Powered Watercraft EV's onboard bi-directional charging system 511 is then electrically connected to the first EV's onboard bi-directional charging system 513.

If desired, the systems 300′ and 300: of FIG. B and FIG. C can be combined into a single system, thus permitting the advantages of both.

Or, if desired, all systems of FIG. A, FIG. B and FIG. C can be combined into a single system, as depicted in FIG. D.

### In Further Reference to FIG. C:

Electrical energy is directed and/or supplied from the Powered Watercraft EV's battery to the Powered Watercraft EV's onboard charging system to the first EV's onboard charging system, where the Powered Watercraft EV's battery is the supply source of said electrical energy to the Powered Watercraft EV's charging system, where said electrical energy is for use either or both to supply the first EV's Power Electronics Controller (motor controller); or, to charge the first EV's battery pack, as can be selected using switch 518 disposed between the first EV's onboard charging and system the first EV's Power Electronics Controller and also between the first EV's onboard charging system and the first EV's battery pack, as already described in more detail above.

The system 300″ depicted in FIG. C can then be used in the same fashion as already described for using the system 300′ depicted in FIG. B. However, an added advantage exists in that the Powered Watercraft EV has its own onboard bi-directional charging system regulating electrical power flowing from the Powered Watercraft EV's battery pack to the system 201″ of the first EV; and also regulating electrical energy flowing from the system 201″ of the first EV to the system 202″ of the Powered Watercraft EV.

In any examples of the present disclosure pertaining to the systems depicted in FIG. A, FIG. B, FIG. C, and FIG. D, the system controller 109 can direct energy from the battery of the first EV to the first EV's motor controller, and then, when the SOC of the first EV's battery is at or below a certain SOC, that can be a preset, as detected by the system controller monitoring the first EV's Battery SOC Sensor 119, can electrically disconnect the first EV's battery from its motor controller, or greatly minimize the amount of electrical energy supplied by the first EV's battery to its motor controller, and electrically connect the Powered Watercraft EV's battery pack to either:
I) the first EV's motor controller, in the case of system 300 depicted in FIG. A; or
ii) the first EV's onboard charging system, in the case of system 300′ depicted in FIG. B; or
iii) the first EV's onboard charging system via the Powered Watercraft EV's onboard charging system, in the case of system 300″ depicted in FIG. C.

Furthermore, in the case of systems 300′ and 300″ depicted in FIG. B and FIG. C, the battery packs of the first EV and of the Powered Watercraft EV can be recharged from an external charger either simultaneously, or one after the other. For example, after a trip, when both battery packs are in need of charging or it is desired to charge them, the system controller 109 can selectively allow recharging of either or both the battery pack of the first EV and/or the Powered Watercraft EV, either simultaneously or one after the other in an order determined by the first EV's driver/operator, as optionally selected by the first EV's driver/operator responding to and entering prompts on the user interface 117.

In an embodiment not shown, the first EV can be configured to provide a direct electrical connection from its charge port to the onboard charging system of the Powered Watercraft EV, that is sensed and used by the system controller(s) 109 and/or 109P, so as to minimize electrical resistance and loss when charging the battery of the Powered Watercraft EV by steps comprising connecting the Powered Watercraft EV to the first EV, and connecting the first EV to an external charger, such as a fast charger.

Otherwise, the systems 300′ and 300″, as well as 300′″ of FIG. D below, all permit charging the Powered Watercraft EV's battery pack without disconnecting the Powered Watercraft EV from the first EV, and without independently connecting the Powered Watercraft EV to an external charger, by connecting the first EV to an external charger and opting to allow the system to charge the Powered Watercraft EV's battery pack, such as by entering and/or responding to prompts provided by the controller to the user/driver via the user interface 117.

### In Reference to FIG. D:

FIG. D depicts a system 300′″ that is a combination of all the systems of FIG. A, FIG. B, and FIG. C. Accordingly, the system 300′″ of FIG. D is able to perform any or all functions taught herein for systems 300, 300-A, 300′ and 300″ of FIG. A, FIG. B, and FIG. C.

In reference to FIG. A: Disclosed is a method for extending the range and/or the towing range of a first EV while the first EV is in use and towing upon a Powered Watercraft EV, the method comprising steps of: supplying electrical energy from the Powered Watercraft EV's battery pack to the first EV's Power Electronics Controller (for purposes of powering the first EV's electric traction motor) while the first EV is in use and driving and towing upon a trailer upon which is removably situated the Powered Watercraft EV.

### In Reference to FIG. B:

Disclosed is a method for extending the range and/or the towing range of a first EV while the first EV is in use and towing upon a Powered Watercraft EV, the method comprising steps of: supplying electrical energy from the Powered Watercraft EV's battery pack to the first EV's onboard charging system for supply either to the first EV's Power Electronics Controller (for purposes of powering the first EV's electric traction motor) while the first EV is in use and driving and towing upon a trailer upon which is removably situated the Powered Watercraft EV; or, for recharging the first EV's battery pack while the first EV simultaneously uses electrical energy from its own battery to supply its Power Electronics Controller (for purposes of powering the first EV's electric: traction motor).

Furthermore, in other embodiments of the present disclosure, using the apparatus and system of the present disclosure, especially as taught in reference to FIG. C and FIG. D, the battery of the Powered Watercraft EV is able to be fully charged by connecting the first EV to a charger, in such a fashion that connecting the first EV to a charger serves to charge the battery of the Powered Watercraft EV just the same as if the Powered Watercraft EV was itself connected to the charger.

In this text, it is understood that the first EV's Power Electronic Controller (that in this text also is termed “motor controller”) is configured to manage the flow of electrical energy delivered to the first EV's Electric Traction Motor, and the Power Electronic Controller may be contained unit or may be comprised of components dispersed from one another and/or situated in different portions of the first EV where such components are in electrical communication with one another so as to perform the functions and operations normally ascribed to a Power Electronic Controller, that is configured to manage the flow of electrical energy delivered to an EV's Electric Traction Motor, controlling the speed of the electric traction motor and the torque it produces. The Power Electronic Controller is also optionally known herein as an “Inverter/Motor Controller”.

In this text, it is understood that the term “charging system” when referring to the first EV's charging system and/or to the Powered Watercraft EV's charging system refers to an “onboard charging system”, and that all charging systems of the first EV and preferably also of the Powered Watercraft EV of the present disclosure preferably are configured at least to be capable of the fasted available battery charging and/or discharging, and are configured to be capable of the fastest available bi-directional charging, including as defined herein. That is to say, preferably, the charging system of both the first EV (that is also the towing EV) as well as of the Powered Watercraft EV each preferably is capable of Bi-Directional Charging as well as Vehicle to Vehicle Charging, and, preferably, is capable of any combination of any or all of: Bi-Directional Charging; Vehicle to Vehicle Charging; Vehicle to Load Charging; and, Vehicle to Grid charging. Furthermore, preferably, the charging system of both the first EV (that is also the towing EV) as well as of the Powered Watercraft EV each preferably is configured to also include and/or to also serve as a circuit protector so as to, for example, protect the first EV from any unsuitable electrical energy that might be sourced from the battery pack of the Powered Watercraft EV, and vice versa. The circuit protectors described herein are able to be comprised of any suitable circuit protector(s) including motor circuit protectors, motor protect circuit breakers, and other.

While in preferred embodiments of the teachings of the present disclosure both the first (and towing) EV as well as the Powered Watercraft EV each are equipped with Bi-Directional Charging, including as defined herein, the teachings of the present disclosure further include apparatus and methods to permit a first EV to power its electric traction motor and especially to power its Power Electronic Controller using electrical energy sourced from the battery pack of a Powered Watercraft EV that either does or does not have an onboard charging system enabled with and/or configured to be capable of Bi-Directional Charging, as depicted in FIG. A and FIG. A-A and other drawing figures in this disclosure especially in reference to system 300.

In less preferred embodiments of the present disclosure that may be desirable in order to reduce manufacture costs, such as in the event it is desired either to reduce the expense of manufacturing and equipping a Powered Watercraft EV with a suitable onboard bi-directional charging system, that, in such case the Powered Watercraft EV can be economically fitted with an electrical connection comprising an electrical cable or other conductor that electrically links the battery of the Powered Watercraft EV to an electrically conductive access port integral with the Powered Watercraft EV. The electrical link to the Powered Watercraft EV's battery is then able to be accessed by connecting a suitably fitted conductive cable to said access port, where the distal end of said suitably fitted conductive cable may be configured to plug into the trailer plug assembly integral the first EV, as in the case of an embodiment of the present disclosure where the system 201 integral the first EV is able to be directly electrically connected to said access port by a suitably fitted conductive cable. However, such is not preferable. Rather, it is more preferable that the system 201 of the first EV connects to the trailer upon which is removably situated the Powered Watercraft EV through the detachable trailer plug connector, and that another electrically conductive link such as an electrical cable communicates with and connects with the system 201 of the first EV through said trailer plug with said access port integral the Powered Watercraft EV, such as by providing another electrical plug integral the trailer that can be detachable connected to said access port integral the Powered Watercraft EV by for example a suitably fitted cable plug. Thus, by plugging the Powered Watercraft EV to an electrical connector integral the trailer electrically connecting said access port integral the Powered Watercraft EV with the trailer, the battery of the Powered Watercraft EV thus becomes electrically connected with the system 201 of the first EV.

However, more preferably, in a preferred example of this embodiment, the Powered Watercraft EVs battery pack is directly electrically linked to the charge port of the Powered Watercraft EV in such a fashion that the conductor that directly links to the Powered Watercraft EV's battery pack to its charge port is able to be accessed by the first EV's system 201 by attachment to a suitably configured plug integral with the first EV, such as included in the first EV's trailer plug, or that is included within an electrical connection port integral with the trailer upon which the Powered Watercraft EV is removably situated.

In systems 300, 300-A, 300′, 300″ and 300′″, system controller 109 and/or 109P includes a central processing unit (CPU) 401 and a memory 403. Memory 403 may be comprised of EPROM, EEPROM, flash memory, RAM, a solid state disk drive, a hard disk drive, or any other memory type or combination of memory types. The system controller 109 is coupled to a user interface 117. Depending upon the type of interface 117 used with the system, for example a touch-screen or similar display means, controller 109 may also include a graphical processing unit (GPU) 405. CPU 401 and GPU 405 may be separate or contained on a single chip set.

As noted above, controller 109 is coupled to a variety of electrical architecture components, thus allowing controller 109 to regulate electrical energy flow between at least: (I) the battery pack of the first EV and the battery pack of the Powered Watercraft EV; (ii) the battery pack of the first EV and the first EV's electric motor and/or electric drive; (iii) the battery pack of the Powered Watercraft EV and the first EV's electric motor and/or electric drive; (iv) regenerative brakes of the first EV and optionally of the trailer upon which is removably situated the Powered Watercraft EV and either or both the first EV's battery pack and/or the Powered Watercraft EV's battery pack; and (v) a charger removably and/or temporarily connectable to either or both the first EV and/or the Powered Watercraft EV and the battery pack of either or both the first EV and/or the Powered Watercraft EV, based on current driving conditions and/or user preferences and/or intended usage of either or both the first EV and/or the Powered Watercraft EV. Accordingly, controller 109 ideally is coupled at least to: a switch(s) integral the first EV's onboard charging system configured to direct electrical energy from the first EV's battery pack to the first EV's Power Electronics Controller coupled to its Electric Traction Motor; a switch(s) configured to direct energy from the battery pack of the Powered Watercraft EV to the first EV's Power Electronics Controller coupled to its Electric Traction Motor; a switch configured to direct energy from the battery pack of the Powered Watercraft EV to the battery pack of the first EV, that may be integral with the onboard charging system of the first EV; a switch(s) configured to direct energy from the first EV's battery pack to the battery pack of the Powered Watercraft EV, that also may be integral with the first EV's onboard charging system; a first EV battery pack State-of-Charge sensor 119; a Powered Watercraft EV battery pack State-of-Charge sensor 113; a Driving Range Calculator (not shown); and a Connect and Disconnect sensor 417 for detecting and identifying when a Powered Watercraft EV has been connected to the first EV and especially when the Powered Watercraft EV's electrical has been system connected to the electrical system of the first EV, especially in the manner and fashion as taught herein and using means and methods as taught herein, and also for identifying when such connection has been disconnected.

Controller 109 may also be used to monitor and/or control a variety of other vehicle functions, e.g., HVAC system operation, audio system operation, vehicle lights, general vehicle operation, etc. In at least one embodiment, controller 109 is coupled to a telecommunications link 407, thus providing a means for controller 109 to receive configuration updates from an external data source (e.g., manufacturer, dealer, service center, web-based application, remote home-based system, etc.). Mobile telecommunications link 407 may be based on any of a variety of different standards including, but not limited to, GSM EDGE, UMTS, CDMA2000, DECT, and WiMAX.

With reference to FIG. E to FIG. W: any use of the term “EV Boat” in these drawing figures is by way of example and for brevity of the text in the drawing figures and to facilitate a rapid visual understanding of the technology, and is interchangeable with the term “Powered Watercraft EV” as disclosed herein and applies to any vehicles and/or boats and/or water craft disclosed herein as being applicable to and/or included within the term “Powered Watercraft EV”, in its singular and plural forms, including but not limited to EV Sea Doos, EV Jet Skis and EV Waverunners; and, the term “first EV” is used interchangeably with and/or includes the terms “EV Pickup; EV SUV; EV sedan; EV light truck; EV Truck; EV van; EV Jeep; EV Hummer; EV Landcruiser; and other, as also elsewhere disclosed herein. Furthermore, as stated above, the singular includes the plural herein when referring to motor controllers and motors of the first EV. It is understood that the first EV may have from one motor controller coupled to an electric motor coupled to at least a wheel of the first EV, to having a plurality of motor controllers each coupled to at least a distinct electric motor coupled to at least a wheel of the first EV. For example, the first EV may have four distinct motor controllers, each coupled to a distinct electric motor, each distinct electric motor in turn coupled to at least a wheel of the first EV. It is understood that when the present disclosure states that electrical energy is supplied to and/or used to power a motor controller that said motor controller is coupled to a corresponding electric motor (for example, an electric traction motor) that in turn is coupled to at least a corresponding wheel of the first EV, and that said electrical energy that is supplied to and/or used to power said motor controller is also being used to power the electric motor coupled to said motor controller, where the motor controller serves the purpose as described herein and also as well known in the industry.

The present disclosure includes combining a plurality of Powered Watercraft EVs on a trailer and/or on a platform of a trailer of the present disclosure where each of said Powered Watercraft EVS comprises a battery pack, and connecting each one of a plurality of said Powered Watercraft EVs to a distinct and separate electrical port mounted on the trailer, where each port provides connection of each Powered Watercraft EV's battery pack and/or charging system with the first EV's system 201, 201-A through 201″′, whereby the control unit directs electrical energy either from or to each of the Powered Watercraft EVs so as to enact the teachings of the present disclosure;

FIG. E illustrates the basic methodology of the invention in accordance with a preferred embodiment, where the method comprises steps of: detecting connection to the first EV of a Powered Watercraft EV (and, more specifically, of the Powered Watercraft EV's battery pack and, preferably also detecting the SOC/SOE of its battery pack, and, ideally, also detecting connection to the first EV of the Powered Watercraft EV's electrical system and especially of its portion 202-202′″ of the system of the present disclosure); determining if the SOC/SOE of the Powered Watercraft EV's battery pack is sufficient to power the first EV's motor controller(s) and motor(s); and if not, using electrical energy from the first EV's own battery pack to supply and/or power its motor controller; but if “yes”, using electrical energy from the Powered Watercraft EV's battery pack to supply and/or power the first EV's motor controller including while the first EV is in use and driving; continuing to monitor the Powered Watercraft EV battery pack's SOC/SOE; and, when the Powered Watercraft EV's battery pack falls below a certain SOC/SOE; stopping or mainly stopping using electrical energy from the Powered Watercraft EV's battery pack to supply and/or power the first EV's motor controller and commencing using electrical energy from the first EV's battery pack to supply and/or power and/or primarily supply and/or power the first EV's motor controller.

Alternatively, the method eliminates the following steps: “determining if the SOC/SOE of the Powered Watercraft EV's battery is sufficient to power the first EV's motor controller(s) and motor(s); and if not, using electrical energy from the first EV's own battery pack to supply and/or power its motor controller; but if “yes”,”. Rather, the step the step following of “detecting connection to the first EV of a Powered Watercraft EV (and, more specifically, of the Powered Watercraft EV's battery pack . . . ” is the step of “using electrical energy from the Powered Watercraft EV's battery pack to supply and/or power the first EV's motor controller . . . ”.

### In Further Reference to FIG. E, Preferably:

the step of “detecting connection to the first EV of a Powered Watercraft EV” is performed by a system controller, and, preferably, by a system controller coupled to a suitably configured sensor. An example of a suitably configured sensor is a sensor configured to detect the connection to at least the system of the present disclosure of the first EV to at least the electrical system and/or electrical architecture and/or portion 202-202″ of the Powered Watercraft EV's system of the present disclosure.
the step of “determining if the SOC/SOE of the Powered Watercraft EV's battery is sufficient to power the first EV's motor controller(s) and motor(s)” is performed by said system controller; and, where a certain preset can be used by said system controller in performing said determination, for example, the preset can be a minimum amount of charge and/or kilowatt hours, such as for example determined required for a minimum trip distance and/or driving time, that may be calculated taking into account the load and drag of the Powered Watercraft EV, where the energy requirements and battery drain due to the load and drag of a certain Powered Watercraft EV may be already known and inputted and/or otherwise accessible to the controller and thus to the system of the present disclosure. (However, in other embodiments, the user/driver may perform said step, especially in response to a prompt offered on the user interface, where the prompt may display information informing the user/driver of the SOC/SOE of the Powered Watercraft EV's battery pack and may further provide a suggestion as to whether or not sufficient SOC/SOE exists therein to permit its use, or for how long said SOC/SOE is predicted to be able to operate the first EV including taking into consideration the load and drag of the Powered Watercraft EV at predicted driving speeds and the battery drain likely to be caused by such load and drag; where the step of offering said prompt may be performed by said system controller.)
the step of “and if not, using electrical energy from the first EV's own battery pack to supply and/or power its motor controller” is performed by said system controller. (However, in other embodiments, the user/driver may perform said step, especially in response to a prompt offered on the user interface, where the step of offering said prompt may be performed by said system controller.)
the step of “but if “yes”, using electrical energy from the Powered Watercraft EV's battery pack to supply and/or power the first EV's motor controller while the first EV is in use and driving” is performed by said system controller. (However, in other embodiments, the user/driver may perform said step, especially in response to a prompt offered on the user interface, where the step of offering said prompt may be performed by said system controller.)
the step of “continuing to monitor the Powered Watercraft EV battery pack's SOC/SOE” is performed by said system controller. (However, in other embodiments, the user/driver may perform said step, especially in response to a series of periodically updated prompts offered on the user interface displaying the Powered Watercraft EV battery packs SOC/SOE, where the prompts may display information informing the user/driver of the SOC/SOE of the Powered Watercraft EV's battery pack and may further provide a suggestion as to whether or not sufficient SOC/SOE exists therein to permit its use, or for how long said SOC/SOE is predicted to be able to operate the first EV including taking into consideration the load and drag of the Powered Watercraft EV at predicted driving speeds and the battery drain likely to be caused by such load and drag; where the step of offering said prompts may be performed by said system controller.)
the step of “and, when the Powered Watercraft EV's battery pack falls below a certain SOC/SOE; stopping or mainly stopping using electrical energy from the Powered Watercraft EV's battery pack to supply and/or power the first EV's motor controller and commencing using electrical energy from the first EV's battery pack to supply and/or power and/or primarily supply and/or power the first EV's motor controller” is performed by said system controller. (However, in other embodiments, the user/driver may perform said step, especially in response to a prompt offered on the user interface, where the step of offering said prompt may be performed by said system controller.)

FIG. F illustrates a modified methodology based on that shown in FIG. E; where electrical energy from the Powered Watercraft EV's battery pack is used to charge the first EV's battery pack (including while the first EV is in use and driving) rather than to power the first EV's motor controller. That is to say, the method illustrated in FIG. F differs from the method illustrated in FIG. E primarily in that the step in FIG. E of “using electrical energy from the Powered Watercraft EV's battery pack to power the first EV's motor controller including while the first EV is in use and driving” is replaced by the step of “using electrical energy from the Powered Watercraft EV's battery pack to charge the first EV's battery pack including while the first EV is in use and driving. (Otherwise, the participation or possible participation in the methods steps of both the system controller and/or the user/driver is similar as described for FIG. E.)

Alternatively, the method eliminates the following steps: “determining if the SOC/SOE of the Powered Watercraft EV's battery is sufficient to power the first EV's motor controller(s) and motor(s); and if not, using electrical energy from the first EV's own battery pack to supply and/or power its motor controller; but if “yes”,”. Rather, the step following the step of “detecting connection to the first EV of a Powered Watercraft EV (and, more specifically, of the Powered Watercraft EV's battery pack . . . ” is the step of “using electrical energy from the Powered Watercraft EV's battery pack to charge the first EV's battery pack including while the first EV is in use and driving . . . ”.

FIG. G illustrates a modified methodology based on that shown in FIG. E and FIG. F, where electrical energy from the Powered Watercraft EV's battery pack is used to simultaneously both charge the first EV's battery pack including while the first EV is in use and driving as well as to power the first EV's motor controller while the first EV is in use and driving. That is to say, the method illustrated in FIG. G differs from the methods illustrated in FIG. E and FIG. F primarily in that the step in FIG. E of “using electrical energy from the Powered Watercraft EV's battery pack to power the first EV's motor controller while the first EV is in use and driving” and the step in FIG. F of “using electrical energy from the Powered Watercraft EV's battery pack to charge the first EV's battery pack including while the first EV is in use and driving” is replaced by the step of “using electrical energy from the Powered Watercraft EV's battery pack to simultaneously both charge the first EV's battery pack including while the first EV is in use and driving as well as to supply and/or power the first EV's motor controller, also while the first EV is in use and driving. (Otherwise, the participation or possible participation in the methods steps of both the system controller and/or the user/driver is similar as described for FIG. E. and FIG. F)

Alternatively, the method eliminates the following steps: “determining if the SOC/SOE of the Powered Watercraft EV's battery is sufficient to power the first EV's motor controller(s) and motor(s); and if not, using electrical energy from the first EV's own battery pack to supply and/or power its motor controller; but if “yes”,”. Rather, the step following the step of “detecting connection to the first EV of a Powered Watercraft EV (and, more specifically, of the Powered Watercraft EV's battery pack . . . ” is the step of “using electrical energy from the Powered Watercraft EV's battery pack to simultaneously both charge the first EV's battery pack including while the first EV is in use and driving as well as to supply and/or power the first EV's motor controller, also while the first EV is in use and driving.”.

FIG. H illustrates a modified methodology based on that shown in FIG. E; where, instead of the system (preferably automatically/autonomously) determining whether or not to use electrical energy from the Powered Watercraft EV's battery pack to power the first EV, the system prompts the user/driver to choose to use electrical energy from the Powered Watercraft EV's battery pack or from the first EV's battery pack to power the first EV; the system then comprises further steps of: the system detecting/receiving a prompt from the user/driver opting to use electrical energy from the Powered Watercraft EVs battery pack to power the first EV; determining if the SOC/SOE of the Powered Watercraft EV's battery is sufficient to power the first EV's motor controller; and if not, using the first EV's own battery pack to power its motor controller; but if “yes”, using electrical energy from the Powered Watercraft EV's battery pack to power the first EV's motor controller while the first EV is in use and driving; continuing to monitor the Powered Watercraft EV battery pack's SOC/SOE; and, when the Powered Watercraft EV's battery pack falls below a certain SOC/SOE; stopping or mainly stopping using electrical energy from the Powered Watercraft EV's battery pack to power the first EV's motor controller and commencing using electrical energy from the first EV's battery pack to power and/or primarily power the first EV's motor controller. (Optionally, the first step of determining if the SOC/SOE of the Powered Watercraft EV's battery is sufficient to power the first EV's motor controller can occur prior to the system prompting the user/driver to choose to use electrical energy from the Powered Watercraft EV's battery pack or from the first EV's battery pack to power the first EV's motor controller, and to make said prompt only when the SOC/SOE is determined sufficient; and otherwise to make no prompt and/or to inform the user/driver that the Powered Watercraft EV's battery is not sufficiently charged to be used to power the first EV's motor controller).

### In Further Reference to FIG. H:

optionally, the step of “the system prompts the user/driver to choose to use electrical energy from the Powered Watercraft EV's battery pack or from the first EV's battery pack to power the first EV” may be replaced by a step of “the system prompts the user/driver to choose to use electrical energy from either or both the Powered Watercraft EV's battery pack or from the first EV's battery pack to power the first EV”; and, optionally, the steps of “the system detecting/receiving a prompt from the user/driver opting to use electrical energy from the Powered Watercraft EVs battery pack to power the first EV; determining if the SOC/SOE of the Powered Watercraft EV's battery is sufficient to power the first EV's motor controller; and if not, using the first EV's own battery pack to power its motor controller; but if “yes”, using electrical energy from the Powered Watercraft EV's battery pack to power the first EV's motor controller while the first EV is in use and driving; continuing to monitor the Powered Watercraft EV battery pack's SOC/SOE; and, when the Powered Watercraft EV's battery pack falls below a certain SOC/SOE; stopping or mainly stopping using electrical energy from the Powered Watercraft EV's battery pack to power the first EV's motor controller and commencing using electrical energy from the first EV's battery pack to power and/or primarily power the first EV's motor controller” may be replaced by a step of the user/driver opting to use electrical energy from both the battery pack of the Powered Watercraft EV as well as from the battery pack of the first EV; and, subsequently, comprises a further step of supplying electrical energy from the battery packs of both the Powered Watercraft EV as well as of the first EV to the first EV's motor controller (such as may be useful when both the Powered Watercraft EV's battery pack as well as the first EV's battery pack are severely depleted but it is required to continue travelling); and, further optionally, may comprise additional steps of informing the user/driver via the user interface of what if any advantage can be gained by using both battery packs simultaneously, such as for example what amount of extended driving range is calculated as possible or what speed or acceleration is calculated as possible.

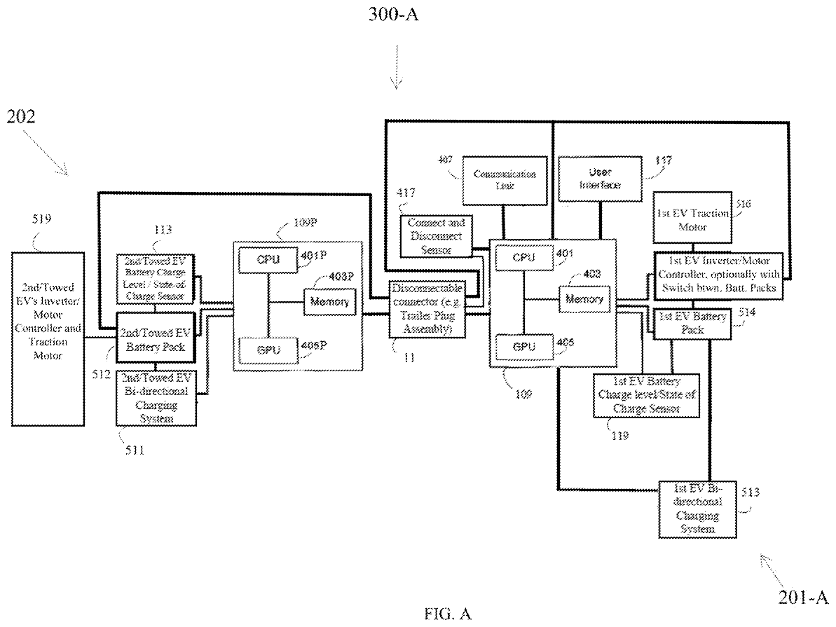

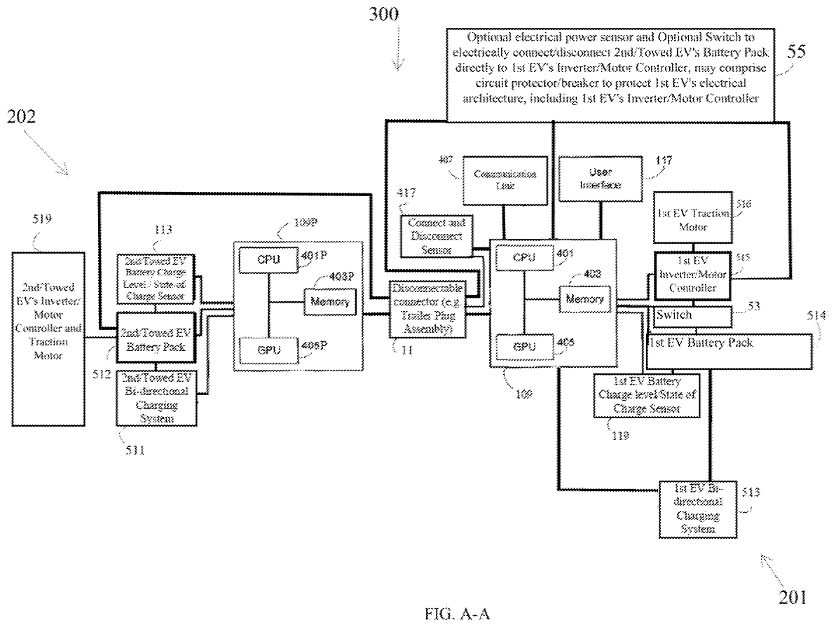

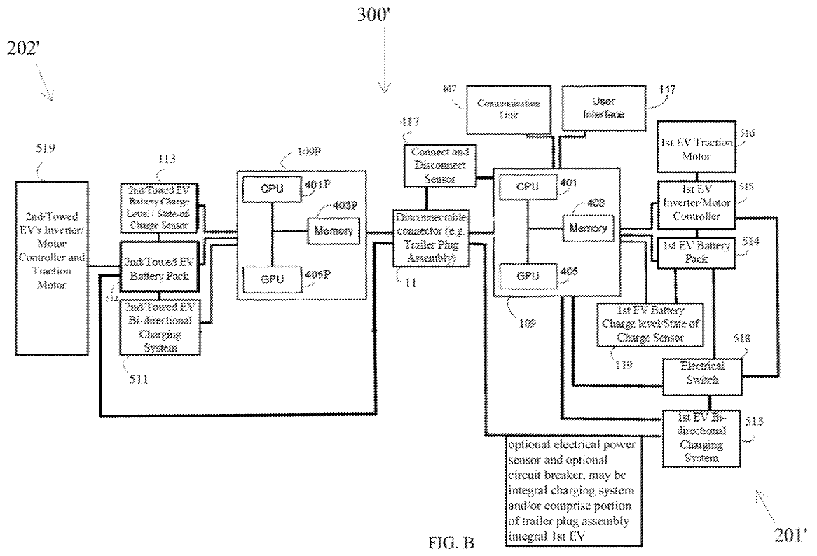

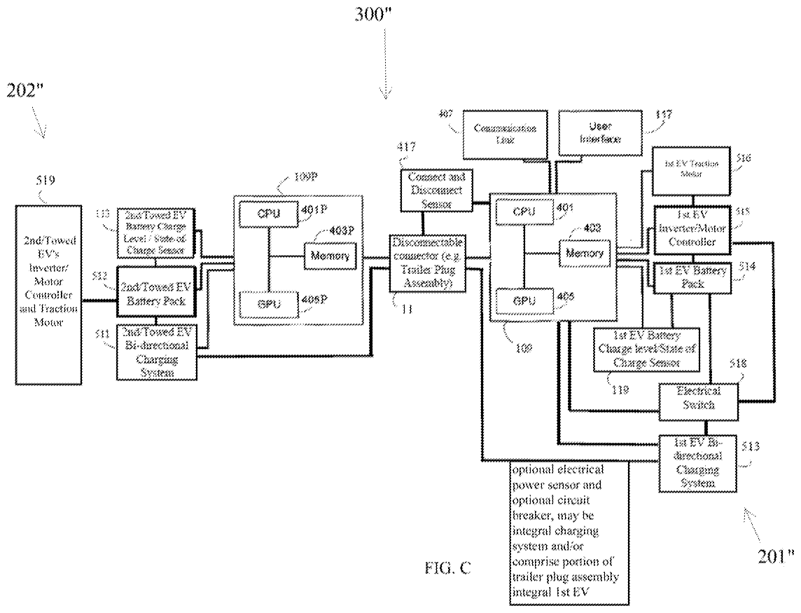

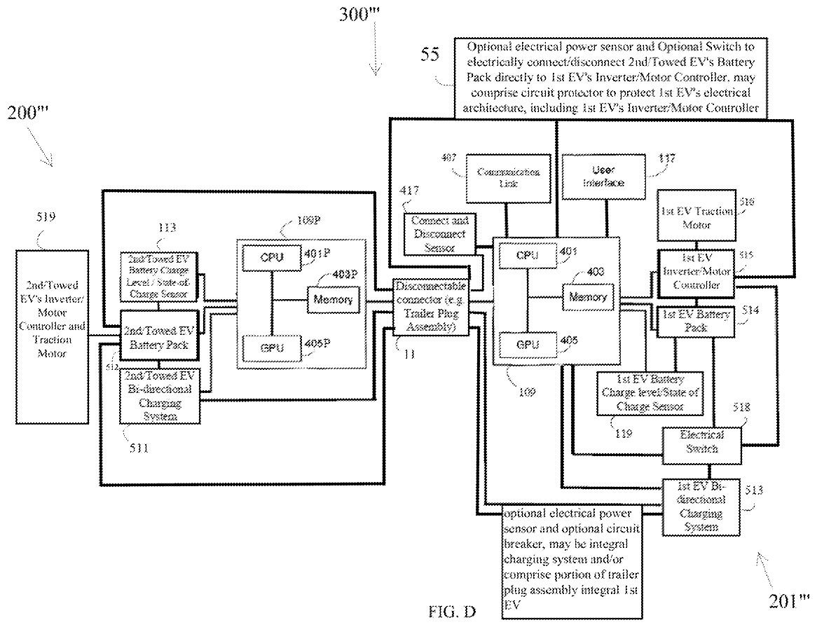

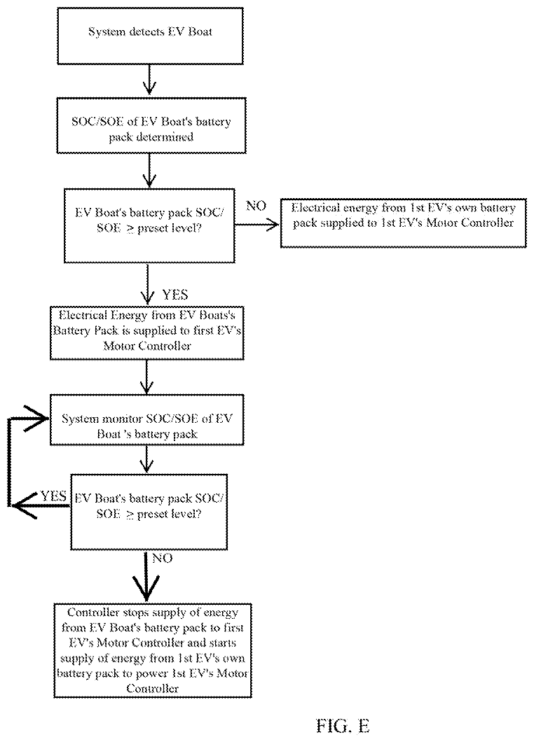

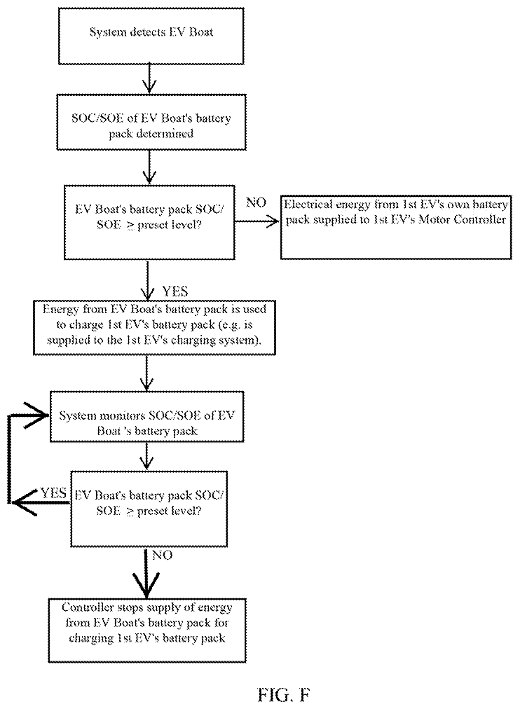

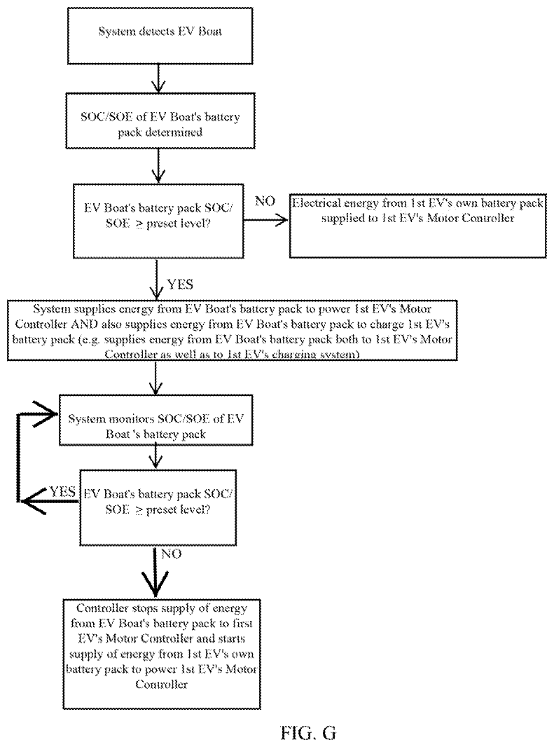

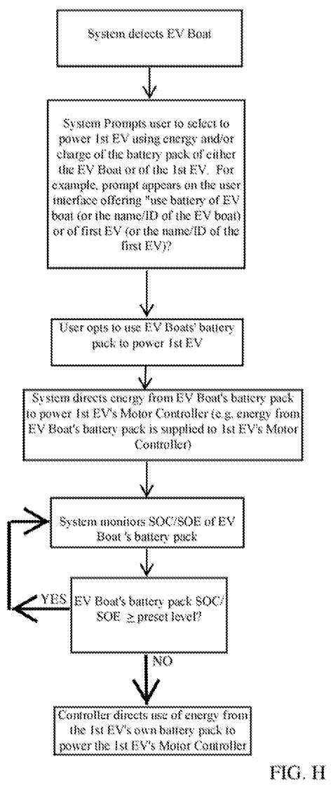

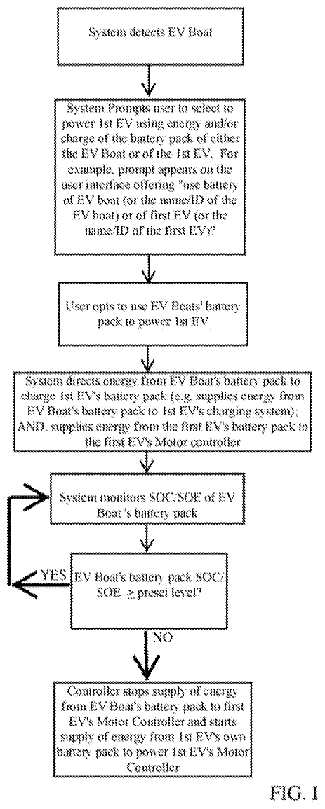

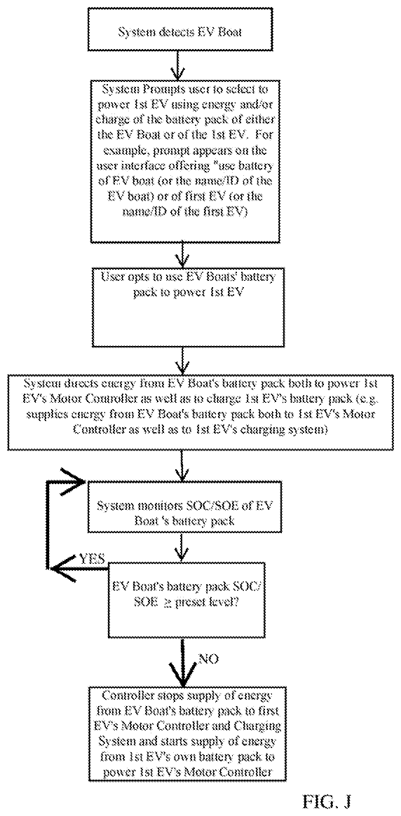

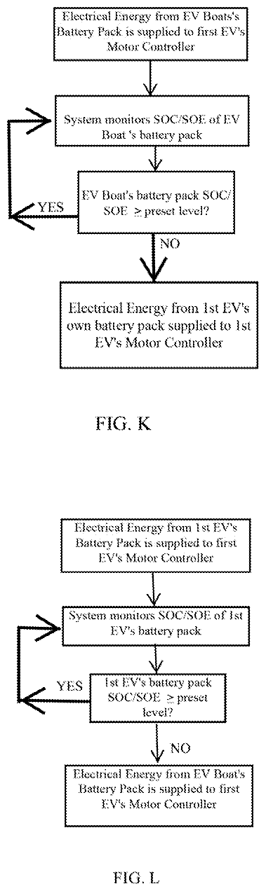

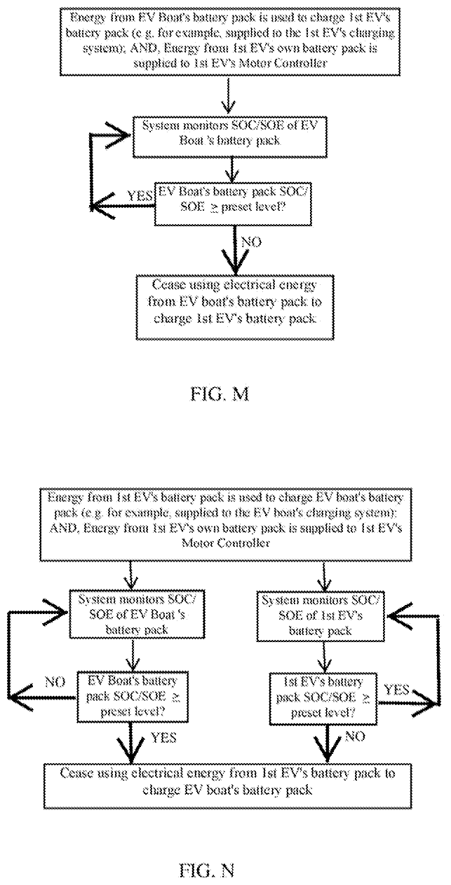

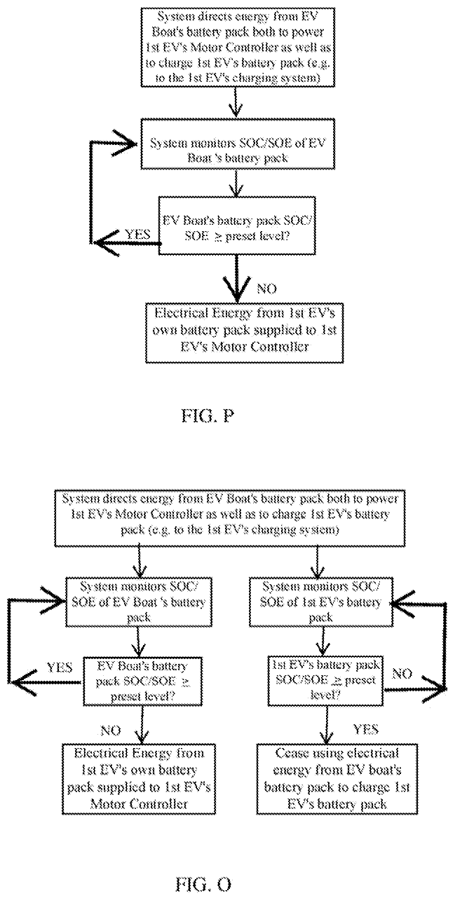

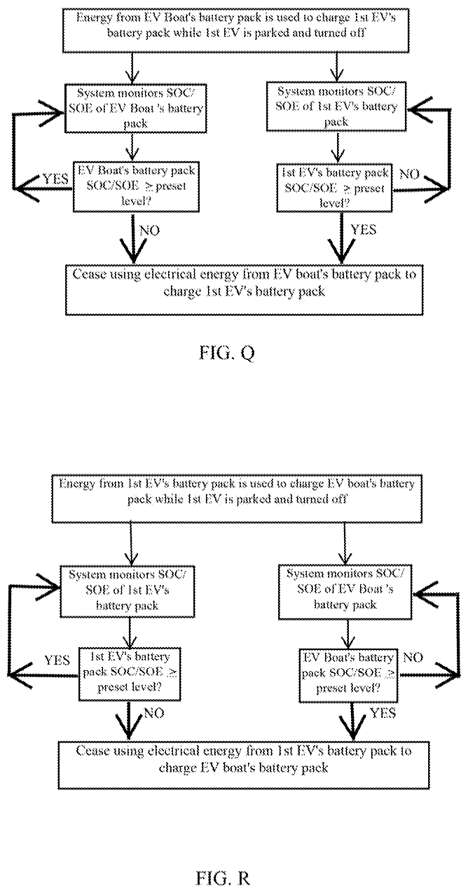

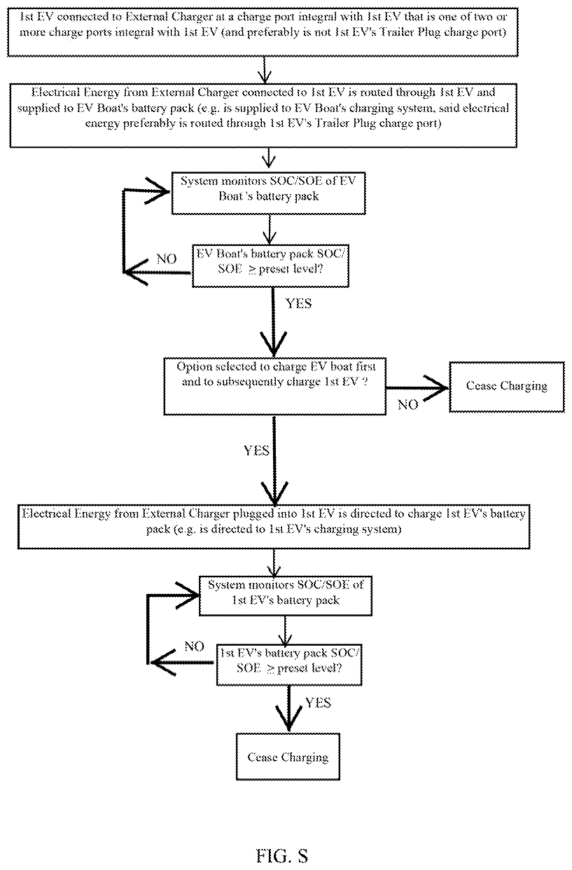

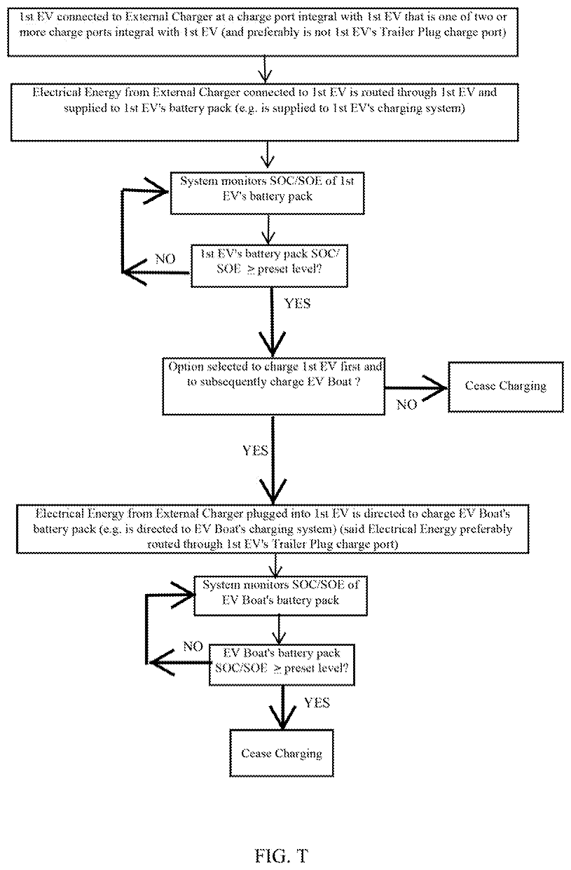

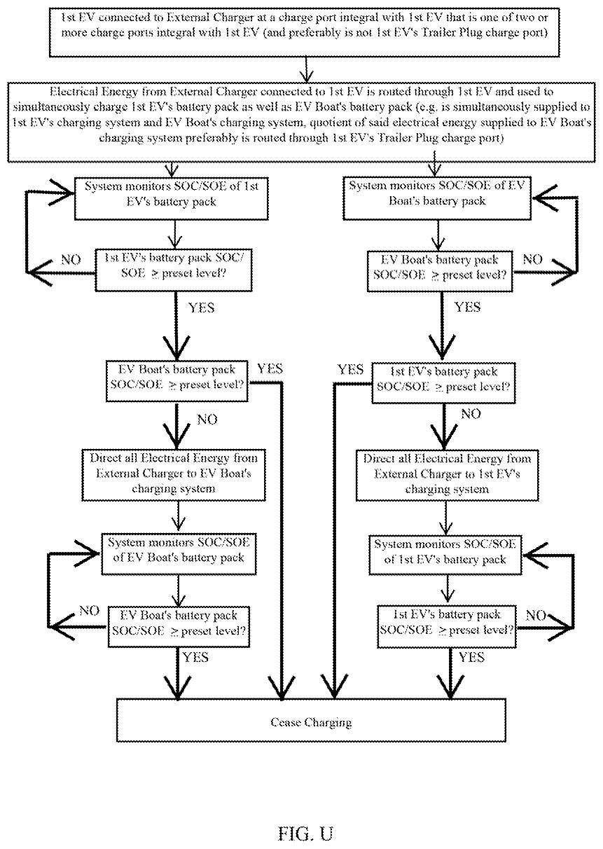

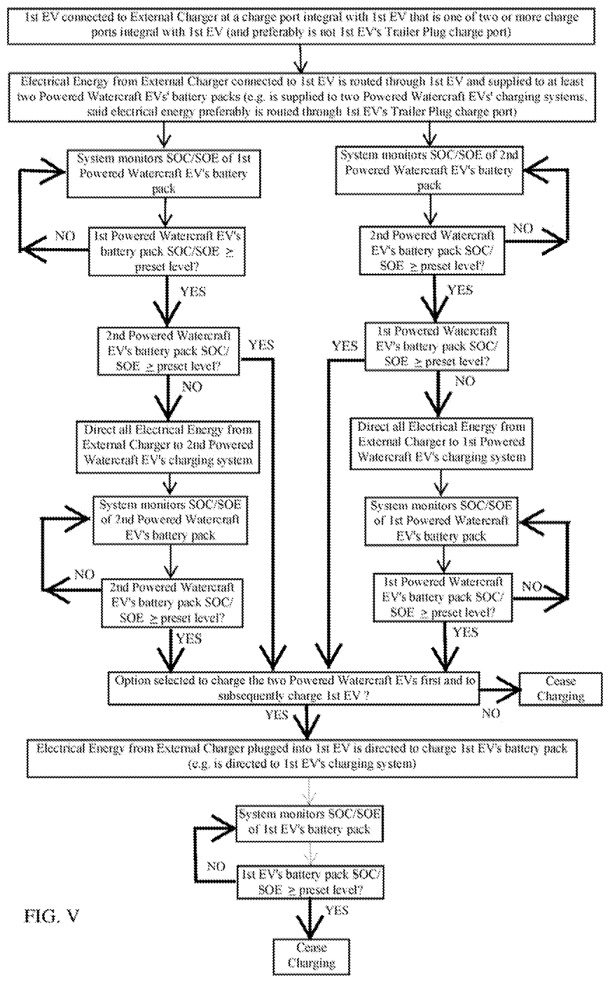

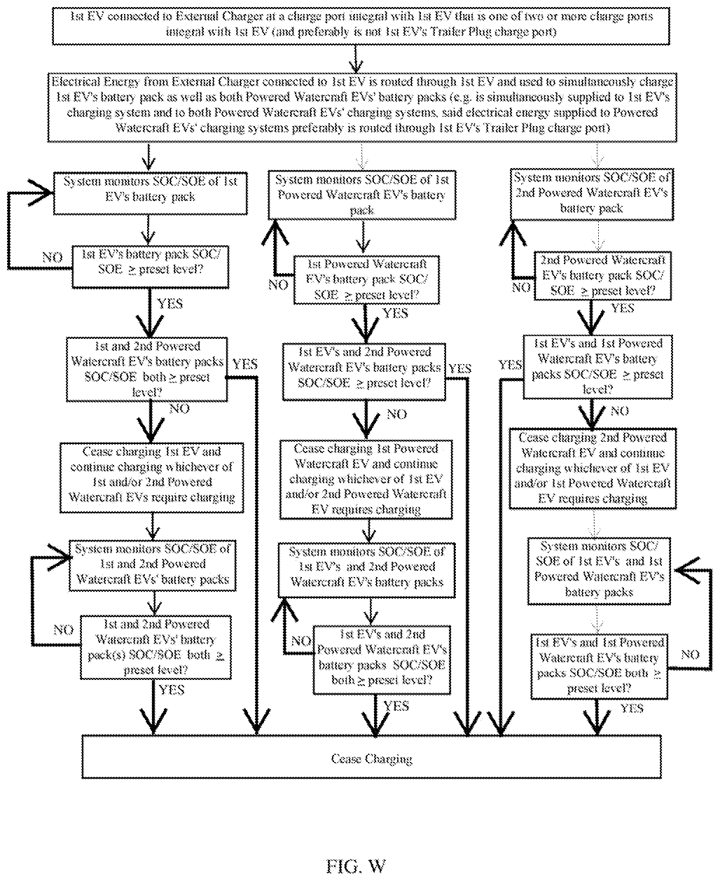

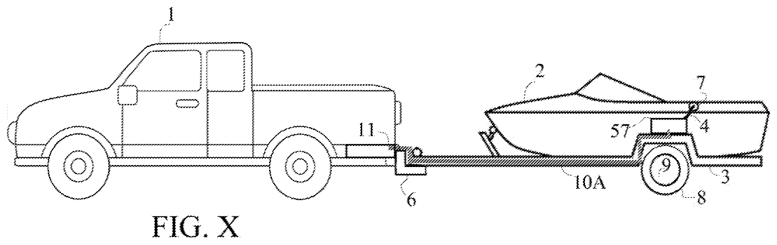

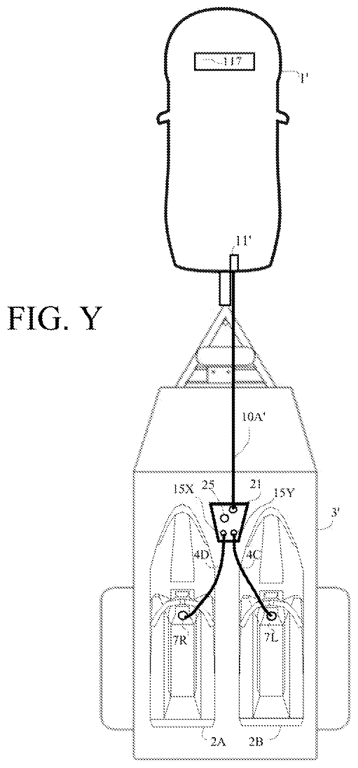

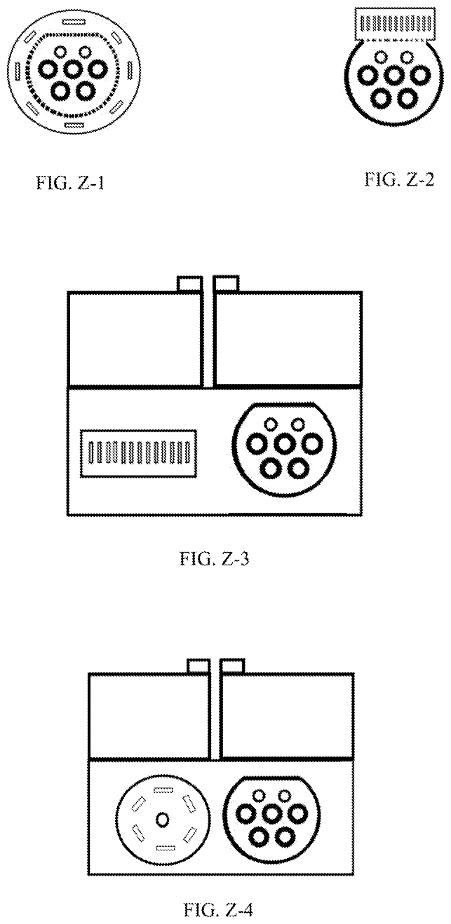

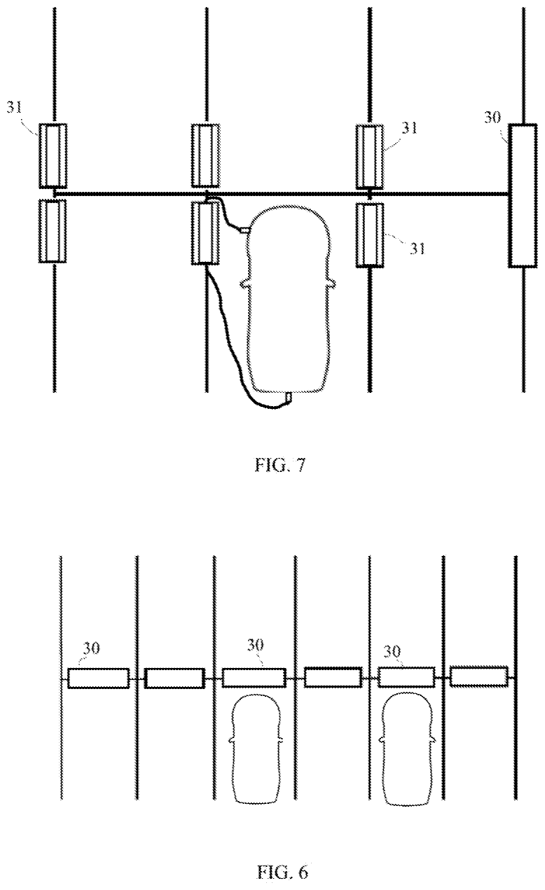

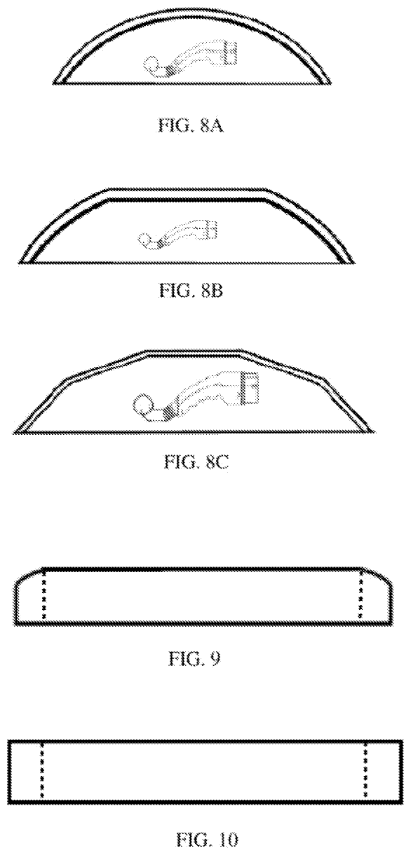

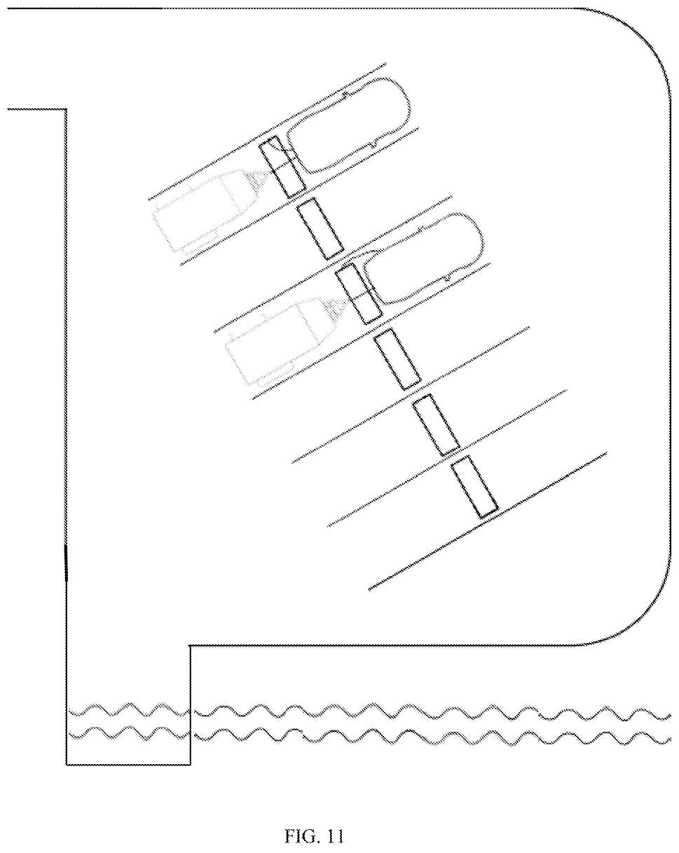

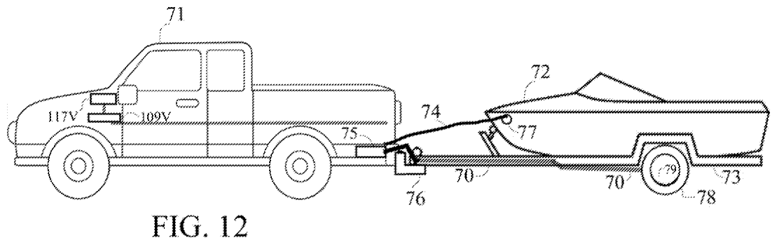

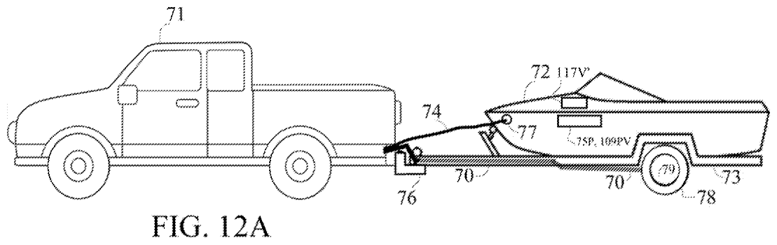

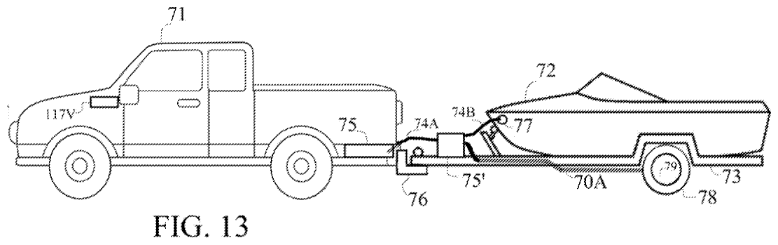

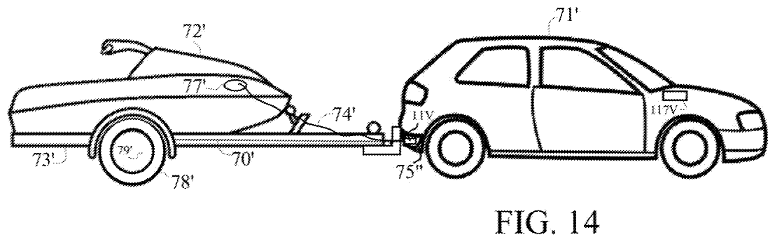

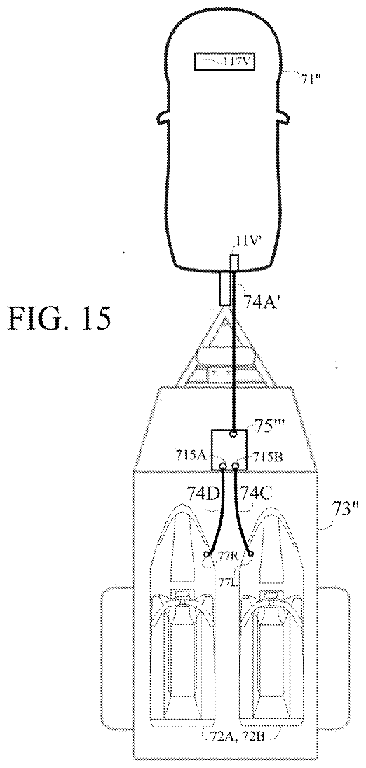

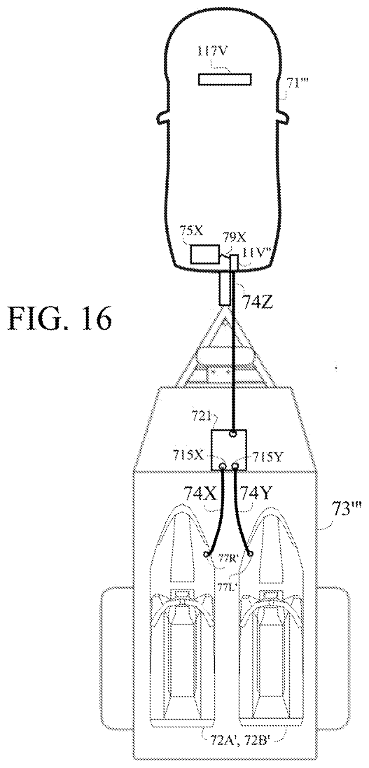

FIG. 1 illustrates a modified methodology based on that shown in FIG. F; where, instead of the system (preferably automatically/autonomously) determining whether or not to use electrical energy from the Powered Watercraft EV's battery pack to power first EV, the system prompts the user/driver to choose to use electrical energy from the Powered Watercraft EV's battery pack or from the first EV's battery pack to power the first EV; the system then comprises further steps of: the system detecting/receiving a prompt from the user/driver opting to use electrical energy from the Powered Watercraft EVs battery pack to power the first EV; determining if the SOC/SOE of the Powered Watercraft EV's battery is sufficient to charge the first EV's battery pack; and if “yes”, using electrical energy from the Powered Watercraft EV's battery pack to charge the first EV's battery, including while the first EV is in use and driving, while, preferably, supplying electrical energy from the first EV's battery pack to the first EV's motor controller; continuing to monitor the Powered Watercraft EV battery pack's SOC/SOE; and, when the Powered Watercraft EV's battery pack falls below a certain SOC/SOE; stopping or mainly stopping using electrical energy from the Powered Watercraft EV's battery pack to charge the first EV's battery pack. (Optionally, the first step of determining if the SOC/SOE of the Powered Watercraft EV's battery is sufficient to charge the first EV's battery pack can occur prior to the system prompting the user/driver to choose to use electrical energy from the Powered Watercraft EV's battery pack or from the first EV's battery pack to power the first EV, and to make said prompt only when the SOC/SOE is determined sufficient; and otherwise to make no prompt or to inform the user/driver that the Powered Watercraft EV's battery is not sufficiently charged to be used to power the first EV).

FIG. J illustrates a modified methodology based on that shown in FIG. G; where, instead of the system (preferably automatically/autonomously) determining whether or not to use electrical energy from the Powered Watercraft EV's battery pack to power the first EV, the system prompts the user/driver to choose to use electrical energy from the Powered Watercraft EV's battery pack or from the first EV's battery pack to power the first EV; the system then comprises further steps of: the system detecting/receiving a prompt from the user/driver opting to use electrical energy from the Powered Watercraft EVs battery pack to power the first EV; determining if the SOC/SOE of the Powered Watercraft EV's battery is sufficient to both to charge the first EV's battery pack as well as to power the first EV's motor controller; and if “yes”, using electrical energy from the Powered Watercraft EV's battery pack to simultaneously both charge the first EV's battery pack while the first EV is in use and driving as well as to power the first EV's motor controller while the first EV is in use and driving; continuing to monitor the Powered Watercraft EV battery pack's SOC/SOE; and, when the Powered Watercraft EV's battery pack falls below a certain SOC/SOE; stopping or mainly stopping using electrical energy from the Powered Watercraft EV's battery pack; and, preferably, using charge from the first EV's battery pack to power the first EV's motor controller. (Optionally, the first step of determining if the SOC/SOE of the Powered Watercraft EV's battery is sufficient to both to charge the first EV's battery pack as well as to power the first EV's motor controller can occur prior to the system prompting the user/driver to choose to use electrical energy from the Powered Watercraft EV's battery pack or from the first EV's battery pack to power the first EV, and to make said prompt only when the SOC/SOE is determined sufficient; and otherwise to make no prompt or to inform the user/driver that the Powered Watercraft EV's battery is not sufficiently charged to be used to power the first EV).

FIG. K illustrates an abbreviated and modified methodology based upon that shown in FIG. E; where the system's methodology comprises steps of: supplying electrical energy from the Powered Watercraft EV's battery pack to the first EV's motor controller; monitoring the SOC/SOE of the Powered Watercraft EV's battery pack; and, when the SOC/SOE of the Powered Watercraft EV's battery pack is above a certain SOC/SOE continuing to supply electrical energy from the Powered Watercraft EV's battery pack to the first EV's motor controller; and, when the SOC/SOE of the Powered Watercraft EV's battery pack is below a certain SOC/SOE discontinuing and/or mainly discontinuing supply of electrical energy from the Powered Watercraft EV's battery pack to the first EV's motor controller; and, supplying electrical energy form the first EV's battery pack to power the first EV's motor controller. The method steps may be enacted by the user/driver, including in response to prompts offering the user/driver to enact each step; or, the method steps may be performed by the system controller; or, a first step may comprise a prompt displayed on the user interface prompting the user/driver to choose to make a default setting and/or to commence to use electrical energy from the Powered Watercraft EV's battery pack (ostensibly to supply the first EV's motor controller, but that information need not appear on the interface) and to, upon the SOC/SOE of the Powered Watercraft EV's battery pack reaching a certain low level, commence using electrical energy from the first EV's battery pack (ostensibly to supply the first EV's motor controller, but that information need not appear on the interface).

FIG. 1 illustrates a methodology of the present disclosures system comprising steps of: supplying electrical energy from the first EV's battery pack to the first EV's motor controller; monitoring the SOC/SOE of the first EV's battery pack; and, when the SOC/SOE of the first EV's battery pack is above a certain SOC/SOE continuing to supply electrical energy from the first EV's battery pack to the first EV's motor controller; and, when the SOC/SOE of the first EV's battery pack is below a certain SOC/SOE discontinuing and/or mainly discontinuing supply of electrical energy from the first EV's battery pack to the first EV's motor controller; and, supplying electrical energy form the Powered Watercraft EV's battery pack to power the first EV's motor controller. The method steps may be enacted by the user/driver, including in response to prompts offering the user/driver to enact each step; or, the method steps may be performed by the system controller; or, a first step may comprise a prompt displayed on the user interface prompting the user/driver to choose to make a default setting and/or to commence to use electrical energy from the first EV's battery pack (ostensibly to supply the first EV's motor controller, but that information need not appear on the interface) and to, upon the SOC/SOE of the first EV's battery pack reaching a certain low level, commence using electrical energy from the Powered Watercraft EV's battery pack (ostensibly to supply the first EV's motor controller, but that information need not appear on the interface).

FIG. M illustrates a methodology of the present disclosure's system comprising steps of: supplying electrical energy from the Powered Watercraft EV's battery pack to charge the first EV's battery pack (e.g. supplying the electrical energy to the first EV's charging system) while simultaneously supplying electrical energy from the first EV's battery pack to the first EV's motor controller; monitoring the SOC/SOE of the Powered Watercraft EV's battery pack; and, when the SOC/SOE of the Powered Watercraft EV's battery pack is above a certain SOC/SOE continuing to supply electrical energy from the Powered Watercraft EV's battery pack to the first EV's charging system; and, when the SOC/SOE of the Powered Watercraft EV's battery pack is below a certain SOC/SOE discontinuing and/or mainly discontinuing supply of electrical energy from the Powered Watercraft EV's battery pack to the first EV's charging system. The method steps may be enacted by the user/driver, including in response to prompts offering the user/driver to enact each step; or, the method steps may be performed by the system controller; or, a first step may comprise a prompt displayed on the user interface prompting the user/driver to choose to make a default setting and/or to commence to use electrical energy from Powered Watercraft EV to resupply/recharge the first EV's battery pack (ostensibly while supplying electrical energy from the first EV's battery pack to the first EV's motor controller, but that information need not appear on the interface).

FIG. N illustrates a methodology of the present disclosure's system comprising steps of: supplying electrical energy from the first EV's battery pack to charge the Powered Watercraft EV's battery pack (e.g. said electrical energy is supplied to the Powered Watercraft EV's charging system); and, simultaneously, supplying electrical energy from the first EV's own battery pack to the first EV's Motor Controller; monitoring the SOC/SOE of the Powered Watercraft EV's battery pack as well as monitoring the SOC/SOE of the first EV's battery pack; and: when the SOC/SOE of the first EV's battery pack is not
(a) equal to or above a certain SOC/SOE discontinuing and/or mainly discontinuing supply of electrical energy from the first EV's battery pack to the charging system of the Powered Watercraft EV; and
(b) when the SOC/SOE of the Powered Watercraft EV's battery pack is equal to or above a certain SOC/SOE discontinuing and/or mainly discontinuing supply of electrical energy from the first EV's battery pack to the charging system of the Powered Watercraft EV.

Preferably, at least steps (a) and (b) in relation to FIG. N are performed by the system controller, however, they optionally may be performed by the user/driver in response to prompts displayed on the user interface, where the system controller causes display of said prompts.

FIG. O illustrates a methodology of the present disclosure's system comprising steps of: supplying electrical energy from the Powered Watercraft EV's battery pack to charge the first EV's battery pack (e.g. said electrical energy is supplied to the first EV's charging system); and, simultaneously, supplying electrical energy from the Powered Watercraft EV's battery pack to the first EV's Motor Controller; monitoring the SOC/SOE of the Powered Watercraft EV's battery pack as well as monitoring the SOC/SOE of the first EV's battery pack; and:
(c) when the SOC/SOE of the Powered Watercraft EV's battery pack is not equal to or above a certain SOC/SOE discontinuing and/or mainly discontinuing supply of electrical energy from the Powered Watercraft EV's battery pack to the first EV's charging system; and
(d) when the SOC/SOE of the first EV's battery pack is equal to or above a certain SOC/SOE discontinuing and/or mainly discontinuing supply of electrical energy from the Powered Watercraft EV's battery pack to the first EV's motor controller.

Preferably, at least steps \textcircled{c} and (d) in relation to FIG. O are performed by the system controller, however, they optionally may be performed by the user/driver in response to prompts displayed on the user interface, where the system controller causes display of said prompts.

FIG. P illustrates an abbreviated and modified methodology based upon that shown in FIG. G; where the system's methodology comprises steps of: supplying electrical energy from the Watercraft Powered EV'S battery pack simultaneously both to the first EV's motor controller as well as to the first EV's charging system to charge the first EV's battery pack; monitoring the SOC/SOE of the Powered Watercraft EV's battery pack; and, when the SOC/SOE of the Powered Watercraft EV's battery pack is not above a certain SOC/SOE discontinuing and/or mainly discontinuing supply of electrical energy from the Powered Watercraft EV's battery pack both to the first EV's motor controller as well as to the first EV's charging system; and, supplying electrical energy from the first EV's battery pack to power the first EV's motor controller. The method steps may be enacted by the user/driver, including in response to prompts offering the user/driver to enact each step; or, the method steps may be performed by the system controller; or, a first step may comprise a prompt displayed on the user interface prompting the user/driver to choose to make a default setting and/or to commence to use electrical energy from the Powered Watercraft EV's battery pack (ostensibly to recharge the first EV's battery pack while driving as well as to supply the first EV's motor controller, but that information need not appear in entirety on the interface) and to, upon the SOC/SOE of the Powered Watercraft EV's battery pack reaching a certain low level, commence using electrical energy from the first EV's battery pack (ostensibly to supply the first EV's motor controller, but that information need not appear on the interface).

FIG. Q illustrates a methodology of the present disclosure's system comprising steps of: while the first EV is parked and turned off, supplying electrical energy from the Powered Watercraft EV's battery pack to charge the first EV's battery pack (e.g. said electrical energy is supplied to the first EV's charging system); monitoring the SOC/SOE of the Powered Watercraft EV's battery pack as well as monitoring the SOC/SOE of the first EV's battery pack; and:
(e) when the SOC/SOE of the Powered Watercraft EV's battery pack is not equal to or above a certain SOC/SOE discontinuing and/or mainly discontinuing supply of electrical energy from the Powered Watercraft EV's battery pack to the first EV's charging system; and
(f) when the SOC/SOE of the first EV's battery pack is equal to or above a certain SOC/SOE discontinuing and/or mainly discontinuing supply of electrical energy from the Powered Watercraft EV's battery pack to the first EV's charging system.

Preferably, at least steps (e) and (f) in relation to FIG. Q are performed by the system controller, however, they optionally may be performed by the user/driver in response to prompts displayed on the user interface, where the system controller causes display of said prompts.

FIG. R illustrates of present a methodology the disclosure's system comprising steps of: while the first EV is parked and turned off, supplying electrical energy from the first EV's battery pack to charge the Powered Watercraft EV's battery pack (e.g. said electrical energy is supplied to the Powered Watercraft EV's charging system); monitoring the SOC/SOE of the Powered Watercraft EV's battery pack as well as monitoring the SOC/SOE of the first EV's battery pack; and:
(g) when the SOC/SOE of the first EV's battery pack is not equal to or above a certain SOC/SOE discontinuing and/or mainly discontinuing supply of electrical energy from the first EV's battery pack to the Powered Watercraft EV's charging system; and
(h) when the SOC/SOE of the Powered Watercraft EV's battery pack is equal to or above a certain SOC/SOE discontinuing and/or mainly discontinuing supply of electrical energy from the first EV's battery pack to the Powered Watercraft EV's charging system.

Preferably, at least steps (g) and (h) in relation to FIG. Q are performed by the system controller, however, they optionally may be performed by the user/driver in response to prompts displayed on the user interface, where the system controller causes display of said prompts.

FIG. S illustrates a methodology of the present disclosure's system for automatically first charging the Powered Watercraft EV's battery pack from an external charger detachably connected to the first EV followed by charging the first EV's battery pack, the method of FIG. S comprising steps of: while the first EV is detachably connected to an external charger at a charge port integral with first EV that is one of two or more charge ports integral with first EV (and preferably is not the first EV's Trailer Plug charge port): using electrical energy from the external charger to charge the Powered Watercraft EV's battery pack, preferably by supplying electrical energy from the external charger through the first EV to the Powered Watercraft EV's charging system (said electrical energy preferably is routed through the first EV's Trailer Plug charge port to the Powered Watercraft EV); monitoring the SOC/SOE of the Powered Watercraft EV's battery pack; and:
(i) when the SOC/SOE of the Powered Watercraft EV's battery pack is equal to or above a certain SOC/SOE, discontinuing and/or mainly discontinuing supply of electrical energy from the external charger to the charging system of the Powered Watercraft EV; and, either of:
a. when an option has not been selected to first charge the Powered Watercraft EV's battery pack and to subsequently charge the first EV's battery pack, ceasing charging; but,
b. when an option has been selected to first charge the Powered Watercraft EV's battery pack and to subsequently charge the first EV's battery pack, supplying electrical energy from the external charger to the first EV's charging system;
   then, monitoring the SOC/SOE of the first EV's battery pack; and, when the SOC/SOE of the first EV's battery pack is equal to or above a certain SOC/SOE, ceasing charging.

The system operator and/or user/driver may select via the user interface to first charge the Powered Watercraft EV and then to either or not charge the first EV upon completion of charging of the Powered Watercraft EV; or, this option may be a preset, including a present input by the system operator and/or user driver, that then is enacted by the system controller upon detecting both connection of the first EV to an external charger as well as connection to the first EV of the battery pack of at least one Powered Watercraft EV.

FIG. T illustrates a methodology of the present disclosure's system that essentially reverses the order in which the Powered Watercraft EV's battery pack and the first EV's battery pack are charged in the method of FIG. S, where the method of FIG. T comprises steps of: while the first EV is detachably connected to an external charger at a charge port integral with first EV that is one of two or more charge ports integral with first EV (and preferably is not the first EV's Trailer Plug charge port): using electrical energy from the external charger to charge the First EV's battery pack, preferably by supplying electrical energy from the external charger to the first EV's usual charging system; monitoring the SOC/SOE of the first EV's battery pack; and:
(j) when the SOC/SOE of the first EV's battery pack is equal to or above a certain SOC/SOE, discontinuing and/or mainly discontinuing supply of electrical energy from the external charger to the first EV's charging system for purposes of charging the first EV's battery pack; and, either of:
a. when an option has not been selected to first charge the first EV's battery pack and to subsequently charge the Powered Watercraft EV's battery pack, ceasing charging; but,
b. when an option has been selected to first charge the first EV's battery pack and to subsequently charge the Powered Watercraft EV's battery pack, supplying electrical energy from the external charger to the Powered Watercraft EV's charging system (said electrical energy preferably is routed through the first EV's Trailer Plug charge port to the Powered Watercraft EV);
   then, monitoring the SOC/SOE of the Powered Watercraft EV's battery pack; and, when the SOC/SOE of the Powered Watercraft EV's battery pack is equal to or above a certain SOC/SOE, ceasing charging.

The system operator and/or user driver may select via the user interface to first charge the first EV and then to either or not charge the Powered Watercraft EV upon completion of charging of the first EV; or, this option may be a preset, including a present input by the system operator and/or user/driver that then is enacted by the system controller upon detecting both connection of the first EV to an external charger as well as connection to the first EV of the battery pack of at least one Powered Watercraft EV.

FIG. U illustrates a methodology of the present disclosure's system that essentially combines the methods of FIGS. S and T FIG. and enables automatically simultaneously charging the first EV's battery pack and the Powered Watercraft EV's battery pack from an external charger detachably connected to the first EV, where the method of FIG. U comprises steps of:
when the first EV is connected to an external charger at a charge port integral with first EV that is one of two or more charge ports integral with first EV (and preferably is not the first EV's Trailer Plug charge port): electrical energy from the external charger connected to the first EV is routed through the first EV and used to simultaneously charge the first EV's battery pack as well as the Powered Watercraft EV's battery pack (e.g. is simultaneously supplied to first EV's charging system and the Powered Watercraft EV's charging system, where the quotient of said electrical energy supplied to Powered Watercraft EV'S charging system preferably is routed through first EV's Trailer Plug charge port);
monitoring the SOC/SOE of both the first EV's battery pack as well as of the Powered Watercraft EV's battery pack; and:
(a) when the SOC/SOE of the first EV's battery pack is equal to or greater than a certain SOC/SOE, but the SOC/SOE of the Powered Watercraft EV's battery pack is not equal to or greater than a certain SOC/SOE, preferably ceasing charging the first EV's battery pack and directing the energy supply from the external charger to the Powered Watercraft EV's battery pack; and then monitoring the SOC/SOE of the Powered Watercraft EV's battery pack; and, when the SOC/SOE of the Powered Watercraft EV's battery pack is equal to or greater than a certain SOC/SOE, ceasing charging.
(b) when the SOC/SOE of the Powered Watercraft EV's battery pack is equal to or greater than a certain SOC/SOE, but the SOC/SOE of the First EV's battery pack is not equal to or greater than a certain SOC/SOE, preferably ceasing charging the Powered Watercraft EV's battery pack and directing the energy supply from the external charger to the First EV's battery pack; and then monitoring the SOC/SOE of the first EV's battery pack; and, when the SOC/SOE of the first EV's battery pack is equal to or greater than a certain SOC/SOE, ceasing charging.

Preferably, the steps above are performed by the system controller, commencing upon detection by the system controller of both connection of the first EV to an external charger as well as connection to the first EV of the battery pack of at least one Powered Watercraft EV, and having either a prompt or a

The option to enact the method, that is to simultaneously charge both the first EV's battery pack as well as the Powered Watercraft EV's battery pack can be selected by the system operator and/or user/driver via the user interface, or can be a preset that then is enacted by the system controller upon detecting both connection of the first EV to an external charger as well as connection to the first EV of the battery pack of at least one Powered Watercraft EV.

FIG. V illustrates a methodology of the present disclosure's system that enables simultaneously automatically charging two or more Powered Watercraft EV's battery packs from an external charger detachably connected to the first EV, followed by charging the first EV's battery pack upon completion of charging the two or more Powered Watercraft EVs' battery packs, where the method of FIG. V comprises steps of:
when the first EV is detachably connected to an external charger at a charge port integral with first EV that is one of two or more charge ports integral with first EV (and preferably is not the first EV's Trailer Plug charge port): electrical energy from the external charger connected to the first EV is routed through the first EV and used to simultaneously charge the a first Powered Watercraft EV's battery pack as well as a second Powered Watercraft EV's battery pack (e.g. is simultaneously supplied to the first Powered Watercraft EV's charging system and also to the second Powered Watercraft EV's charging system, where electrical energy supplied to Powered Watercraft EV'S charging system preferably is routed through first EV's Trailer Plug charge port);
monitoring the SOC/SOE of both the first Powered Watercraft EV's battery pack as well as of the second Powered Watercraft EV's battery pack;
when the SOC/SOE of the first Powered Watercraft EV's battery pack is equal to or greater than a certain SOC/SOE, but the SOC/SOE of the second Powered Watercraft EV's battery pack is not equal to or greater than a certain SOC/SOE, preferably ceasing charging the first Powered Watercraft EV's battery pack and directing the energy supply from the external charger to the second Powered Watercraft EV's battery pack;
when the SOC/SOE of the second Powered Watercraft EV's battery pack is equal to or greater than a certain SOC/SOE, but the SOC/SOE of the first Powered Watercraft EV's battery pack is not equal to or greater than a certain SOC/SOE, preferably ceasing charging the second Powered Watercraft EV's battery pack and directing the energy supply from the external charger to the first Powered Watercraft EV's battery pack;
when the SOC/SOE of both the first Powered Watercraft EV's battery pack as well as the second Powered Watercraft EVs' battery pack are equal to or greater than a certain SOC/SOE, either ceasing charging; or, alternatively, when an option has been selected to first charge the first and second Powered Watercraft EVs' battery packs and then subsequently charge the first EV's battery pack, direct the electrical energy from the external charger to the first
EV's charging system; and, preferably, monitoring the SOC/SOE of the first EV's battery pack; and, when the SOC/SOE of the first EV's battery pack is equal to or greater than a certain SOC/SOE, ceasing charging.

Preferably, the steps above are performed by the system controller, commencing upon detection by the system controller of both connection of the first EV to an external charger as well as connection to the first EV of the battery pack of at least one Powered Watercraft EV, and having either a prompt or a preset to enact the method. However, some or all can be performed by the user/operator.

The option to enact the method, that is to firstly simultaneously charge both the first and second Powered Watercraft EV's battery packs, followed by subsequent to the first and second Powered EVs' battery packs reaching a desired state of charge automatically charging the first EV's battery pack, can be selected by the system operator and/or user/driver via the user interface, or can be a preset that then is enacted by the system controller upon detecting both connection of the first EV to an external charger as well as connection to the first EV of the battery pack of at least one Powered Watercraft EV.

FIG. W illustrates a methodology of the present disclosure's system that enables simultaneously automatically charging two or more Powered Watercraft EV's battery packs as well as the first EV's battery pack from an external charger detachably connected to the first EV, the method of FIG. W comprising steps of:

when the first EV is detachably connected to an external charger at a charge port integral with first EV that is one of two or more charge ports integral with first EV (and preferably is not the first EV's Trailer Plug charge port): electrical energy from the external charger connected to the first EV is routed through the first EV and used to simultaneously charge at least three EVs, for example, a first Powered Watercraft EV's battery pack as well as a second Powered Watercraft EV's battery pack; as well as the first EV's battery pack (e.g. is simultaneously supplied to: the first Powered Watercraft EV's charging system; the second Powered Watercraft EV's charging system; and, to the first EV's charging system), where electrical energy supplied to first and second Powered Watercraft EVs' charging systems preferably is routed through first EV's Trailer Plug charge port);
monitoring the SOC/SOE of both the first Powered Watercraft EV's battery pack; the second Powered Watercraft EV's battery pack; and, the first EV's battery pack (i.e. the battery packs of the “said at least three EVs”); and:
when the SOC/SOE of any one or two of: the first Powered Watercraft EV's battery pack; the second Powered Watercraft EV's battery pack; and, the first EV's battery pack reaches and/or is at a SOC/SOE that is equal to or greater than a certain SOC/SOE, that can be a preset, preferably ceasing charging any of whichever of the said three EVs whose battery packs have a SOC/SOE that is equal to or greater than said certain SOC/SOE, and supplying the electrical energy from the external charger to whatever of the said three EVs' battery packs SOC/SOE is not equal to or greater than said certain SOC/SOE; and,
when the SOC/SOE of all three of said three EVs' battery packs are equal to or greater than said certain SOC/SOE, ceasing charging.

Preferably, the steps above are performed by the system controller, commencing upon detection by the system controller of both connection of the first EV to an external charger as well as connection to the first EV of the battery pack of at least one Powered Watercraft EV, and having either a prompt or a

The option to enact the method, that is to simultaneously charge the first EV's battery pack as well as the battery packs of the at least two Powered Watercraft EVs, can be selected by the system operator and/or user/driver via the user interface, or can be a preset that then is enacted by the system controller upon detecting both connection of the first EV to an external charger as well as connection to the first EV of the battery pack of at least two Powered Watercraft EVs.

In all the above methods described in FIG. E to FIG. W, the system controller can perform the function of notifying the user/driver and/or system operator of any particular cessation or commencement of any particular step. For example, when a particular Powered Watercraft EV reaches a desired SOC/SOE, a notification can be sent to the user informing such and identifying a particular Powered Watercraft EV by its name or identification. For example, a notification can be an audio and/or visual notification that “Jenny's Jet Ski is now fully charged”. Or, when two or more Powered Watercraft have reached full charge, the notification could for example state “Jenny's Jet Ski and Sean's Sea Doo are now both fully charged”. Also, when the first EV reaches full charge, the notification could for example be “(insert identify of first EV here” now is fully charged”. Also, when a first Powered Watercraft EV is fully charged but a second Powered Watercraft EV has yet to reach full charge, a notification could for example be “Jenny's Jet Ski is fully charged, Peter's Jet Ski is still charging and is about half charged”.

FIG. X depicts a side view of a first EV 1 towing a trailer 3 removably carrying a Powered Watercraft EV 2. The Powered Watercraft EV's charge cable 4 is plugged into an outlet box 57 that is configured to route a bundle 10A of electrically conductive wires to trailer plug 11 integral the first EV in such a fashion as to preserve the function of the Powered Watercraft EV's charge plug and/or charge port, thereby connecting first EV and Powered Watercraft EV system portions 201-201′″ (including 201-A) and 202-202′″. The purpose of plugging/connecting the Powered Watercraft EV's charge cable 4 to outlet box 57 is so that a minimum of length of charge cable 4 is exposed to wind buffeting.

The bundle 10A can include electrical conductors leading from the trailer plug to the trailer's lights and any trailer brakes and/or regenerative brakes as well as other electrical features of the trailer (also known herein as “conventional trailer wiring”). Bundle 10A also may only comprise electrical conductors and/or fiber optic conductors leading to the Powered Watercraft EV(s) charging system as well as its system portion 202-202′″ (also known herein as “system trailer wiring”). Thus, bundle 10A may comprise either only system trailer wiring; or may comprise both conventional trailer wiring as well as system trailer wiring.

When bundle 10A comprises only system trailer wiring, then a separate cable bundle (not shown) comprises the conventional trailer wiring, and a trailer plug assembly such as illustrated in FIG. Z-3 and FIG. Z-4 is anticipated to be most useful, because the trailer plug assembly portion integral with the trailer (i.e. not that portion integral the first EV) can then be formed such that there is a conventional portion to the trailer plug assembly configured to connect to a conventional trailer wiring harness' as well as a system portion to the trailer plug assembly (that harnesses the system trailer wiring); where such trailer plug assembly portion permanently attached to the trailer can comprise a single unit formed so that the its plug interface mates with that portion of the trailer plug assembly integral with the first EV having a mating face configuration as illustrated in FIG. Z-3 and FIG. Z-4 (i.e. where the portion of the trailer plug assembly that is integral with the first EV comprises a face configuration comprising an EV charge plug's mating face configuration adjacent to but separate from a conventional trailer plug's mating face configuration); or, that can comprise two distinct plug assemblies that each are independently plugged into the plug interface of the trailer plug of the first EV depicted in FIG. Z-3 and FIG. Z-4, where one of such distinct plug assemblies comprises an EV charge plug's mating face configuration and where the other of such distinct plug assemblies comprises a conventional trailer wiring harness plug's mating face configuration

Alternatively, When bundle 10A comprises both the system trailer wiring as well as the conventional trailer wiring, then at some point along the length of bundle 10A that is prior to the connection to the first EV's trailer plug assembly, the bundle comprising conventional trailer wiring is bundled and/or joined with the bundle comprising the system trailer wiring, and thus a trailer plug assembly portion can comprise a single unit formed combining features of an EV charge port plug as well as features of a conventional trailer portion trailer plug (that typically is the male end of a trailer plug assembly, with the female end typically integral the first EV), and in which case the portion of the trailer plug assembly integral with the first EV comprises a face configuration that is selected from those depicted in FIG. Z-1 and FIG. Z-2 (i.e. where the portion of the trailer plug integral with the first EV comprises a face configuration comprising an EV charge plug mating face configuration adjacent to (and preferably contacting) a conventional trailer plug mating face configuration).

FIG. Y depicts a top view of an embodiment of the present disclosure where multiple Powered Watercraft EVs are connected to the first EV. As shown, the first EV (and towing EV) 1′ is attached to and towing upon trailer 3′ at trailer plug 11′. The trailer preferably is equipped with regenerative trailer brakes (not visible); and a plurality Powered Watercraft EV personal watercraft are carried upon the trailer, that in the shown embodiment are two Powered Watercraft EV jet skis indicated by reference numerals 2A and 2B. Both of the Powered Watercraft EVs 2A and 2B are removably situated upon and thus carried upon the platform of the trailer towed by the towing EV/first EV and each have their charging system connected to a multi-port and/or multi-plug port electrical connector 21 configured to permit connection of multiple charging cables for multiple EVs and/or Powered Watercraft EVs, where the multi-port and/or multi-plug port electrical connector 21 has at least two and/or multiple ports 15x, 15Y, and that thus allows more than one Powered Watercraft EV to be connected to the multi-port EV charger electrical connector 21. Electrical cables 4D and 4C connect charge ports 7R and 7L, respectively, of EV Jet Skis 2A and 2B to ports 15X and 15Y, respectively, of the multi-port EV charger electrical connector 21. Electrical cable 10A′ is comprised and performs a function as taught above in relation to FIG. X, and connects the electrical wiring and/or conductive structure and/or conductive harness of trailer mounted multi-port EV charging electrical connector 21 to the charging system of the towing EV 1′, preferably by first connecting to trailer plug 11′ (where trailer plug 11′ is configured in relation to the characteristics of cable bundle 10A′ similarly as described above in relation to trailer plug 11 of FIG. X), where trailer plug 11′ in turn is connected to first EV system portion 201-201′″ thus forming the system's detachable connection 11 at trailer plug assembly 11′. Cable 10A′ may also include a bundle of the trailer's conventional trailer wiring, as described above in relation to FIG. X. Multi-port EV charger electrical connector 21 is designed, constructed and configured to collect and/or group and/or bundle and/or form a harness of electrical conductors electrically communicating with and to each of its at least two ports 15X, 15Y into a bundle of individual electrical conductors, preferably individually insulated electrical cables (that may or may not be bundled with individually insulated optical fiber conductors for purpose of data transmission), that are included in and with any other electrical conductors and/or optical fibers, such as cables leading to other electrical elements of the trailer such as lights and regenerative trailer brakes, and that together comprise electrical cable bundle 10A′. Electrical cable bundle 10A′ in turn is configured and fitted to be detachably connectable to that portion of the trailer plug 11′ that is integral the first EV in similar fashion as described above in relation to bundle 10A of FIG. X. A charge port and/or plug 25 is formed integral with the multi-port EV charger electrical connector 21 and allows connection of external charger to the multi-port EV charger electrical connector 21, thereby permitting charging of both Jet Skis and/or other Powered Watercraft EV's carried on the trailer simultaneously and from the same external charger.

FIG. Z-1 to FIG. Z-4 illustrate various trailer plug forms of the present disclosure.

FIG. Z-1 illustrates a combination trailer plug of the present disclosure where the trailer plug comprises a centrally disposed conventional EV Charge Plug assembly surrounded by a radially disposed multi-pin trailer plug assembly.

FIG. Z-2 illustrates another combination trailer plug of the present disclosure where the trailer plug comprises a conventional EV Charge Plug assembly adjacent to a conventional flat multi-pin trailer plug assembly.

FIG. Z-3 illustrates another combination trailer plug of the present disclosure where the trailer plug comprises a conventional EV Charge Plug assembly adjacent to a conventional flat multi-pin trailer plug assembly, where sufficient space separates the conventional EV Charge Plug assembly from the conventional flat multi-pin trailer plug assembly so that either or both a conventional EV Charge Plug and/or a conventional flat multi-pin trailer plug assembly can be connected from the trailer to the first EV either alone or simultaneously. The flap lids are present to protect the assembly face from debris.

FIG. Z-4 illustrates another combination trailer plug of the present disclosure where the trailer plug comprises a conventional EV Charge Plug assembly adjacent to a conventional round multi-pin trailer plug assembly, where sufficient space separates the conventional EV Charge Plug assembly from the conventional round multi-pin trailer plug assembly so that either or both a conventional EV Charge Plug and/or a conventional round multi-pin trailer plug assembly can be connected from the trailer to the first EV either alone or simultaneously. The flap lids are present to protect the assembly face from debris.

### In Continuing Reference to FIG. X to FIG. Z-4, and any Drawing Figures of the Present Disclosure:

The trailer is towed upon by the first EV through trailer hitch 6. The trailer includes wheels 8 that may be equipped with regenerative brakes indicated by reference numeral 9. Trailer plug 11 also is configured to be compatible with and allow functioning of and/or to permit Bi-directional charging (including vehicle to vehicle charging; vehicle to grid charging; and vehicle to load charging) of an EV (and especially between the first EV and the towed upon Powered Watercraft EV), that is against the trend in the industry and contrary to the state of the art. A Powered Watercraft EV equipped for example with a charging system configured to be capable of bi-directional charging is able to be connected at its charge port to a cable that in turn plugs into the first EV's trailer plug, and then to receive charge from the first EV and/or from an external charger to which the first EV is detachably connected. System controller 109 send information signals through the bi-directional charging enabled systems of the first EV and the Powered Watercraft EV so as to carry out the functions of the system of the present disclosure.

The trailer plug and connector assembly portion 11, 11′ integral with the first EV can be any variety as shown in FIG. Z-1 to Z-4, and enables connection of the Bi-directional charging capability and/or Vehicle to Vehicle charging capability of the towing EV to the towed upon Powered Watercraft at EV(s), by, least, suitably electrically connecting the trailer plug assembly integral with the first EV to the first EV's onboard charging system. The Powered Watercraft EVs are enabled with Bi-directional charging capability and/or Vehicle to Vehicle charging capability accessible through their regular charge ports. Thus, the towing EV's Bi-directional charging capability and/or Vehicle to Vehicle charging capability is accessible through either or both its regular charge port, or through its trailer plug 11, 11′, that is contrary to the state of the art and against the trend in the industry. Thus further, upon connection to the first EV through that portion of the trailer plug integral with the first EV, the towed Powered Watercraft EV's Bi-directional charging capability and/or Vehicle to Vehicle charging capability becomes and/or is thereby accessible through trailer plug 11, 11′, that is contrary to the state of the art and against the trend in the industry.

This feature also allows the user/driver/operator to pull up the first EV while it is towing the Powered Watercraft EV removably carried by the trailer and park it perpendicular or more or less perpendicular to the usual orientation a sedan not towing anything normally parks when it parks at a charge port location/parking stall/parking slot; and, then the user/driver/operator of the first EV can use two, three or four external chargers at one time, and charge two, three or four times more rapidly, by, for example, steps comprising: disconnecting the portion of the trailer connector assembly integral with the trailer and/or with the Powered Watercraft EV from that portion of the trailer connector assembly integral the first EV (i.e. the trailer plug integral the first EV); also, connecting the first EV to an external charger at its usual charge port; and, also, connecting the first EV to a second external charger at its trailer plug (that as disclosed herein serves as a charge port) (preferably, the second external charger is more proximal the rear of the first EV than is the first external charger); and, also, connecting a third external charger to the Powered Watercraft EV at its usual charge port, where the third external charger is distally further from the first external charger than is the second external charger, thereby allowing the user/driver/operator of the present disclosures system and apparatus to make full use of at least three external chargers at once where such three external chargers are, commonly, adjacent to one another, and integral with three typical car parking and charging stalls where each of said such car parking and charging stalls is equipped with an external charger; and, when the Powered Watercraft EV is formed comprising more than one charge port, e.g. when, as disclosed herein, the Powered Watercraft EV is formed comprising two charge ports (and preferably, one of the Powered Watercraft EV's two charge ports is more proximal the stern of the Powered Watercraft EV than is another of its charge ports), connecting a fourth external charge port to the Powered Watercraft EV at its most aft charge port, e.g. that charge port integral the Powered Watercraft EV that is more proximal its stern in comparison to its other charge port. In this embodiment, when the Powered Watercraft EV is formed with one charge port, then by pulling up to a series of charging stalls/charging parking spots, each having an external charger, the user/driver/operator of the first EV can access and use three different external chargers at one time to charge the first EV twice as rapidly (in comparison to when using only one external charger to charge the first EV) while simultaneously charging the Powered Watercraft EV at the usual rate when it is connected to only one external charger; and, when the Powered Watercraft EV is formed with two charge ports, can charge the Powered Watercraft EV twice as rapidly in comparison to when using only one external charger to charge the Powered Watercraft EV. This embodiment of the system and apparatus of the present disclosure both allows the user/driver/operator to charge the apparatus of the system, i.e. including the first EV and the Powered Watercraft EV, at from three times the rate of plugging into just one external charger to four times the rate compared to plugging into just one external charger, but, also, importantly, improves the user experience because the user/driver/operator is actually using most or all of the external chargers belonging to the parking stalls that the user/driver/operator occupied when pulling his first EV plus trailered Powered Watercraft EV up to external chargers in the way usually mandatory to avoid blocking traffic, so that the user/driver/operator does not need either to wait long to be fully charged, and can do so while shopping or dining at a restaurant, for example; and also eliminated concerns about occupying the resource of multiple chargers and being unable to use them while, perhaps, other drivers of other EVs are waiting to use the cTarger. Other drivers, realizing that all or most of the chargers are being used, are more likely to feel comfortable, and there is less likely to be conflict at the external charging stations, making both the general public represented by other EV drivers as well as the user/driver/operator of the present disclosure's system and apparatus feel comfortable.

Regenerative trailer brakes 9 generate electrical energy which is conveyed to the (towing) first EV through trailer plug 11 that in turn connects to the remainder of the system. System controller 109 monitors the SOC/SOE of the first EV's and of the Powered Watercraft EV's battery packs to determine when electrical energy generated by the regenerative brakes should be directed and/or supplied to the (towing) first EV or directed and/or supplied to the towed upon Powered Watercraft EV, such as by the system controller 109 calculating how much electrical energy is being consumed per kilometer or mile or unit distance during actual towing at either a mean experienced towing speed or an average per unit time of towing, as empirically determined preferential, and using that value to calculate how much electrical energy is needed in order to arrive at the destination where the EV Jet Ski is intended to be utilized; and determining if sufficient charge exists in the towing EV SUV to reach such destination and/or to both reach such destination as well as to reach a charge point destination; and, when it determines that sufficient charge exists to reach such destination and/or such charge point destination, to direct electrical energy generated by the trailer's regenerative brakes to the towed upon Powered Watercraft EV; or, when the towing and first EV's control unit 109 that might be included in its onboard computer system determines that insufficient battery charge exists in the towing and first EV's battery pack to reach destination and/or to both reach such destination as well as to reach a charge point destination, to direct electrical energy generated by the trailer's regenerative brakes to the towing and first EV. In other embodiments, in similar fashion, electrical energy generated by regenerative brakes incorporated into the towing and first EV also can be directed and/or supplied to either the towed upon Powered Watercraft EV or to the towing and first EV.

When the towing EV and also the towed Powered Watercraft EVs are capable of Bi-Directional Charging, then the towing EV's computer system is able to selectively direct electrical energy from any of: (I) the trailer's regenerative brakes; and, (ii) the towing EV's regenerative brakes; to any of: (a) the towing/first EV's battery pack; or, (b) the towed upon/Powered Watercraft EV(s)′ battery pack(s).

In preferred embodiments of the present disclosure, the user interface 117 and the system controller 109 are integral with the first EV. In other less preferred embodiments, the system controller may be integral with the Powered Watercraft EV (it being understood that the Powered Watercraft EV may comprise a different user interface). In embodiments of the present disclosure where the system controller is integral with the Powered Watercraft EV, the method comprises providing a user prompt to human operators of any or both of the first EV as well as the Powered Watercraft EV causing a prompt to appear on the user interface integral with the first EV, and/or on the user interface integral with the Powered Watercraft EV, informing the operator when the first EV and the battery pack of the Powered Watercraft EV are electrically connected (preferably through the present disclosure's trailer plug), and prompting the operator to select whether to use battery energy from either or both the first EV and/or the Powered Watercraft EV to power the first EV, including while in use and driving; and/or to charge the battery of either the first EV or the Powered Watercraft EV, including either while in use and driving using the battery pack of either the first EV or Powered Watercraft EV; or while parked, or while parked and to charge either or both the first EV or the Powered Watercraft EV from an external charge port, and otherwise functioning according to the teachings of the present disclosure.

### Examples of Using the System and Methods of the Present Disclosure

It is common for boaters to desire to begin trailering their personal boat using their personal vehicle as soon as possible at the end of their work week in order to arrive at a motel or friend's or relative's home on a Friday or other day ending their personal work week so as to have the entire weekend and/or non-working days of their work week, or other holiday, available for their boating activities and their water activities in general. In what is anticipated to be a common example for an ideal use of the present disclosure, a desired driving destination is too far away to be reached on even a fully charged battery pack of an EV Pickup or of an EV SUV when such EV Pickup or EV SUV is trailering an EV Boat. The driver prepares for their weekend boating activities by ensuring that the battery pack of their EV boat is fully charged and also that the battery pack of their EV Pickup and/or EV SUV is fully charged or at least as charged as feasible under their particular set of circumstances.

When it is time to depart on their trip, or in advance preparation for the intended trip, the driver or other operator connects the EV boat to the EV Pickup or EV SUV (also “first EV”). The connection preferably is made by connecting the charging cable and/or charging plug of the EV boat to a charging port or other electrically conductive suitable port on the trailer upon which is removable situated the EV boat, and also connecting the trailer's electrical elements to the first EV by plugging the trailer's male end electrical plug into the first EV's female end trailer plug. The system of the present disclosure detects the presence of the EV boat and prompts the first EV's driver/operator to select whether or not to use battery energy from the battery pack of the EV boat to power the first EV (that, by default, shall either be to charge the first EV's battery pack, or to directly power the first EV's electric drive and/or electric motor, as the first EV's manufacturer determines is most suitable). In order to assist the first EV's operator in making their decision as to whether or not to use the battery energy of the EV Boat to power the first EV while trailering the EV boat, the system's range calculator can calculate the range and required energy to accomplish the trip, and indicate on the user interface whether or not the first EV's battery pack has sufficient charge to accomplish the trip; or whether or not the EV boat's battery pack has sufficient charge to accomplish the trip; or whether or not the combination of the first EV's battery pack and the EV boat's battery pack together have sufficient charge to accomplish the trip. The range calculator also coordinates with the system controller as well as a GPS or other device including a Trip Planner or Trip Planner application in order to identify charging stations (charge points) along the way, and at or near the desired destination(s), and inform the operator via the user interface whether or not it is possible to reach any such point and/or destination, having calculated the energy available in the battery pack(s), and if so, using energy from which battery pack or from which combination of battery packs (i.e. using the energy of the battery pack of the first EV or of the Powered Watercraft EV, or using the energy of both the battery pack of the first EV as well as the battery pack of the Powered Watercraft EV).

The operator then makes their decision. For example, the operator, seeing that it is possible to reach their destination only using energy stored exclusively in the battery pack of either the EV boat or the first EV, selects to start their voyage by using energy from the EV boat's battery pack first, so as to ensure that the first EV is able to be driven for as long as possible before requiring a recharge event, such as for example by detaching the trailer and thus the EV boat from the first EV and separately charging the EV boat while it and its trailer is detached from the first EV, leaving the first EV fully operational while the EV boat is charging. The system of the present disclosure then uses energy from the battery pack of the EV boat during the trailering event portion of the trip, and, when the destination is reached, and the operator has a fully charged battery pack in their own vehicle, e.g. the EV Pickup or EV SUV, and can detach the trailer carrying the EV boat, plug the EV boat into a charger, and be free to go to a restaurant for dinner or other with the first EV while the EV boat charges. The EV boat is then ready for a day of boating the next day.

Similarly, but with some difference, the range calculator determines that is possible to reach the desired destination only by using energy stored in the battery pack of both the first EV as well as in the battery pack of the EV boat, but that the combined stored energy from both said battery packs exceeds the trips requirements. The operator is notified of this by information on the user interface, and is prompted to select whether or not to use energy first and completely from the EV boat or from the first EV. Should the operator wish to be able to drive the first EV immediately upon reaching their destination, but does not immediately require use of the EV boat upon reaching their destination, such as in the present example, the operator can through the user interface opt to completely use energy stored in the EV boats battery pack for the trailering event and to use only some of the energy stored in the first EV's battery pack for said trailering event, thus permitting the operator to arrive at their destination with the ability to detach the trailer and EV boat and set the EV boat to charge, and to drive the first EV, such as to a restaurant for dinner, and then back to a hotel and/or friend's or relative's home, or a second home, while the EV boat charges in preparation for the next day's boating activities and/or watersports. The operator can then also opt to charge the first EV at night, while sleeping, thus ensuring that both the EV boat and the first EV are fully charged in the morning.

The next day, the operator can again connect to the trailer, and tow the EV boat to a boat launch, launch the EV boat, and leave the first EV ashore connected to a charger, or, if it is sufficiently charged, not connected to a charger. Then, after the boating and/or watersport activities, can pull the EV boat out of the water upon the trailer connected to the first EV and, in order to save time, begin to fill upon (charge) the battery of the EV boat from the energy contained in the battery pack of the first EV. Or, if the operator intends to return to their primary residence after pulling the EV boat out of the water, either directly or after other activities and drives, can opt to not charge the battery of the EV boat, but to reserve energy in the battery of the first EV for the trailering event. In such case, it is likely that the EV boat's battery pack shall have some charge remaining, in which case the operator can opt to use charge from the EV boat first to operate the first EV, and then, when the EV boat's battery pack is depleted or at a preset SOC, to use the first EV's battery pack for the trailering event.

If needed to stop enroute to a final destination to recharge the first EV, then it is envisioned that both the first EV and the EV boat can be temporarily and removably each connected to a separate charger at the same time, through their individual charge ports, or, that both can be charged through the charge port of the first EV, as taught herein. Thus, for example, the battery packs of both the first EV and the EV boat can be charged to a full SOC while the operator is engaged in other activities, and then be available to allow a longer trailering event uninterrupted by a mandatory charging event than would be possible in comparison to when the trailering event must be powered solely by energy stored in the first EV's battery pack.

In another example, the first EV is an SUV or Pickup truck and the Powered Watercraft EV is an EV jet ski, or a plurality of EV jet skis; and the destination for use of the jet skis is relatively near to the departure point of the trip. In this case, the operators may choose to first use the battery of the first EV for the leg of the voyage to the desired destination; and then, after completing their desired activities, and for the return leg of their voyage, use whatever charge remains in the EV jet skis' battery pack(s) to power the first EV prior to using the first EV's own battery pack; thereby maximizing both the range as well as the amount of charge potentially remaining in the first EV's battery pack upon completion of the towing activities.

In any case, the battery pack(s) of the towed upon Powered Watercraft EV's are able to be fully charged by plugging the first EV into a suitable charging apparatus such as an external. The system controller/control unit 109 can be configured to permit automatically detecting that the battery pack of the Powered Watercraft EV is fully drained and should be first charged, and then the battery pack of the first EV receives charge, as is suitable when after a long voyage to a desired location it is desired to charge both the first and Powered Watercraft EVs overnight so that they are both useful for desired activities the next day, but the priority is to ensure a full charge to the Powered Watercraft EV for an early start to recreational boating activities while the first EV requires only sufficient charge to reach and return from a boat launch. Alternatively, as already disclosed, a prompt can be made by the system controller 109 to the user interface 117 to permit the operator to select if the operator desires either the first EV or the Powered Watercraft EV to be first charged prior to the other being charged, or if both the first EV and the Powered Watercraft EVs are to be charged simultaneously.

In order to facilitate towing multiple Powered Watercraft EVs, the present disclosure also teaches a method of producing, offering for sale and selling Powered Watercraft EVs in pairs where one Powered Watercraft EV has a charge port located on its left side and the other Powered Watercraft EV of the pair has its charge port located on the right side, thereby facilitating towing a plurality of Powered Watercraft EVs on a trailer connecting to an EV capable of Vehicle to Vehicle Charging and/or Bi-Directional charging, and adapted for charging and/or being charged by Powered Watercraft EVs mounted upon the trailer; and, on a trailer equipped with regenerative trailer brakes and adapted for charging the Powered Watercraft EVs mounted upon the trailer.

The first EV'S system controller is capable of ascertaining the state-of-charge of each Powered Watercraft EV removably carried by the trailer, and, when it directs electrical energy from any of: the first EV's battery pack; the first EV'S brakes; regenerative the trailer's regenerative brakes; or, in the case of stationary charging, from a charge point removably connected to the first EV, to any of the trailered Powered Watercraft EVs, it can be programmed to preferentially direct electrical energy to whichever battery pack of the plurality of trailered Powered Watercraft EVs is most depleted; and, after the batteries of all the trailered Powered Watercraft EVs are at a similar charge, directs such electrical energy equally to the batteries of the Powered Watercraft EVs. However, the operator is able to input a command to the system controller to supply to any particular Powered Watercraft EV electrical energy from any other particular Powered Watercraft EV's battery pack.

Thus, in the case of towing multiple Powered Watercraft EVs removably carried by the trailer, each Powered Watercraft EV may connect via a different port to the system 300 thus permitting the control unit to sense its SOC/SOE, the control unit configured to separately analyze and process the electrical current and/or voltage and charge level/state-of-charge of the battery pack of each such Powered Watercraft EV, preferably in the manner and fashion described herein for any single towed upon Powered Watercraft EV.

The battery pack of the Powered Watercraft EV preferably is configured so as to have a capacity comprising at least as much stored electrical energy, often expressed in terms of kilowatt-hours, in comparison to the battery capacity in kilowatt-hours of the first EV. This is practically feasible in the instance of larger EV power boats, such as EV offshore fishing boats, and even of EV bass fishing boats and/or other EV fishing boats, EV wake boats, EV bow riders, EV water ski boats, EV jet-boats, EV cabin cruisers, and similar. However, such is not practical in the case of smaller Powered Watercraft EVs such as Jet Skis (including Sea Doos and Waverunners). However, preferably, the battery pack of the Powered Watercraft EV(s) are configured to have a capacity of at least one fifth as much kilowatt-hours as is the battery pack of the first EV, and yet again, having at least on quarter as much kilowatt-hours as the battery-pack of the first EV.

Thus, the present disclosure includes the methods and apparatuses of the present disclosure with a further teaching of combining a first EV of the present disclosure with at least one Powered Watercraft EV of the present disclosure (and preferably with at least one Powered Watercraft EV of the present disclosure removably situated upon a trailer as taught supra) where the Powered Watercraft EV comprises a battery pack having a capacity equal to or greater than the capacity of the first EV's battery pack, especially as measured in kilowatt-hours. Alternatively, the Powered Watercraft EV's battery pack capacity is at least one quarter that of the battery pack capacity of the first EV; and more preferably at least a quarter as much kilowatt-hours in comparison to the battery pack of the first EV, and, yet more preferably, having at least one third as much kilowatt-hours in comparison to the battery-pack of the first EV, and, yet even more preferably, having at least half the kilowatt-hours in comparison to the battery pack of the first EV, and yet even more preferably having a similar (including same) amount of battery capacity in kilowatt-hours in comparison to the battery pack of the first EV; and, as taught above, most preferably has greater capacity.

The present disclosure includes combining a plurality of Powered Watercraft EVs carried by a trailer and/or on a platform of a trailer of the present disclosure where each of said Powered Watercraft EVs comprises a battery pack having a capacity lesser than the battery capacity of the first EV, for example lesser than one fifth, and lesser than one quarter, and lesser than one third the battery capacity of the first EV, and connecting each one of a plurality of said Powered Watercraft EVs to a distinct and separate electrical port mounted on the trailer that connects to an electrical energy distribution unit of the present disclosure (that could be either on the trailer or integral either with the first EV or with any of said Powered Watercraft EVs) and/or connecting to an electrical energy distribution unit of the present disclosure that is integral with the trailer, so as to provide by virtue of the combined capacity of their battery packs a viable alternative source and supply of electrical energy, often expressed in terms of kilowatt-hours, to power the motor controller of the first EV and/or to charge the battery pack of the first EV, especially while the first EV is in motion towing upon the trailer upon which are removably situated the plurality of said Powered Watercraft EVs.

### Regenerative Braking Embodiments:

In a preferred embodiment of the present disclosure the trailer upon which is/are towed the Powered Watercraft EV(s) is equipped with regenerative braking mechanisms and architecture. That is to say, it is equipped with regenerative brakes.

Most preferably, the regenerative brakes of the trailer towed by the first EV generate electrical energy that is, according to the present disclosure, able to be routed to charge the first EV's battery pack, or is able to be routed to charge battery packs of any number of the Powered Watercraft EVs towed upon the trailer.

The present disclosure also and further teaches a method and apparatus for charging (including “recharging”) and extending the range of a first EV comprising at least a battery pack and an electric motor for its primary propulsion mechanism, where such first EV is towing at least one and up to a plurality of Powered Watercraft EVs, where each towed Powered Watercraft EV comprises at least a battery pack and an electric motor for their primary propulsion mechanism, where the first EV tows upon the at least one and up to a plurality of towed Powered Watercraft EVs by towing upon a towable trailer where the towable trailer is adapted to carry the at least one and up to a plurality of towed Powered Watercraft EVs, where the towed trailer is equipped with regenerative brakes serving to brake at least one, preferably several and more preferably all of the wheels of the towed trailer, where electrical energy created by the regenerative brakes is used to charge (including “recharge”) the battery pack of (I) the first (and towing) EV; and (ii) the battery pack and/or battery packs of the at least one and up to a plurality of towed Powered Watercraft EVs.

Thus, the present disclosure teaches a method and apparatus for charging (including “recharging”) and extending the range of a first and towing EV that is towing upon at least one and up to a plurality of other EVs, where the towed upon Powered Watercraft EVs are carried upon a towable trailer that is adapted to be towed upon by the first and towing EV, where the towable trailer is equipped with regenerative brakes, where the regenerative brakes are designed and configured to activate when the brakes of the first EV itself activate and/or where the trailer arm and/or trailer hitch comprises a load sensor that activates the trailer's regenerative brakes when the load sensor senses positive load, such as when the trailer is pushing against the trailer hitch rather than being pulled by the trailer hitch, and where electrical energy generated by the trailer's regenerative brakes is used to charge and/or recharge the battery pack of the first EV, and, optionally, to charge and/or recharge the battery pack and/or battery packs of the towed upon Powered Watercraft EVs.

Preferably, electrical energy generated by the regenerative brakes equipping the trailer is carried to the towing EV's battery pack by electrically conductive cables and/or wires that connect to a circuit protector that ensures that the current and voltage and other properties of the electrical energy is compatible with the towing EV's battery pack and electrical and/or voltage architecture.

Preferably, the system controller 109 is configured to receive input from the towing EV that signals the system controller to supply and route electrical energy generated by the trailer's regenerative brakes to any of: (I) the first (and towing) EV; or, (ii) one or a plurality of Powered Watercraft EV(s) carried upon the trailer.

Preferably, the system controller 109 is configured to supply and route electrical energy generated by the trailer's regenerative brakes to the towing EV when the towing EV's battery pack is any of:
iii) below a charge level that would permit the towing EV to reach its planned destination, the planned destination capable of having been inputted into the EV's computer by the operator through a GPS or other system or directly inputted through an interface;
   ii) below a charge level that would permit the towing EV to both reach its planned destination as well as to reach a second planned destination (that may be the point of origin or may be a final stopping point before a planned parking recharge event), the planned destination capable of having been inputted into the EV's computer by the operator through a GPS or other system or directly inputted through an interface;
   iii) when the battery pack(s) of any of the towed Powered Watercraft EVs including any EVs carried upon the towed trailer have sufficient charge to be considered fully charged or when they have sufficient charge to permit carrying out the desired operations with the towed Powered Watercraft EVs.

Preferably, the system controller 109 is configured to supply and route electrical energy generated by the trailer's regenerative brakes preferentially to the towing EV when the towing EV's battery pack is any of:
I) below a charge level that would permit the towing EV to reach its planned destination, the planned destination capable of having been inputted into the EV's computer by the operator through a GPS or other system or directly inputted through an interface;
ii) below a charge level that would permit the towing EV to both reach its planned destination as well as to reach a second planned destination (that may be a final stopping point before a planned parking recharge), the planned destination capable of having been inputted into the EV's computer by the operator through a GPS or other system or directly inputted through an interface;
iii) when the battery pack(s) of any of the towed Powered Watercraft EVs including any EVs carried upon the towed trailer have sufficient charge to be considered fully charged or when they have sufficient charge to permit carrying out the desired operations with the towed Powered Watercraft EVs.

Preferably, the system controller 109 is configured to supply and route electrical energy generated by the trailer's regenerative brakes to the towed upon Powered Watercraft EV(s) when the towed upon Powered Watercraft EV(s) battery pack(s) have insufficient charge to be considered fully charged and when the towing EV's battery pack is any of:
I) at or above a charge level that would permit the towing EV to reach its planned destination, the planned destination capable of having been inputted into the EV's computer by the operator through a GPS or other system or directly inputted through an interface;
ii) at or above a charge level that would permit the towing EV to both reach its planned destination as well as to reach a second planned destination (that may be the point of origin for the trip or that may be a final stopping point before a planned parking recharge event), the planned destination capable of having been inputted into the EV's computer by the operator through a GPS or other system or directly inputted through an interface.

Importantly, and preferably, all regenerative braking teachings of the present disclosure, including all method and apparatus teachings, are combinable with and preferably used simultaneous with all battery charge sharing embodiments of the present disclosure. For example, while the first and towing EV is towing upon the towed upon Powered Watercraft EV(s), that for example is/are an EV motorboat(s) or other personal watercraft, or any Powered Watercraft EV(s), and while the first and towing EV is, for example, using battery charge from the towed upon Powered Watercraft EV(s) as taught in the present disclosure, the methods of the present disclosure also include that electrical energy generated by regenerative brakes of a trailer upon which is mounted the towed upon Powered Watercraft EV(s); (and also, optionally, electrical energy generated by regenerative brakes of the first EV itself), is preferentially routed either to the battery pack of the first and towing EV; or, to the battery pack(s) of the towed upon Powered Watercraft EV(s), wherein the method of the present disclosure is such that:
A) electrical energy from the trailer's regenerative brakes (and, optionally, from the first and towing EV's regenerative brakes) is routed to the battery pack of the first and towing EV when:
   I) the battery charge level of the first and towing EV is not sufficient to permit the first and towing EV to reach a planned destination (preferably taking into account the rate of battery charge consumption during actual towing by the first EV of the towed upon Powered Watercraft EV(s), such accounting preferably calculated in real time and regularly updated);
   ii) the battery charge level of the first and towing EV is adequate to permit the first and towing EV to reach a planned destination (preferably taking into account the rate of battery charge consumption during actual towing by the first EV of the towed upon Powered Watercraft EV(s), such accounting preferably calculated in real time and regularly updated), and the battery of the first and towing EV is not fully charged, and the battery of the towed upon Powered Watercraft EV(s) and/or of selected certain towed upon Powered Watercraft EV(s) is either fully charged, or sufficiently charged to permit a desired use of such towed upon Powered Watercraft EV(s), (a determination of whether or not the battery of the towed upon Powered Watercraft EV(s) and/or of selected certain towed upon Powered Watercraft EV(s) is either fully charged, or sufficiently charged to permit a desired use of such towed upon Powered Watercraft EV(s) preferably made by the first EV's onboard computer system after having received input from the first EV's operator as to the planned destination, but, optionally, capable of being made by the operator of the first EV and inputted to the system controller; and/or
   iii) the operator of the first EV selects that said electrical energy is to be routed to the first and towing EV's battery pack.

### Furthermore:

B) electrical energy from the trailer's regenerative brakes (and, optionally, from the first and towing EV's regenerative brakes) is routed to the battery pack(s) of the towed upon Powered Watercraft EV(s) when:
   I) the battery charge level of the first and towing EV is adequate to permit the first and towing EV to reach a planned destination (preferably taking into account the rate of battery charge consumption during actual towing by the first EV of the towed upon Powered Watercraft EV(s), such accounting preferably calculated in real time and regularly updated), and the battery/batteries charge level of the towed upon Powered Watercraft EV(s) is not fully charged;
   ii) the battery charge level of the first and towing EV is adequate to permit the first and towing EV to reach a planned destination (preferably taking into account the rate of battery charge consumption during actual towing by the first EV of the towed upon Powered Watercraft EV(s), such accounting preferably calculated in real time and regularly updated), and the battery/batteries of the towed upon Powered Watercraft EV(s) and/or of selected certain towed upon Powered Watercraft EV(s) is/are not sufficiently charged to permit a desired use of such towed upon Powered Watercraft EV(s), (a determination of whether or not the battery/batteries of the towed upon Powered Watercraft EV(s) and/or of selected certain towed upon Powered Watercraft EV(s) is either fully charged, or sufficiently charged to permit a desired use of such towed upon Powered Watercraft EV(s) preferably made by the first EV's onboard computer system after having received input from the first EV's operator as to the planned destination, but also, optionally, capable of being made by the operator of the first EV and inputted to the system controller;
   iii) the battery charge level of the first and towing EV charged and the is fully battery/batteries of the towed upon Powered Watercraft EV(s) is not fully charged; and
   iv) the operator selects that said electrical energy is to be routed to the battery/batteries of the towed upon Powered Watercraft EV(s).

### Additional Constructions and Methods for Enacting the System and Apparatus of the Present Disclosure Including, but not Limited to, Retrofit Constructions and Methods:

In certain embodiments of the present disclosure, especially when retro-fitting an existing first EV or Powered Watercraft EV or trailer to be equipped with and capable of being employed according to the teachings of the present disclosure, it may be desired and preferable to manufacture or otherwise equip either the first EV, or the Powered Watercraft EV, or the trailer upon which is/are removably situated one or several Powered Watercraft EV's with equipment designed to facilitate enacting the teachings of the present disclosure. In this case, a “battery charge sharing unit” as described in more fully below is useful for retrofitting or even equipping newly manufactured first EVs and Powered Watercraft EVs and trailers of the present disclosure. Additionally, battery charge sharing units as taught below are useful for enacting the teachings of the present disclosure when multiple Powered Watercraft EVs are removably situated upon the trailer and it is desired to harness energy from the battery packs of all or several of them, or to recharge the battery packs of all or several of them by a single connection to the first EV (that may itself be connected to an external charger or may use its battery energy to recharge the Powered Watercraft EV's batteries); or, alternatively, to an external charger.

With reference to FIG. 12: shown is side view of vehicles equipped with an alternative embodiment of the present disclosure. Shown is a first (and towing) EV indicated by reference numeral 71; a Powered Watercraft EV indicated by reference numeral 72 that is depicted removably situated upon a trailer indicated by reference numeral 73; and an electrical connection indicated by a cable indicated by reference numeral 74 connecting the electrical system and electrical architecture of the first EV and Powered Watercraft EVs to one another. This is a simplistic embodiment, where, the trailer is separately electrically connected to the first EV by a usual trailer plug electrical harness (not shown), and where the electrical connection between the first (and towing EV) and the Powered Watercraft EV is made in such a way that a suitably fitted cable is plugged into a specifically configured and adapted electrical port that also can serve as a charge port (not shown) of the first EV (that may be in additional to its usual charge port), where such specifically configured and adapted electrical port/charge port is located proximal the aft/rear end of the first EV, and plugged at its other end into the Powered Watercraft EV. The specifically configured and adapted electrical port/charge port shown) is configured to enable electrical connection of one or several Powered Watercraft EV's charging systems and/or dedicated cables connecting to their battery packs, so as to enable enacting the functions of the present disclosure and so as to provide detachable electrical connection as required to enable the present disclosure's teachings. As noted, this is a simplistic embodiment, and not preferred, but might be suitable in certain instances, especially when retrofitting an existing EV to be capable of functioning as the present disclosure's first EV. Preferably, electrical cable 74 connects to battery charge sharing unit 75 located integral with the first and towing EV 71, where the battery charge sharing unit as well aW the above referenced specifically configured and adapted electrical port/charge port might be retrofitted into an existing EV, or, might be manufactured when manufacturing the first EV. The battery charge sharing unit can be an onboard charging system of the first EV, or, can be a component of an onboard charging system of the first EV, or, can be a component that is retrofitted into the first EV and comprises all equipment needed to enact the functions of the present disclosure, including circuit protection, bi-directional charging, and may include a control unit and/or may be configured to be connectable to an EVs existing control unit. The location of electrical connection between the first EV and the Powered Watercraft EV preferably is near the trailer hitch 76. Ideally, rather than the above described separate specifically configured and adapted electrical port/charge port possibly retrofitted into the first EV, the connection preferably comprises a trailer plug having been configured to enable enacting the functions of the present disclosure, as disclosed in more detail further herein. The electrical connection between the first EV and the Powered Watercraft EV also connects to the towed Powered Watercraft EV 72 at a charging port 77 for the Powered Watercraft EV. Electrical cable 74, preferably, connects to the battery charge sharing unit of the first EV 71 as stated above, and not directly to the electrical system and/or electrical architecture of the first EV other than that of the battery charge sharing unit, and also connects at its other end to the charge port of the Powered Watercraft EV. (Although the Powered Watercraft EV is shown having a charge port at its bow region, its charge port could be anywhere, including its stern region).

The trailer is towed upon by the first EV through trailer hitch 76. The trailer includes wheels 78 that may be equipped with regenerative brakes indicated by reference numeral 79. Electrical energy generated by regenerative brakes 79 is transmitted to the first and towing EV (and optionally also to the towed upon Powered Watercraft EV) along electrical cable 70 and, and is connected to the first EV through the same specifically configured and adapted electrical port/charge port described supra that might be retrofitted into the first EV and is particularly adapted enacting the functions of the present disclosure, and, preferably is routed first directly to the battery charge sharing unit that, in the case of the embodiment shown in FIG. 12, is integral with the first and towing EV.

While the electrical cables 74 and 70 are shown in FIG. 12 as distinctly connecting to the first and towing EV, preferably, an electrical harness and/or connector would exist that would incorporate electrical cables 74 and 70, as well as other electrical conductors that serve to provide communication to the trailer's features such as trailer lights and trailer brakes, and such electrical harness would be incorporated into a plug unit that would connect to the first and towing EV (said plug unit also is known herein as a “trailer plug” and/or as a “trailer connector”), where said trailer plug and/or trailer connector comprise any and all electrically conductive structures including plugs, receptacles, leads and wiring harnesses to permit enacting the present disclosure's teachings.

In preferred embodiments of the present disclosure as shown in FIG. 12, FIG. 14 and FIG. 16, the battery charge sharing unit 75 is integral with the first EV, and in these disclosed preferred embodiments, user interface 117V is integral the first EV

In other embodiments of the present disclosure, as shown in FIG. 12A, the user interface as indicated by reference numeral 117V′ is integral with the Powered Watercraft EV, as is the battery charge sharing unit as indicated by reference numeral 75P that comprises in this case the system controller as indicated by reference numeral 109PV that also is integral with the Powered Watercraft EV. In embodiments of the present disclosure where the system controller is integral with the Powered Watercraft EV, the method comprises providing a user prompt to human operators of any or both of the first EV as well as the Powered Watercraft EV causing a prompt to appear on the user interface integral with the first EV, and/or on the user interface integral with the Powered Watercraft EV, informing the operator when the first EV and the Powered Watercraft EV are electrically connected (preferably through the present disclosure's trailer plug), and prompting the operator to select whether to use battery energy from either or both the first EV and/or the Powered Watercraft EV to power the first EV, including while in use and driving; and/or to charge the battery of either the first EV or the Powered Watercraft EV, including either while in use and driving using the battery pack of either the first EV or Powered Watercraft EV; or while parked, or while parked and to charge either or both the first EV or the Powered Watercraft EV from an external charge port.

(In other embodiments of the present disclosure, that are disclosed below and herein in reference to FIG. 13 and FIG. 15, the battery charge sharing unit is integral with the trailer 73, and may comprise an onboard bi-directional charging system housed integral trailer 73, in which embodiments, the controller 109V and the battery charge sharing unit 75 may be incorporated into a housing situated integral the trailer 73. This situates the controller 109V on trailer 73, in which such embodiments it is preferred to also have a user interface situated on trailer 73, such as by being attached to the housing including battery charge sharing unit 75 and controller 109V, thus providing said user interface situated and/or integral with trailer 73.)

With reference to FIG. 13: shown is side view of vehicles equipped with an alternative embodiment of the present disclosure. The difference between the embodiment shown in FIG. 12 and the embodiment shown in FIG. 13 is that, in FIG. 13, a battery charge sharing unit, indicated in FIG. 13 by reference numeral 75′, is located on and attached to and/or otherwise integral with the trailer 73; and the electrical cable 74 is divided into two portions, one portion indicated by reference numeral 74A that connects the first and towing EV to the battery charge sharing unit 75′; and the second portion indicated by reference numeral 74B that connects the towed upon and Powered Watercraft EV to the same battery charge sharing unit 75′; and, electrical cable 70A that serves to transmit electrical energy generated by the trailer's regenerative brakes 79 to either or both the towing EV or the towed upon Powered Watercraft EV is routed from the trailer's regenerative brakes to the battery charge sharing unit mounted on and/or integral with the trailer.

Preferably, even though a battery charge sharing unit 75′ is integral with the trailer 73, the first and towing EV nonetheless includes a battery charge sharing unit 75 in order to guarantee that any electrical energy directed and/or supplied to the electrical and/or voltage architecture of the first and towing EV is compatible with the charging system and remainder of the electrical and/or voltage architecture of the first and towing EV.

While the electrical cable 74A is shown in FIG. 13 as distinctly connecting to the first and towing EV, preferably, an electrical harness and/or connector would exist that would incorporate electrical cable 74 as well as other electrical conductors that serve to provide communication to the trailer's features such as trailer lights and trailer brakes, and such electrical harness would be incorporated into the a plug unit that would connect to the first and towing EV, especially the disclosed trailer plug.

FIG. 14 shows vehicles equipped with an alternative embodiment of the present disclosure similar to that shown in and described for FIG. 12, where the first and towing EV is an EV SUV indicated by reference numeral 71′; the towed upon Powered Watercraft EV is an EV Jet Ski indicated by reference numeral 72′; and the trailer indicated by reference numeral 73′ is adapted to carry an EV personal watercraft that is an EV Jet Ski. Electrical cable 74′ connects the charging system and electrical and/or voltage architecture of the towed upon Powered Watercraft EV Jet Ski to the charging system and electrical and/or voltage architecture of the towing EV SUV via battery sharing unit 75″ that protects the electrical system of the first EV and, optionally but preferably, the Powered Watercraft EV, that is in this case a Jet Ski, and otherwise functions to enable the system of the present disclosure. As seen, electrical cable 74′ connects at one end to the charging port 77′ of the EV Jet Ski and at its other end to trailer plug 11V, and trailer plug 11V in turn is electrically and physically connected battery charge sharing unit 75″ of the EV SUV. Trailer plug 11V serves as a harness and connector that, preferably, connects all electrical cables that run to various electrical elements of the trailer, including trailer lights and trailer brakes, and, at the least, connects the terminal ends of both electrical cable 74′ as well as electrical cable 70′ proximal the towing EV. Trailer plug 11V preferably is located at the rear of the towing EV SUV proximal the rear bumper and proximal the trailer hitch, and, optimally, provides an electrical connection to the towing EV's system controller and/or control unit communicating with the battery charge sharing unit of the present disclosure in the manner and fashion described supra and herein.

Trailer plug 11V also is constructed, designed and configured to be compatible with and allow functioning of and/or to permit Bi-directional charging of and between the towing EV and the towed upon Powered Watercraft EV, that is against the trend in the industry and contrary to the state of the art, and is a result of configuring the trailer plug to enable the functions of the present disclosure. A harness housing that is configured to be detachably connected to trailer plug 11V (where trailer plug 11V is integral the first EV), and is configured to include any harnesses, leads, electrical wires and/or conductors providing electrical communication to equipment of the trailer, includes an additional plug adaptor (not shown) that is configured to permit connection to a cable or other conductor that connects to the Powered Watercraft EV's charge port. Resultantly: in such fashion, a Powered Watercraft EV equipped for example with a charging system configured to be capable of bi-directional charging is able to be connected at its charge port to a cable that in turn plugs or otherwise connects to a suitably configured plug or socket that is integral the same housing comprising a harness comprising other electrical conductors electrically communicating with other equipment of the trailer, such as trailer lights, trailer brakes and/or regenerative trailer brakes, in such a configuration as to enable the Powered Watercraft EV and the first EV to be capable to electrically communicate so as to carry out the functions of the system of the present disclosure, including whether or not a battery charge sharing unit is in use or present, such as, for example, when no battery charge sharing unit is present but rather the first EV's onboard charging system is configured with all needed circuit protection.

The trailer 73′ includes wheels 78′ that include and/or connect to regenerative trailer brakes 79′ that generate electrical energy which is conveyed by electrical cable 70′ to the towing EV SUV by, preferably, being conveyed to the battery charge sharing unit 75″ of the EV SUV by virtue of the fact that electrical cable 70′ connects to trailer plug 11V that in turn connects to the battery charge sharing unit 75″. The battery charge sharing unit of the EV SUV communicates with the EV SUV's system controller 109V (the term “system controller” including the control unit for controlling the system of the present disclosure) that may be incorporated into the first EVs/EV SUVs computer system, to determine when electrical energy generated by the regenerative brakes should be directed and/or supplied to the towing EV SUV or directed and/or supplied to the towed upon Powered Watercraft EV Jet Ski, such as by the EV SUV's computer system calculating how much electrical energy is being consumed per kilometer or mile or unit distance during actual towing at either a mean experienced towing speed or an average per unit time of towing, as empirically determined preferential, and using that value to calculate how much electrical energy is needed in order to arrive at the destination where the EV Jet Ski is intended to be utilized; and determining if sufficient charge exists in the towing EV SUV to reach such destination and/or to both reach such destination as well as to reach a charge point destination; and, when it determines that sufficient charge exists to reach such destination and/or such charge point destination, to direct electrical energy generated by the trailer's regenerative brakes to the towed upon Powered Watercraft EV Jet Ski; or, when the towing EV SUV's onboard computer system determines that insufficient battery charge exists in the towing EV's battery system to reach destination and/or to both reach such destination as well as to reach a charge point destination, to direct electrical energy generated by thT trailer's regenerative brakes to the towing EV SUV. In other embodiments, in similar fashion, electrical energy generated by regenerative brakes incorporated into the towing EV also can be directed and/or supplied to either the towed upon Powered Watercraft EV Jet Ski or to the towing EV SUV.

FIG. 15 shows a top view of vehicles equipped with an alternative embodiment of the present disclosure where a first and towing EV 71″ tows upon a trailer 73″ also equipped with trailer brakes (not visible); and where a plurality of Powered Watercraft EVs, that in the depicted embodiment are two EV Jet Skis indicated by reference numerals 72A and 72B, are both carried upon the trailer 73″. Both of the Powered Watercraft EVs 72A and 72B carried upon the trailer towed by the towing first EV each have their charging system connected to a battery charge sharing unit 75′″ that is integral with the trailer by electrical cables 74D and 74C that connect charge ports 77R and 77L of EV Jet Skis 72A and 72B to ports 715A and 715B, respectively, of the battery charge sharing unit. Another electrical cable 74A′ connects the trailer mounted battery charge sharing unit's electrical system to the electrical system and preferably to the charging system of the towing EV. (Although each of the Powered Watercraft EVs are depicted as having a charge port at their bow region, their charge ports could be anywhere suitable, including at their stern region).

In further reference to FIG. 15, trailer plug and connector 11V′ is constructed similarly as trailer plug and connector 11V described in FIG. 14 and enables connection of the Bi-directional charging capability and/or Vehicle to Vehicle charging capability of the towing EV to the towed upon Powered Watercraft EV(s). The towed upon Powered Watercraft EVs are enabled with Bi-directional charging capability and/or Vehicle to Vehicle charging capability accessible through their regular charge ports. Thus, the towing EV's Bi-directional charging capability and/or Vehicle to Vehicle charging capability is accessible through either or both its regular charge port, or through its trailer plug 11V, 11V′, that is contrary to the state of the art and against the trend in the industry; and, furthermore, this allows the user/driver/operator to pull up the first EV while it is towing the Powered Watercraft EV removably situated on the trailer and park it perpendicular or more or less perpendicular to the usual orientation a sedan not towing anything normally parks when it parks at a charge port location/parking stall/parking slot; and, then the user/driver/operator of the first EV can use three to four external chargers at one time, and charge three to four times more rapidly, by, for example, disconnecting the portion of the trailer connector assembly integral with the trailer and/or with the Powered Watercraft EV from that portion of the trailer connector assembly integral the first EV (i.e. the trailer plug integral the first EV); and, also, connecting the first EV to an external charger at its usual charge port; and, also, connecting the first EV to a second external charger at its trailer plug (that as disclosed herein serves as a charge port), where the second external charger is more proximal the rear of the first EV than is the first external charger; and, also, connecting a third external charger to the Powered Watercraft EV at its usual charge port, where the third external charger is distally further from the first external charger than is the second external charger, thereby allowing the user/driver/operator of the present disclosures system and apparatus to make full use of at least three external chargers at once where such three external chargers are, commonly, adjacent to one another, and integral with three typical car parking stalls where each of said such car parking stalls is equipped with an external charger; and, when the Powered Watercraft EV's is formed comprising more than one charge port, e.g. when, as disclosed herein, the Powered Watercraft EV is formed comprising two charge ports, and one of the Powered Watercraft EV's two charge ports is more proximal the stern of the Powered Watercraft EV than is another of its charge ports, connecting a fourth external charge port to the Powered Watercraft EV at its most aft charge port, e.g. that charge port integral the Powered Watercraft EV that is more proximal its stern in comparison to its other charge port, that may be for example more proximal its bow and is, in this example, connected to the third external charger. In this embodiment, when the Powered Watercraft EV is formed with one charge port, then by pulling up to a series of charging stalls/charging parking spots, each having an external charger, the user/driver/operator of the first EV can access and use three different external chargers at one time to charge the first EV twice as rapidly/twice as fast in comparison to when using only one external charger to charge the Powered Watercraft EV; and to charge the Powered Watercraft EV at the usual rate when it is connected to only one external charger; and, when the Powered Watercraft EV is formed with two charge ports, can charge the Powered Watercraft EV twice as rapidly/twice as fast in comparison to when using only one external charger to charge the Powered Watercraft EV. This embodiment of the system and apparatus of the present disclosure is extremely important because it both allows the user/driver/operator to charge the apparatus of the system, i.e. including the first EV and the Powered Watercraft EV, at from three times the rate of plugging into just one external charger to four times the rate compared to plugging into just one external charger, but, also, very importantly, improves the user experience because the user/driver/operator is actually using most or all of the external chargers belonging to the parking stalls that the user/driver/operator occupied when pulling his first EV plus trailer Powered Watercraft EV up to, so that the user/driver/operated does not need either to wait long to be fully charged, and can do so while shopping or dining at a restaurant, for example; and also does not need to feel guilty about occupying the resource of multiple chargers and being unable to use them while, perhaps, other drivers of other EVs are waiting to use the charger. Other drivers, realizing that all or most of the chargers are being used, are more likely to feel comfortable, and there is less likely to be conflict at the external charging stations, making both the general public represented by other EV drivers as well as the user/driver/operator of the present disclosure's system and apparatus feel comfortable.

FIG. 16 depicts a top view of an alternative embodiment of the present disclosure that is similar to the embodiment taught in FIG. 15 excepting that the battery charge sharing unit is, in the embodiment of FIG. 16, integral with the first and towing EV 71′″ of FIG. 16 and is indicated by reference numeral 75X in FIG. 16. As seen, battery charge sharing unit 75X is connected by electrically conductive connector 79X to trailer plug 11V″, also integral with first and towing EV 71′″. FIG. 16 further shows first and towing EV 71′″ attached to and towing upon trailer 73′″ that preferably is equipped with trailer brakes (not visible); and where a plurality Powered Watercraft EV personal watercraft are carried upon the trailer, that in the shown embodiment are two Powered Watercraft EV jet skis indicated by reference numerals 72A′ and 72B′. Both of the Powered Watercraft EVs 72A′ and 72B′ removably situated upon and thus carried upon the trailer towed by the towing EV each have their charging system connected to a multi-port and/or multi-plug port electrical connector 721 configured to permit connection of multiple charging cables for multiple EVs and/or Powered Watercraft EVs, where the multi-port and/or multi-plug port electrical connector 721 has at least two and/or multiple ports 715X, 715Y, and that thus allows more than one Powered Watercraft EV to be connected to the multi-port EV charger electrical connector 721. Electrical cables 74X and 74Y connect charge ports 77R′ and 77L′, respectively, of EV Jet Skis 72A′ and 72B′ to ports 715X and 715Y, respectively, of the multi-port EV charger electrical connector 721. Electrical cable 74Z connects the trailer mounted multi-port EV charging electrical connector 721 to the charging system of the towing EV 71′″, preferably by first connecting directly to trailer plug 11V″ that turn is connected to battery charge sharing unit 75X that is integral with the towing EV. Multi-port EV charger electrical connector 721 is designed, constructed and configured to collect and/or group and/or bundle electrical conductors electrically communicating with and to each of its at least two ports 715X, 715Y into a bundle of individual electrical conductors, preferably individually insulated electrical cables (that may or may not be bundled with individually insulated optical fiber conductors for purpose of data transmission), that are included in and with any other electrical conductors and/or optical fibers, such as cables leading to other electrical elements of the trailer such as lights and regenerative trailer brakes, and that together comprise electrical cable bundle 74Z. Electrical cable bundle 74Z in turn is configured and fitted to be detachably connectable to that portion of the trailer plug that is integral the first EV.

In further reference to FIG. 16, trailer plug and connector 11V′″ is constructed similarly as trailer plug and connector 11V described in FIG. 14 and enables connection of the Bi-directional charging capability and/or Vehicle to Vehicle charging capability of the towing EV to the towed upon Powered Watercraft EV(s), by, at least, suitably electrically connecting the trailer plug assembly integral with the first EV to the first EV's onboard charging system, and, providing detachable connection to a charging cable configured to connect to the Powered Watercraft EV(s) charge ports, for example. The towed upon Powered Watercraft EVs are enabled with Bi-directional charging capability and/or Vehicle to Vehicle charging capability accessible through their regular charge ports. Thus, the towing EV's Bi-directional charging capability and/or Vehicle to Vehicle charging capability is accessible through either or both its regular charge port, or through its trailer plug 11V, 11V′, that is contrary to the state of the art and against the trend in the industry. Thus further, upon connection to the first EV through that portion of the trailer plug integral with the first EV, the towed Powered Watercraft EV's Bi-directional charging capability and/or Vehicle to Vehicle charging capability becomes and/or is thereby accessible through trailer plug 11V, 11V′, that is contrary to the state of the art and against the trend in the industry.

In order to facilitate towing multiple Powered Watercraft EVs, the present disclosure also teaches a method of producing, offering for sale and selling Powered Watercraft EVs in pairs where one Powered Watercraft EV has a charge port located on its left side and the other Powered Watercraft EV of the pair has its charge port located on the right side, thereby facilitating towing a plurality of Powered Watercraft EVs on a trailer connecting to an EV capable of Vehicle to Vehicle Charging and/or Bi-Directional charging, and adapted for charging and/or being charged by Powered Watercraft EVs mounted upon the trailer; and, on a trailer equipped with regenerative trailer brakes and adapted for charging the Powered Watercraft EVs mounted upon the trailer.

In all embodiments of the present disclosure: the towing EV preferably is capable of Bi-Directional Charging as well as Vehicle to Vehicle Charging, and, preferably, is capable of any combination of any or all of: Bi-Directional Charging; Vehicle to Vehicle Charging; Vehicle to Load Charging; and, Vehicle to Grid charging, and also the towed Powered Watercraft EVs preferably are capable of Bi-Directional Charging as well as Vehicle to Vehicle Charging, and, preferably, is capable of any combination of any or all of: Bi-Directional Charging; Vehicle to Vehicle Charging; Vehicle to Load Charging; and Vehicle to Grid Charging. When the towing EV and also the towed Powered Watercraft EVs are capable of Bi-Directional Charging (and, optionally, Vehicle to Vehicle Charging), then the towing EV'S computer is able system to selectively direct electrical energy from any of: (I) the trailer's regenerative brakes; and, (ii) the towing EV's regenerative brakes; to any of: (a) the towing EV; or, (b) the towed upon Powered Watercraft EV(s), including in similar manner and fashion as described supra with reference to FIGS. 12, 13 and 14 for a single towed Powered Watercraft EV.

Furthermore, when the towing EV and also the towed Powered Watercraft EVs are capable of Bi-Directional Charging, then the towing EV's computer system is able to selectively direct electrical energy from either the towing EV's battery pack to the battery pack of any or all of the towed upon Powered Watercraft EVs; or, from the battery pack of any or all of the towed upon Powered Watercraft EVs to the battery pack of the towing EV, including in similar manner and fashion as described supra with reference to FIGS. 12, 13 and 14 for a single towed Powered Watercraft EV.

Furthermore, when the towing EV and also the towed Powered Watercraft EVs are capable of at least Vehicle to Vehicle Charging, then the towing EV's computer system is able to selectively direct electrical energy from either the towing EV's battery pack; or, from the battery pack of any or all of the towed upon Powered Watercraft EVs, to the electric drive of the towing EV.

Furthermore, when the towing EV and also the towed Powered Watercraft EVs are capable of at least Vehicle to Vehicle Charging, then the towing EV's computer system is able to selectively direct electrical energy, including in similar manner and fashion as described supra with reference to FIGS. 12, 13 and 14 for a single towed Powered Watercraft EV, from either the towing EV's battery pack; or, from the battery pack of any or all of the towed upon Powered Watercraft EVs, to the electric drive of the towing EV.

The towing EV's system controller and/or computer and control unit, whether it is included within a same housing as or separate from the present disclosure's “battery charge sharing unit”, is capable of ascertaining the state-of-charge (also known herein as the “charge level” and/or as the “level of charge”) of each Powered Watercraft EV mounted upon the trailer, and, when it directs electrical energy from any of the towing EV's battery; the towing EV's regenerative brakes; the trailer's regenerative brakes; or, in the case of stationary charging, from a charge point removably connected to the first EV, to any of the towed upon Powered Watercraft EVs, it preferentially directs electrical energy to whichever battery of the plurality of towed upon Powered Watercraft EVs is most depleted; and, after the batteries of all the towed upon Powered Watercraft EVs are at similar charge, directs such electrical energy equally to the batteries of the towed upon Powered Watercraft EVs. However, the operator is able to input to the towing EV's computer to either not charge, or to drain to another towed upon Powered Watercraft EV or to the towing EV, charge stored in any particular or in any of a plurality of particular towed upon Powered Watercraft EV's batteries. Alternatively, the trailer may be constructed, designed and configured to permit manually switch on or off the access to the battery charge sharing unit and thus to the electrical architecture of the trailer and by extension of the towing EV of any particular towed upon Powered Watercraft EV, such as by having toggle switches, or on/off buttons located on ports to which the charging cable of the towed upon Powered Watercraft EVs connect to the battery charge sharing unit. However, it is preferred that such inputs are executed by the towing EV operator from inside the towing EV by use of the towing EV's computer system.

Furthermore, with continued reference to FIG. 15 and FIG. 16, when the towed upon Powered Watercraft EV(s) are not capable of Bi-Directional Charging, then their battery packs are not able to be used to charge the battery pack of the towing EV. In such embodiment, the computer system and the battery charge sharing unit (which may be incorporated into the towing EV's control unit and/or computer system) selects to direct electrical energy generated by regenerative trailer brakes, or by the EV'S own regenerative brakes; either to the battery pack of the towing EV or to the battery pack(s) of any or all of the towed upon Powered Watercraft EV(s), including in similar manner and fashion as described supra in relation to FIGS. 12, 13 and 14, excepting that electrical energy from the battery packs of the Powered Watercraft EVs not capable of Bi-directional charging is not used to power the battery pack of the first and towing EV.

Furthermore, with continued reference to FIG. 15 and FIG. 16, when the towed upon Powered Watercraft EV(s) are not capable of either Bi-Directional Charging or Vehicle to Vehicle Charging, even when electrically connected to the trailer plug and/or battery charge sharing unit of the present disclosure, and their battery packs are not able to be used to charge the battery pack of the towing EV, in such embodiment, the computer system and the battery charge sharing unit (which may be incorporated into the towing EV's control unit and/or computer system) selects to direct electrical energy stored in the battery pack of the towing EV to the battery pack(s) of any or all of the towed upon Powered Watercraft EV(s), including in similar manner and fashion as described supra in relation to FIGS. 12, 13 and 14, especially those disclosed embodiments where the towing EV's computer system and/or the battery charge sharing unit has determined that the towing EV's battery pack has sufficient charge for the desired trip, and thus can direct charge from the towing EV's battery pack, and/or charge from the towing EV's regenerative brakes; and/or charge from the trailer's regenerative brakes to the towed upon Powered Watercraft EV(s). Furthermore, the towing EV is designed, constructed and configured to be capable of directing and/or supplying charge from an external charger plugged into the towing EV's charge port (that preferably is not its trailer plug) directly to the towed upon Powered Watercraft EV(s), preferably through the towing EV's trailer plug 11V, 11V′, 11V″, 11V′″, so as to fully charge the battery packs(s) of the towed upon Powered Watercraft EV(s) just the same as if they themselves were directly plugged into a charger.

In one embodiment of the present disclosure, a first EV, that is a passenger vehicle such as an SUV or light truck (such as a pickup truck) that is adapted for towing a trailer that carries a Powered Watercraft EV, such as an EV water ski boat, an EV jet ski or a plurality of EV jet skis, or an EV motorboat such as an EV waterski boat or an EV fishing boat. The first EV that is a passenger EV such as an SUV or light truck such as a pickup truck tows upon the towed Powered Watercraft EV, that preferably is towed by being carried upon a trailer that is connected to the first EV. The battery pack of the towed Powered Watercraft EV is connected to the first EV in such a fashion that electricity in the battery pack of the towed Powered Watercraft EV is able to be used to operate the first EV.

In the event that it is desired to use the first EV to tow upon multiple Powered Watercraft EVs, such as, for example, to tow upon a trailer upon which are situated a plurality of EV jet skis, it is envisioned that the trailer upon which ride the plurality of towed Powered Watercraft EVs is equipped with multiple charge port plugs configured to permit the functions of the present disclosure for each Powered Watercraft EV connected to each such charge port plug, one for each Powered Watercraft EV to be removably situated upon the trailer, where such charge port plug could comprise a simple electrical connection communicating to the trailer plug and thus to that portion of the range extending system 300 integral with the first EV, such as that corresponding to the first EV's system 201-201′″, or, where each such charge port plug comprises a battery charge sharing unit, each of which being positioned on the trailer in a location that permits connecting at least one of the towed upon Powered Watercraft EVs to at least one of the charge port plugs and/or battery charge sharing units. The towed Powered Watercraft EVs thus connect to a charge port plug and/or battery charge sharing unit attached to the trailer, and the current and/or voltage of each towed Powered Watercraft EV is thus read, ascertained and routed to an appropriate inverter and/or convertor so as to convert and/or otherwise ensure that current from any of the towed Powered Watercraft EVs is compatible with the voltage architecture of the first EV prior to such current being routed to the first EV.

In the event of towing several Powered Watercraft EVs upon a trailer, several battery charge sharing units may be included within a single housing, attached to the trailer, thus having externally visible several ports to connect to the charging and/or electrical apparatus of any towed Powered Watercraft EV. Each or any of said several ports may be positioned at different locations on the trailer so as to make it convenient to connect each Powered Watercraft EV removably situated upon the trailer to a port that connects its charging system to the battery charge sharing unit. This connection can be made by connecting a charge cable of the port to a charge port of any of the Powered Watercraft EVs (when the port has a charge cable); by connecting a charge cable from the Powered Watercraft EV to the applicable said port (when the Powered Watercraft EV has an integral charge cable). Alternatively, when towing either one Powered Watercraft EV or when towing multiple Powered Watercraft EVs, a port on the trailer that connects through a cable (especially a charge cable) to a charge port of the Powered Watercraft EV may then route to a battery charge sharing unit that is integral with the first EV, rather than having the battery charge sharing unit integral with the trailer. This is convenient even in the case of when multiple Powered Watercraft EVs (such as multiple EV Jet Skis) are removably situated upon the trailer. Thus, the trailer's charging ports serve to provide an electrically communicative connection between each Powered Watercraft EV removably situated upon the trailer and the battery charge sharing unit integral with the first EV, preferably through the trailer plug of the present disclosure, that is formed so as to provide a separate electrical conductor communicating between each Powered Watercraft EV removably situated upon the trailer and the battery charge sharing unit, wherever said battery charge sharing unit is situated, with it preferably being situated integral with the first EV, and less preferably with it being situated integral the trailer, and also less preferably with it being situated integral any Powered Watercraft EV (as that would increase the cost of production and the weight of the Powered Watercraft EV which would disincentive their adoption, whereas it is anticipated that the cost and weight increase to any EV comprising a first EV would be negligible).

Thus, in the case of towing multiple Powered Watercraft EVs removably situated upon the trailer, each towed upon Powered Watercraft EV may connect at and/or via a different port to the battery charge sharing unit that is designed, constructed and configured to separately analyze and process the electrical current and/or voltage and charge level/state-of-charge of the battery pack of each such EV, preferably in the manner and fashion described herein for any single towed upon Powered Watercraft EV.

In some embodiments of the present disclosure, it may be desired to charge the battery pack of the Powered Watercraft EV using charge stored within the battery pack of the first EV. When this is desired, the battery charge sharing unit(s) of the present disclosure operate essentially in reverse to the method of operation described supra with the exception that the electrical charge is directed and/or supplied to the battery pack of the Powered Watercraft EV, preferably exclusively, but in some cases it may be used also to power electrical systems of the Powered Watercraft EV such as computers and sensors and the battery charge sharing unit(s) themselves should they be located upon or within the Powered Watercraft EV. For example, when desired to use the battery charge of the first EV to charge the battery of the Powered Watercraft EV, the battery charge sharing unit(s) of the present disclosure first is/are designed and configured to ensure that any current permitted to flow from the first EV to the Powered Watercraft EV is compatible with the voltage architecture of the Powered Watercraft EV, and first detects the voltage of the first EV's battery (or already knows it from a pre-program) and also ascertains the voltage architecture of the Powered Watercraft EV and its battery pack (or already knows it from a pre-program); it then directs current from the first EV's battery to an appropriately configured inverter or convertor prior to allowing the voltage and/or current to connect to the Powered Watercraft EV'S electrical architecture so as to result in current and/or voltage that is compatible with the voltage architecture of the Powered Watercraft (and towed upon) EV.

(Or, if the first EV and its battery function at the same voltage architecture of the Powered Watercraft EV, the battery charge sharing unit might not necessarily direct current from the first EV through any inverter and/or convertor prior to allowing such current to flow to the Powered Watercraft EV's electrical architecture.)

Preferably, upon either (I) converting the current and/or voltage from the first EV's battery to a voltage and/or current compatible with the Powered Watercraft EV's architecture; or, (ii) ascertaining that the voltage and/or current from the first EV's battery already is compatible with the Powered Watercraft EV's electrical architecture; the battery charge sharing unit is designed and configured and programmed to allow the current and voltage from the first EV's battery to charge the battery of the Powered Watercraft EV, and optionally if desired to power all features and aspects of the Powered Watercraft EV's electrical architecture, just as if the battery of the first EV was the battery of the Powered Watercraft EV.

For another example, the first EV, such as may be an SUV, tows a trailer upon which are situated on or more EV jet skis. Each EV jet ski has a battery pack and the first EV also has a battery pack. The operators may desire to travel a considerable distance from their point of origin to their final destination. Due to the fact that the first EV is towing a considerable load, the battery of the first EV is likely to be depleted at an accelerated rate during the voyage when compared to driving without towing the considerable load. This reduces the range that the operator can travel to a desired destination, and thus impedes the adoption of EVs for a significant proportion of persons who are interested to use boats and watercraft. However, by making use of the apparatus and methods of the present disclosure, the first EV is able to harness the electricity stored in the battery of the towed Powered Watercraft EV, thus extending the range of the first EV.

In one embodiment, using the example of an EV SUV for the first EV and an EV jet ski for the towed Powered Watercraft EV, the apparatus of the present disclosure includes that the first EV; the trailer; and the towed Powered Watercraft EV are designed and configured to be able to charge the battery pack of both the first EV and the Powered Watercraft EV by plugging in the first EV or the Powered Watercraft EV to a suitable EV charger or charge point. That is, by plugging in only the first EV, such as the SUV, both the SUV and the jet ski battery packs are able to be fully charged. A control unit 109V can be designed and configured to regulate the charging so that first the first EV is fully charged and then the towed Powered Watercraft EV is fully charged, or, at the option of the operator, vice versa. Or, the first and Powered Watercraft EVs may be separately charged, if the operator so desires.

In operation, e.g. while driving the first EV while towing upon a trailer carrying the towed Powered Watercraft EV, the battery of either the first EV or the Powered Watercraft EV can be used to power the first EV, as the operator desires. Or, a control unit can be designed, configured and programmed to first take charge from the towed Powered Watercraft EV's battery pack, and only when it is depleted to take charge from the first EV's battery pack, such as is suitable when the final destination is far enough away from the first destination that the first EV's battery would have been drained and require charging enroute if not for the use of the electricity stored in the towed Powered Watercraft EV's battery pack. In this way, the effective driving range between stopping for recharging is increased, and in fact significantly increased. In such example, such as when the operators are taking a road trip, the convenience of the extended range at the expense of using the towed Powered Watercraft EV's (e.g. the jet ski's) battery charge is acceptable as the jet Ski could then be charged overnight prior to use such as occurs, for example, when the operators depart on their voyage on a Friday afternoon intended to use the EV jet ski on Saturday, then to recharge it Saturday night, for either using again the EV jet ski on Sunday or for the drive to another location where the EV jet ski's battery pack again can be used to power the first EV (e.g. the SUV, or light truck/pickup).

In another option, if the final destination is relatively near the point of origin, the operator can select an option that the first EV's battery pack is used to power the first EV enroute to the destination, so that the jet ski arrives fully charged and ready for use, while, oppositely, in commencing the remainder of the voyage after the watersport activity, any remaining charge in the towed Powered Watercraft EV's battery pack (e.g. the jet ski's battery pack) is first used and first drained in powering the first EV for the leg of the voyage after completion of the desired activity, such as a boating activity, so that a maximal driving range is achieved for the combination of the first EV and the towed Powered Watercraft EV prior to requiring a next recharge.

In another example, a first EV is a pickup truck and the Powered Watercraft EV is an EV waterski boat and/or personal motorboat, where the first EV tows upon a trailer upon which is situated the Powered Watercraft EV (e.g. the towed Powered Watercraft EV). The battery pack of the first and the Powered Watercraft EVs are designed and configured to each be chargeable by the same type of fast charging unit, preferably to operate at the same voltage, and to be able to connect, via hardware included on the trailer and/or included on either or both the first and Powered Watercraft EV, to one another so that the first EV's Power Electronics Controller and/or Inverter and/or Electric Traction Motor, and in fact the entire first EV is able to be supplied with electricity from the battery pack of the towed Powered Watercraft EV just as if it was being supplied with electricity from its own battery pack. The operator is able to select to first use the electricity of the towed Powered Watercraft EV's battery pack, or, to first use the electricity of the first EV's battery pack, as the situation mandates. For example, if the drive is a relatively long drive that would sufficiently drain the battery pack of the first EV so that it would require charging prior to or shortly upon arrival at a particular destination, and especially when the towed Powered Watercraft EV is not intended to be used the first leg of the voyage, then the battery of the towed Powered Watercraft EV can be first drained so as to preserve for as long as possible the battery charge of the first EV so that upon arrival at a destination and disconnection from the trailer towing the towed Powered Watercraft EV, the first EV has sufficient charge to be used without having to immediately stop operating the first EV for recharging. This would be especially useful for long road trips where the towed Powered Watercraft EV is not planned to be used each day of driving. By first using the battery pack charge of the towed Powered Watercraft EV, the mass of the towed powered Watercraft EV is reduced for more of the driving time than if it's battery pack either was never used to power the first EV or was used only after depletion of much of the charge in the first EV's battery pack, thus also increasing range by reducing the towing resistance on the first EV.

In presently preferred embodiments of the present disclosure, the first EV comprises a charging system capable of bi-directional charging (including Vehicle to Vehicle Charging; Vehicle to Load Charging; and Vehicle to Grid Charging), and the Powered Watercraft EV also comprises a charging system capable of bi-directional charging (including Vehicle to Vehicle Charging; Vehicle to Load Charging; and Vehicle to Grid Charging); and, the system of the present disclosure is in communication with the charging system of the first EV, and also with the charging system of the Powered Watercraft EV, so as to be in communication with all sensors and switches and other equipment, features and elements of the charging system of the first EV and the charging system of the Powered Watercraft EV so as to be configured to and capable of carrying out the objects of the present disclosure and the functions of the system of the present disclosure.

This text discloses a different invention where the trailer is not present and where the Powered Watercraft EV is removably situated in the bed of an EV Pickup truck, or in the bed of a closed bed truck, (i.e. a first EV), instead of being removably situated upon a trailer that is towed by the EV Pickup truck, and where a charge port connects the charging system of the Powered Watercraft EV to that of the EV Pickup truck, and more particularly connects a bi-directional charging system of the Powered Watercraft EV to a bi-directional charging system of the EV Pickup Truck, where at least the bi-directional charging system of the EV pickup truck and of the Powered Watercraft EV(s) are included in the system of the present disclosure and are controlled by the system controller of the present disclosure. More than one of said such charge ports can be situated integral the EV Pickup Truck, for example, by being arranged with several situated aft of the rear window (i.e. on the back panel of the cab and on the front panel of the bed), and/or with several situated on the side panels of the EV Pickup's bed, so that several individual Powered Watercraft EV's can be carried in the EV Pickup's bed, and each have their bi-directional charging system removably connected to the bi-directional charging system of the EV Pickup Truck, and thus also connected to the system controller and thus be included in the system of the present disclosure. Then, the methods of the present disclosure for using energy stored in the battery packs of one or more Powered Watercraft EV(s) to power the first EV, and/or to charge either or both the first EV and/or the Powered Watercraft EV(s), when the Powered Watercraft EV(s) are removably situated upon a trailer, apply to this alternative invention now disclosed in this paragraph of when the Powered Watercraft EV(s) are removably situated in the bed of the EV Pickup truck, where embodiments pertaining to trailer regenerative brakes do not apply, and where the trailer plug 11, 11″ of the present disclosure is replaced by said charge ports situated in the bed and/or on the aft of the cab of the EV Pickup Truck.

This text discloses an additional and different invention where the teachings of this text as disclosed and taught as applicable to Powered Watercraft EVs are applied to “alternative EVs”. Specifically, although quite different from and in no way interchangeable with nor a substitution for Powered Watercraft EVs, it is anticipated that in certain circumstances it may be possible to modify the construction and configuration of other vehicles so as to make it possible and useful to apply the teachings of the present disclosure as taught herein for Powered Watercraft EVs to other types of vehicles, such as, potentially, all electric versions of: ATVs; UTVs; Quadbikes; snowmobiles; and motorbikes (including dirt bikes and/or motorcycles), in which case, although said other all electric vehicles are in no way interchangeable with nor substitutable with Powered Watercraft EVs, it is anticipated that the teachings of the present disclosure as taught applicable to Powered Watercraft EV's can, with appropriate digital, mechanical and electrical modification of said other all electric vehicles, be applied to said other all electric vehicles. In this text the term “alternative EVs” shall include ATVs; UTVs; Quadbikes; snowmobiles; and motorbikes (including dirt bikes and/or motorcycles).

Furthermore, the present disclosure discloses an additional and different invention where, to facilitate access to external charge ports at boat ramps and parking lots for vehicles towing boat trailers, and also at any location, the present disclosure discloses an additional invention of an external charger for EVs where said external charger is formed comprising the shape of a speed bump (e.g. comprising for its upper portion an artificial ridge that can be drove over and across by a passenger vehicle especially one travelling at low speeds, with a height of about one hundred to two hundred centimeters at its highest point, that is in the center of its ridge).

That is, the external charger of the present disclosure comprises a shape comprising a typical ridge shaped speed bump where the ridge has an arched surface and/or an upper surface preferably comprising an arc of a circle when the ridge is viewed in a cross section that is perpendicular to the speed bump shaped charger's long axis. The ridge may be set crosswise onto a street, roadway, parking lot or other paved surface, such as by adherence to the paved surface. The arched ridge can easily be drove over by a car or truck or trailer traveling at a slow speed, such as at a boat launch parking lot, including when trailering the Powered Watercraft EV(s) of the present disclosure, and, the maximal height of the speed bump shaped portion of the present disclosure's external charger could be considerably higher than a typical speed bump, as it is not designed to slow otherwise fast traffic, but designed only to accommodate passage of very low speed vehicles towing a trailer, where such vehicles and trailer typically have rather high ground clearance, and the arch and/or tangent of a circle can have a rather wide base so as to make a smooth drive, thereby allowing a rather large internal space to accommodate any and all desired components of said speed bump shaped external charger. It is understood that the speed bump shape of said external and typically outdoors charger of the present invention can comprise only a portion of said external charger of the present invention, and that it can have a rectangular box like, or coffin like form that contains most of the charger's components where such rectangular box like and/or coffin like form is recessed into the road/ground/pavement/asphalt or other, and have only an upper portion that is the speed bump shaped portion, according to how much void space is required to contain all components of the charger that preferably includes components for a highly energy efficient slow charger, as well as for a very fast charger, it being anticipated that use of a highly energy efficient slow charger is optimal when the user/operator is parking an All-Electric Pickup or other EV from early morning to late afternoon, while boating during that same time period, as often is the case at boat launches.

However, it is not preferably to recess any portion of the speed bump shaped charger into the ground or substrate upon which is situated the paved surface that vehicles are driving upon. Preferably, the entire structure of the speed bump shaped external charger is the speed bump shape itself, so as to allow its adherence to a paved surface, rather than a larger shape having a box like structure beneath the speed bump like structure, where the box like structure would by necessity require being sunken into the substrate and/or ground upon which the paved surface is situated, which is an expensive undertaking.

In the speed bump shaped configuration, the present disclosure's charger comprises an elongated and/or rectangular and/or generally rectangular cross sectional shape to its vertical axis and/or dimension). However, alternately, the present disclosure's charger may have a mound shape, where said external charger is formed as a dome top shaped and is not elongated but has a circular or generally circular cross section to its vertical axis and/or dimension). In this way, said dome topped external chargers that can easily be driven over by a vehicle same as are said speed bump shaped chargers, and the dome shaped chargers are an option when insufficient space exists to use an elongated, ridge shaped speed bump of the present disclosure. Another option is that the external charger of the present disclosure is, alternatively, in a different invention because it cannot be comfortably driven over and is not suitable for boat launch parking lots, shaped as a parking curb and/or parking block and/or curb stop, e.g. a ridge shaped charger having a surface not comfortable to be drove over by a wheeled vehicle. However, such is not preferred, except when said charger is to be used to terminate a parking stall or other parking space. For both the speed bump shaped charger of the present disclosure as well as for the dome shaped charger of the present disclosure, as well as for the parking curb shaped charger of the present disclosure, if insufficient space exists in the above ground level/above paved level portion of the external charger to contain all components and elements of the external charger, the external charger may comprise a shape that includes a subterranean portion, that can be any convenient shape including but not limited to a rectangular box shape like shape and/or coffin like shape that comprises as its upper segment the above-ground speed bump shaped portion of the external charger. Similarly, the dome shaped external charger can have any conveniently shaped sub-paved surface level portion. In this way, the external charger is recessed into the ground/asphalt/pavement/road, and is waterproofed such as by its electrical components other than its charging cable and plug being contained in a water tight container, that may be formed by injecting molten thermoplastic into the container housing the components of the external charger and allowing such thermoplastic to solidify, leaving only the electrical lead(s)/charging cable and plug accessible as well as any user interface, so that the external charger can be connected to underground cable providing electricity as well as communication conductors. Filling void space internal the speed bump shaped charger with a thermoplastic or other plastic also is anticipated to provide sufficient resistance to deformation even when subjected to the pressure of being parked upon or driven over by the heaviest vehicle that can utilize the parking space. If desired, supporting structures such as ribs and trusses and the like can be constructed internal the speed bump shaped charger in order to prevent its upper surface from collapsing under pressure. Also, if desired, all components of the speed bump shaped charger related to the charging system itself, besides the charging plug and/or handle and its electrical cable, can be recessed into the roadbed or ground, while the speed bump shaped charger itself is designed solely to resist compression, and can even be a solid plastic or rubber speed bump shape (that has flanges or other structures at it's ends to permit mounting the charger handle and/or plug as well as its electrical cable, that communicate electrically to the remainder of the charging components, that are recessed into the ground and/or roadbed, preferably in a trench or other concavity that is substantially smaller in at least length and/or width than the footprint of the speed bump portion of the charger itself, so as to provide a “mushroom cap over stem” shape, thereby ensuring that pressure from a heavy vehicle is transmitted to the ground rather than to the charging system components that would, in this embodiment of the speed bump shaped charger of the present disclosure, be contained in the recess in the ground that is beneath the speed bump portion of the charger.

A flap can be situated on the top surface of the speed bump shaped charger, e.g. that portion above ground level, or on a side surface at one of its narrow ends (when it is an elongated shaped speed bump shaped external charger); or at its top or top side surface when it is a simple dome shaped external charger, where lifting such flap allows access to the charging cable and plug as well as any device needed to effect payment and/or authorize use, such as a touch screen user interface, or other, where such flap is having a configured to automatically close itself unless it is being held open by a user or by the cable of the charging cable, for example.

Alternately, the speed bump shaped charger may comprise at its short ends truncated ends comprising a recessed face onto which is removably mounted an EV Charger handle attached to a cable, where the cable preferably retracts into the interior of the speed bump shaped charger, but can be coiled outside it. Multiple different charging handles can be situated on each truncated short end of said speed bump shaped charger, for example, allowing charging various makes of EVs having incompatible charge systems.

In this way, users/drivers/operators of the present disclosure's system can launch their boat, and then park their pickup truck or other EV, at the usual location at a boat launch park's parking lot dedicated for vehicles trailering boat trailers, and, connect the first EV to said speed bump shaped external charger in order to charge it to a full charge while they are out boating. Then, upon returning, they have a fully charged first EV to either use to drive home or to another location, or to use to charge or partially charge their EV Powered Watercraft in accordance with the teachings of the present disclosure, or both.

FIG. 6 illustrates a top view of a portion of a parking lot where a plurality of speed bump shaped external chargers 30 of the present disclosure are set crosswise at the interior terminal end of a plurality of parking stalls indicated by painted lines. To adapt the parking lot charger arrangement shown in FIG. 6 to that of a boat ramp, the center dividing lines indicating the head to head separation of different parking stalls could be eliminated and a first EV towing a trailer could be parked so that the first EV occupies one parking space, the trailer occupies another parking space, and between the two and situated in the middle of the two, in the position already shown in FIG. 6, is a speed bump shaped charger 30.

FIG. 7 illustrates a top view of an alternate portion of a parking lot where a plurality of speed bump shaped external chargers 31 of the present disclosure are set parallel to the long length of the parking stalls and placed so as to separate the right and left sides of adjacent parked vehicles and with a gap space between the short ends/butt ends of in-line speed bump shaped chargers so as to allow access to more charger plugs, those being situated on the butt ends; and, a single speed bump shaped external charger 30 that is situated in similar fashion as chargers 31 but is longer than chargers 31 and occupies more space and provides less access to charger handles as it has only two short ends/butt ends to display charger handles. Chargers 31 differ from chargers 30 in that chargers 31 comprise a flattened top.

As shown in FIG. 7, a single EV is capable of being charged at its usual charge port as well as at its trailer plug charger port by a single speed bump charger. This also would hold true when a first EV towing a trailer is parked relative to a single speed bump charger as described above.

FIG. 8A, FIG. 8B and FIG. 8C illustrate various possible cross sectional shapes for the cross section of the speed bump shaped chargers of the present disclosure taken in a plane perpendicular to their long axis. The cross section of FIG. 8A comprises an arc of a circle. The cross section of FIG. 8B comprises an arc of a circle that has had its apex truncated so as to create a flattened top surface. The cross section of FIG. 8B comprises an arc of a circle that has had its apex truncated so as to create a flattened top surface. The cross section of FIG. 8C comprises a series of flat cuts joined together to approximate an arc of a circle with a flattened top surface. All forms are useful, provided that the speed bump shaped charger comprises for its above ground level/pavement level form a ridge that has a convex surface shaped so that a passenger vehicle can drive over the speed bump shaped charger. As seen, a charger handle is situated at each short end of each speed bump shaped charger, as described above.

FIG. 9 and FIG. 10 illustrate possible side plan views of the long dimension of two alternate speed bump shaped chargers of the present disclosure, where the dashed vertical lines in each indicate where the flat face of their short ends/butt ends exist forming the awning like sheltered configuration over their short sides' faces surfaces upon which is situated at least one charger handle up to several charger handles, with a charger handle cable that, preferably, retracts into the speed bump shaped charger's above ground forms interior space. An electrical power cable can be submerged into the paved surface and/or asphalt and supply electric power to a plurality of speed bump shaped chargers arranged in a line and/or row. A meter at each charger counts the kilowatt hours dispensed in each case. A user interface can optionally be situated on each charger handle.

The speed bump shaped chargers of the present disclosure are made from durable materials including hard plastics and possibly including aluminum and/or steel coated in plastics and due to their shape that allows vehicles to drive over them are virtually impossible for a motor vehicle to damage even by colliding with them or running over them at any speed, and thus are an affordable and practical solution for large parking lots, and for boat launch parking lots, where a vertically disposed charger is essentially impossible to provide without it being damaged, thus providing the ability to charge an EV at a large parking lot where parking stalls are divided only or frequently only by painted lines and also at a boat launch parking lot while its counterpart Powered Watercraft EV is in use (or while it is on the trailer), thus allowing boaters to charge their towing first EV while they are away and out boating and to return to a fully charged EV to tow their boat and or other Powered Watercraft EV and trailer, thus facilitating adoption of clean EV boats and clean EV personal watercraft, thereby removing a major source of pollution of both the atmosphere and marine environments, thereby accomplishing a goal of the present disclosure.

Similarly and likewise, the Range Extending System of the present disclosure also facilitates use of EVs in many situations where otherwise EVs are known to be unpleasant to use due to over fifty percent range reductions and long charging wait times, thereby also facilitating adoption of clean EV boats and clean EV personal watercraft, thereby removing a major source of pollution of both the atmosphere and marine environments, thereby accomplishing a goal of the present disclosure.

FIG. 11 illustrates a top view of a boat launch parking lot where a plurality of speed bump shaped external chargers of the present disclosure are set crosswise about midpoint along the length of parking stalls having a length and width typically found in boat launch parking lots, that is, long enough and wide enough to accommodate parking and parking maneuvers of a typical large pickup towing a typical large boat trailer. The invention disclosed in FIG. 11 thus solves the problem of charging an EV Pickup or other wheeled EV that had its battery charge excessively depleted consequent of towing an EV boat, EV personal watercraft, or other Powered Watercraft EV to a boat launch facility for a recreational boating event, thereby removing a major hindrance impeding the adoption of EV Pickups and EV SUV's as most Pickup truck drivers in North America require to be able to tow a boat with their Pickup.

### SPECIFIC EXAMPLES

### Examples/Claims

i) A method for extending the range a first EV is capable of travelling while towing a trailer upon at least a portion of which is removably situated at least one Powered Watercraft EV, the first EV having at least a primary propulsion apparatus comprising an electric drive system comprising at least a battery pack and a motor controller, the first EV's electric drive system configured to at least power at least a wheel of the first EV, the Powered Watercraft EV having at least a primary propulsion apparatus comprising an electric drive system having at least a battery pack and configured at least to power at least a propeller and/or impeller of the Powered Watercraft EV, the method comprising steps of: monitoring a sensor configured to detect at least an electrical component of the Powered Watercraft EV's electric drive system wherein said monitoring step is performed by a system controller (109) coupled to said sensor.
ii) The method of example 1 further comprising selecting for the electrical component of the Powered Watercraft EV's electric drive system that is detected by the sensor at least a feature of the battery pack of the Powered Watercraft EV.
iii) The method of example 2 further comprising configuring the sensor to detect the Powered Watercraft EV's battery pack's SOC/SOE.
iv) The method of example 3 further comprising outputting a control signal from said sensor; receiving said control signal by said system controller; and determining if the battery pack of the Powered Watercraft EV contains a certain SOC/SOE (that could be preset, such as a preset determined to be a minimum sufficient SOC/SOE to power the 1st EV).
v) The method of example 4 wherein said step of outputting a control signal from said battery charge sensor further comprises outputting a control signal that is calibrated to the SOC/SOE of said battery pack.
vi) The method of any one of examples 3 or 5 wherein said step of determining if the battery pack of the Powered Watercraft EV contains sufficient energy to power the 1st EV further comprises selecting to make said determination according to at least one preset.
vii) The method of example 6 further comprising selecting a minimum amount of kilowatt-hours for the at least one preset.
viii) The method of example 6 further comprising selecting a predetermined driving speed and/or minimum driving speed for the first EV while towing a predetermined load and/or minimum load for the at least one preset.
ix) The method of example 6 further comprising selecting a certain weight and/or weight range of a combination of the at least a Powered Watercraft EV and the trailer upon at least a portion of which is removably situated the Powered Watercraft EV for the at least one preset.
x) The method of any one of examples 1 to 9 further comprising steps of activating a display of information on a user interface (117) coupled to the system controller (109), said display information pertaining to at least a feature of the Powered Watercraft EV, wherein said step of activating said display of information is performed by said system controller.
xi) The method of example 10 wherein said information includes information pertaining to the SOC/SOE of the battery pack of the at least a Powered Watercraft EV.
xii) The method of example 10 wherein said information includes information pertaining to the SOC/SOE of the battery pack of at least the first EV.
xiii) The method of example any one of examples 10 to 12 wherein said information includes at least a prompt to the user/driver.
xiv) The method of any one of examples 10 or 13 where said information displayed on the user interface comprises a menu.
XV) The method of any one of examples 13 to 14 where either or both said menu and/or said prompt includes an option for the user/driver, where said option has the effect of allowing the user/driver to select to power the first EV from the battery pack of the Powered Watercraft EV.
xvi) The method of any one of examples 13 to 15 where either or both said menu and/or said prompt includes an option for the user/driver, where said option has the effect of allowing the user/driver to select to power the first EV from the battery pack of the first EV.
xvii) The method of any one of examples 13 to 16 where either or both said menu and/or said prompt includes an option for the user/driver, where said option has the effect of allowing the user/driver to select to power the first EV simultaneously from both the battery pack of the first EV as well as from the battery pack of the at least one Powered Watercraft EV.
xviii) The method of any one of examples 13 to 17 where either or both said menu and/or said prompt includes an option for the user/driver, where said option has the effect of allowing the user/driver to select to power the
   first EV firstly and/or initially either from the battery pack of the first EV or from the battery pack of the at least one Powered Watercraft EV; and, secondly and/or subsequently from whichever battery pack was not selected to be the battery pack to firstly power the first EV.
xix) The method of example 18 where the method further comprises selecting to supply electrical energy to the first EV's motor controller firstly from whichever battery pack is selected by the user/driver to firstly power the first EV; and, selecting to subsequently supply electrical energy to the first EV's motor controller from whichever battery pack was not selected by the user/driver to firstly power the first EV.
xx) The method of example 19 wherein the user/driver selecting to power the first EV firstly from the battery pack selected by the user/driver to firstly power the first EV causes the system to supply electrical energy to the first EV's motor controller from the battery pack selected by the user/driver to firstly power the first EV.
xxi) The method of any one of examples 19 to 20 wherein the SOC/SOE of the battery pack selected by the user/driver to firstly power the first EV is periodically monitored during use of the first EV.
xxii) The method of example 21 wherein said monitoring is performed by the system controller.
xxiii) The method of any one of examples 18 to 22 comprising a further step of discontinuing and/or mainly discontinuing supplying electrical energy to the first EV's motor controller from the battery pack selected by the user/driver to firstly power the first EV when the SOC/SOE of said battery pack reaches a preset.
xxiv) The method of example 23 wherein said step of discontinuing and/or mainly discontinuing supplying electrical energy to the first EV's motor controller from the battery pack selected by the user/driver to firstly power the first EV when the SOC/SOE of said battery pack reaches a present is performed by the system controller.
xxv) The method of example 23 wherein said step of discontinuing and/or mainly discontinuing supplying electrical energy to the first EV's motor controller from the battery pack selected by the user/driver to firstly power the first EV when the SOC/SOE of said battery pack reaches a preset is performed by the user/driver inputting information into the user interface wherein said inputted information has the effect of causing said step of discontinuing and/or mainly discontinuing supplying electrical energy to the first EV's motor controller from the battery pack selected by the user/driver to firstly power the first EV.
xxvi) The method of example 25 wherein prior to the step of the user/driver inputting said information into the user interface the method comprises an additional step of notifying the user/driver of the SOC/SOE of the battery pack selected by the user/driver to firstly power the first EV.
xxvii) The method of example 26 wherein the step of notifying the user/driver of the SOC/SOE of the battery pack selected by the user/driver to firstly power the first EV comprises an additional step of making a suggestion to the user/driver via the user interface comprising suggestions selected from a group comprising: (a) that the SOC/SOE of the battery pack selected by the user/driver to firstly power the first EV indicates that said battery should no longer be used to power the first EV; (b) that another battery pack is available that has more charge than does the selected battery pack; the estimated range that could be travailed using the charge contained in the selected battery pack; and (d) any combination of the above xxviii) The method of any one of examples 25 to 27 comprising a further step of making a suggestion to the user/driver to switch to using whichever battery pack was not selected to be the battery pack to firstly power the first EV for the purpose of powering the first EV.
xxix) The method of example 26 wherein the step of notifying the user/driver of the SOC/SOE of the battery pack selected by the user/driver to firstly power the first EV is performed by the system controller.
xxx) The method of example 27 wherein the step of making a suggestion to the user/driver via the user interface that the SOC/SOE of the battery pack selected by the user/driver to firstly power the first EV indicates that said battery should no longer be used to power the first EV is performed by the system controller.
xxxi) The method of example 28 wherein the step of making a suggestion to the user/driver to switch to using whichever battery pack was not selected to be the battery pack to firstly power the first EV for the purpose of powering the first EV is performed by the system controller.
xxxii) The method of any one of examples 18 to 31 wherein the step of selecting to subsequently supply electrical energy to the first EV's motor controller from whichever battery pack was not selected by the user/driver to firstly power the first EV is performed by the user/driver via the user interface.
xxxiii) The method of any one of examples 18 to 24 wherein the step of selecting to subsequently supply electrical energy to the first EV's motor controller from whichever battery pack was not selected by the user/driver to firstly power the first EV is performed by the system controller.
xxxiv) The method of example 33 wherein the step of selecting to subsequently supply electrical energy to the first EV's motor controller from whichever battery pack was not selected by the user/driver to firstly power the first EV is performed by the system controller upon the SOC/SOE of the battery pack selected by the user/driver to firstly power the first EV reaching a preset.
xxxv) The method of example 19 wherein said step of supplying electrical energy to power the first EV's motor controller from whichever battery pack was not selected to be first by the user subsequent to supplying electrical energy to power the first EV's motor controller from whichever battery pack is selected to be first by the user is performed by said system controller and comprises a further step of monitoring a battery SOC/SOE sensor configured to detect the SOC/SOE of the battery pack selected to be first by the user, wherein said monitoring step is performed by the system controller.
xxxvi) The method of example 35 wherein said step of monitoring the battery SOC/SOE further includes a step of detecting a certain SOC/SOE of the battery pack selected to be first by the user, and further includes a step of selecting to supply electrical energy to power the first EV's motor controller from whichever battery pack was not selected to be first by the user subsequent to said detection of said certain SOC/SOE, wherein said step of said detection of said certain SOC/SOE is performed by said system controller, and wherein said step of selecting to supply electrical energy to power the first EV's motor controller from whichever battery pack was not selected to be first by the user subsequent to said detection of said certain SOC/SOE is performed by said system controller.
xxxvii) The method of any one of examples 13 to 18 wherein said menu and/or prompt informs the user/driver that whichever battery pack is not selected by the driver to be first to power the first EV is to be used to power the first EV upon whichever battery pack is selected to be first reaching a certain SOC/SOE (that might be a “low charge” level).
xxxviii) The method of example 37 wherein said menu and/or prompt informs the user/driver that they can change the certain SOC/SOE level that whichever battery pack is not selected by the driver to be first to power the first EV is to be used to power the first EV.
xxxix) The method of any one of examples 37 to 38 wherein said menu and/or prompt informs the user/driver that they can change the certain SOC/SOE level that whichever battery pack is not selected by the driver to be first to power the first EV is to be used to power the first EV, and/or prompts the user/driver to enter a different value for said SOC/SOE level.
xl) A method for bettering a performance characteristic of a vehicle selected from a group consisting of: a first EV; and, at least a Powered Watercraft EV, the first EV having at least a primary propulsion apparatus comprising an electric drive system comprising at least a battery pack, at least a motor controller and at least an electric traction motor, the first EV's electric drive system configured to at least power at least a wheel of the first EV, the at least a Powered Watercraft EV having at least a primary propulsion apparatus comprising an electric drive system comprising at least a battery pack and at least an electric motor configured at least to power at least a propeller and/or impeller of the at least a Powered Watercraft EV, the method comprising steps of: forming an electrically conductive connection between: (I) at least an electrical component integral with the first EV; and, (ii) at least an electrical component integral with the at least a Powered Watercraft EV.
xli) The method of example 40 comprising further steps of selecting to form the electrically conductive connection as a detachable connection preferably as a mechanically detachable connection.
xlii) The method of any one of examples 40 or 41 further comprising selecting for the at least an electrical component integral with the at least a Powered Watercraft EV an electrical component integral with the at least a Powered Watercraft EV's electric drive system.
xliii) The method of example 42 further comprising selecting for the electrical component integral with the at least a Powered Watercraft EV's electric drive system at least a battery pack of the at least a Powered Watercraft EV's electric drive system.
xliv) The method of any one of examples 40 or 41 further comprising selecting for the at least an electrical component integral with the first EV an electrical component integral with the first EV's electric drive system.
xlv) The method of example 44 further comprising selecting for the electrical component integral with the first EV's electric drive system at least a motor controller of the first EV's electric drive system.
xlvi) The method of example 44 further comprising selecting for the electrical component integral with the first EV's electric drive system at least a battery pack of the first EV's electric drive system.
xlvii) The method of example 45 wherein the step of forming the electrically conductive connection between: (I) at least an electrical component integral with the first EV; and, (ii) at least an electrical component integral with the at least a Powered Watercraft EV comprises further steps of forming an electrically conductive connection between the battery pack of the at least a Powered Watercraft EV and the motor controller of the first EV.
xlviii) The method of example 47 comprising a further step of selecting to form the electrically conductive connection between the battery pack of the at least a Powered Watercraft EV and the motor controller of the first EV as a direct connection.
xlix) The method of example 47 comprising a further step of selecting to form the electrically conductive connection between the battery pack of the at least a Powered Watercraft EV and the motor controller of the first EV as a direct connection bypassing a charging system of the at least a Powered Watercraft EV, where the bypassed charging system of the at least a Powered Watercraft EV is configured to facilitate charging of the battery pack of the at least a Powered Watercraft EV.
l) The method of any one of examples 47 to 49 wherein the step of selecting to form the electrically conductive connection between the battery pack of the at least a Powered Watercraft EV and the motor controller of the first EV comprises a further step of configuring the first EV to be capable of using electrical energy contained within the at least a Powered Watercraft EV's battery pack just the same as if said electrical energy was contained within the first EV's battery pack, whereby
   the bettered performance characteristic is selected from a group comprising bettered driving range of the first EV while towing the at least a Powered Watercraft EV; less frequent recharging events required to drive a certain distance and shorter trip times when towing the at least a Powered Watercraft EV with the first EV; and a more pleasant user experience.
li) The method of any one of examples 47 to 50 comprising a further step of verifying that electrical energy from the batter pack of the at least a Powered Watercraft EV is suitable for supply to the first EV's motor controller, where said verification step is performed by a system controller.
lii) The method of any one of examples 47 to 51 comprising a further step of selecting to supply electrical energy to the first EV's motor controller from the battery pack of the at least a Powered Watercraft EV.
liii) The method of any one of examples 47 to 51 comprising a further step of selecting to supply electrical energy to the first EV's motor controller simultaneously from both the battery pack of the first EV as well as from the battery pack of the at least one Powered Watercraft EV.
liv) The method of any one of examples 47 to 51 comprising a further step of selecting to supply electrical energy to the first EV's motor controller firstly and/or initially either from the at least a Powered Watercraft EV's battery pack; and, secondly and/or subsequently from the first EV's battery pack.
lv) The method of any one of examples 47 to 51 comprising a further step of selecting to supply electrical energy to the first EV's motor controller firstly and/or initially either from the battery pack of the first EV or from the battery pack of the at least one Powered Watercraft EV; and, secondly and/or subsequently from whichever battery pack was not selected to be the battery pack to firstly supply electrical energy to the first EV's motor controller.
lvi) The method of any one of examples 52 to 55 wherein the step of selecting to supply electrical energy to the first EV's motor controller is performed by a system controller.
lvii) The method of example 56 comprising a further step of verifying that electrical energy from the battery pack of the at least a Powered Watercraft EV is suitable for supply to the first EV's motor controller, where said verification step is performed by the system controller.
lviii) The method of example 54 wherein the step of supplying electrical energy to the first EV's motor controller from the first EV's battery pack secondly and/or subsequently to supplying electrical energy to the first EV's motor controller from the at least a Powered Watercraft EV's battery pack is performed by a system controller.
lix) The method of example 55 wherein the step of supplying electrical energy to the first EV's motor controller secondly and/or subsequently from whichever battery pack was not selected to be the battery pack to firstly supply electrical energy to the first EV's motor controller is performed by a system controller.
lx) The method of example 54 wherein the step of supplying electrical energy to the first EV's motor controller from the first EV's battery pack secondly and/or subsequently to supplying electrical energy to the first EV's motor controller from the at least a Powered Watercraft EV's battery pack is performed by a user/driver.
lxi) The method of example 55 wherein the step of supplying electrical energy to the first EV's motor controller secondly and/or subsequently from whichever battery pack was not selected to be the battery pack to firstly supply electrical energy to the first EV's motor controller is performed by a user/driver.
lxii) The method of any one of examples 40 to 44, and example 46, wherein the method further comprises supplying electrical energy from the battery pack of the at least a Powered Watercraft EV to the charging system of the first EV for purposes of charging the battery pack of the first EV.
lxiii) The method of any one of examples 40 to 44, and example 46, wherein the method further comprises supplying electrical energy from the battery pack of the first EV to the charging system of the at least a Powered Watercraft EV for purposes of charging the battery pack of the at least a Powered Watercraft EV.
lxiv) The method of any one of examples 40 to 44, and example 46, wherein the method further comprises supplying electrical energy from an external charger detachably connected to the first EV to the charging system of the at least a Powered Watercraft EV for purposes of charging the battery pack of the at least a Powered Watercraft EV.
lxv) The method of any one of examples 40 to 44, and example 46, wherein the method further comprises supplying electrical energy from an external charger detachably connected to the first EV simultaneously to both the charging system of the first EV as well as the charging system of the at least a Powered Watercraft EV for purposes of simultaneously charging both the battery pack of the at least a Powered Watercraft EV as well as the battery pack of the first EV.
lxvi) The method of any one of examples 40 to 65 comprising further steps of selecting to configure the first EV to be capable of connecting to and towing upon a trailer configured to be capable of having removably situated upon at least a portion of itself the at least a Powered Watercraft EV.
lxvii) The method of example 66 comprising further steps of selecting to form the electrically conductive connection between: (I) at least an electrical component integral with the first EV; and, (ii) at least an electrical component integral with the at least a Powered Watercraft EV, comprising at least a portion of a detachable trailer plug assembly wherein the trailer plug assembly is configured to enable electrically conductive connection between elements selected from a group comprising: (I) at least the battery pack of the at least a Powered Watercraft EV and the first EV's motor controller; (ii) at least the battery pack of the at least a Powered Watercraft EV and a charging system of the first EV;
   (iii) at least a charging system of the at least a Powered Watercraft EV and a charging system of the first EV; and (iv) at least a bi-directional charging system of the at least a Powered Watercraft EV and a bi-directional charging system of the first EV.
lxviii) The method of any one of examples 40 to 65 comprising further steps of selecting to configure the first EV as a truck comprising a platform configured to be capable of having removably situated upon its platform the at least a Powered Watercraft EV, and comprising further steps of selecting to form integral the truck at least a portion of the electrically conductive connection between: (I) at least an electrical component integral with the first EV; and, (ii) at least an electrical component integral with the at least a Powered Watercraft EV, comprising further steps of forming the at least a portion of the electrically conductive connection formed integral the truck comprising at least a portion of a detachable plug assembly and further comprising steps of configuring the at least a portion of the detachable plug assembly situated integral the truck comprising a charge port and/or charge plug configured to suitably enable electrically conductive connection between elements selected from a group comprising: (I) at least the battery pack of the at least a Powered Watercraft EV and the first EV's motor controller; (ii) at least the battery pack of the at least a Powered Watercraft EV and a charging system of the first EV; (iii) at least a charging system of the at least a Powered Watercraft EV and a charging system of the first EV; and (iv) at least a bi-directional charging system of the at least a Powered Watercraft EV and a bi-directional charging system of the first EV.
lxix) The method of example 68 comprising further steps of selecting to form the at least a portion of a detachable plug assembly that is situated integral with a portion of the truck comprising the first EV situated at a location integral with the truck selected from a group comprising:
(I) a back panel of a cab of the truck; (ii) a back panel of a cab of the truck, where the truck is a pickup truck;
(iii) a front panel of a bed of the truck; (iv) a front panel of a bed of the truck, where the truck is a pickup truck; (v) a side panel of a bed of the truck;
(vi) a side panel of a bed of the truck, where the truck is a pickup truck; (vii) the truck bed's floor;
(viii) the truck bed's floor, where the truck is a pickup truck;
(ix) any location integral the truck; and, (x) any location integral the truck, where the truck is a pickup truck.
70. A method for extending a first EV's range during towing by the first EV of a second EV that is a Powered Watercraft EV, the method comprising configuring the first EV to be capable of towing upon at least one Powered Watercraft EV using a trailer, the trailer configured to be capable of having the at least one Powered Watercraft EV removably situated upon at least a portion of the trailer, the method further comprising connecting electrical architecture of the first EV and electrical architecture of the at least one Powered Watercraft EV removably situated upon the at least a portion of the trailer through a plug and/or a trailer plug connected to the first EV, the method further comprising configuring the plug and/or connector and/or trailer plug connected to the first EV to be capable of transmitting electrical energy between at least the battery of the at least one Powered Watercraft EV and any of (a) the motor controller and/or electric motor of the first EV; and, (b) a battery and/or traction battery of the first EV.
71. The method of example 70 further comprising steps of using charge from the battery of the at least one Powered Watercraft EV to charge the battery of the first EV.
72. The method of any one of examples 70 or 71 further comprising steps of using charge from the battery of the at least one Powered Watercraft EV to power the motor controller and/or electric motor of the first EV.
73. The method of example 70 further comprising using the charge from the battery of the at least one Powered Watercraft EV to charge the battery of the first EV while the first EV is actively towing upon the at least one Powered Watercraft EV including at speeds from normal road speeds to highway speeds.
74. The method of example 70 further comprising using the charge from the battery of the at least one Powered Watercraft EV to power the motor controller and/or electric motor of the first EV while the first EV is actively towing upon the at least one Powered Watercraft EV including at speeds from normal road speeds to highway speeds.
75. The method of any one of examples 70 to 74 further comprising first routing electrical energy from the battery of the towed upon Powered Watercraft EV to equipment that ensures that the electrical energy is compatible with the electrical architecture and the voltage architecture of the first EV.
76. The method of examples 70 to 74 further comprising first routing electrical energy from the battery of the towed upon Powered Watercraft EV to equipment that ensures that the electrical energy of the towed upon Powered Watercraft EV is useable by the towing EV without causing any harm to the towing EV and its electrical architecture and its voltage architecture.
77. The method of any one of examples 70 to 76 further comprising steps of selecting to cease using electrical energy and/or charge from the battery of the towed upon Powered Watercraft EV when the Powered Watercraft EV's battery charge level (including State-of-charge and/or State of Energy) is below a certain battery charge level.
78. The method of any one of examples 70 to 77 further comprising steps of ceasing using electrical energy and/or charge from the battery of the towed upon Powered Watercraft EV to either charge the battery of the first EV or to power the motor controller and/or electric motor of the first EV, and using electrical energy from the first EVs battery pack to operate the first EV including to power the first EV's motor controller and/or electric motor.
79. The method of any one of examples 70, 71 and 72 further comprising steps of also charging the battery of the towed upon Powered Watercraft EV by ceasing to use battery charge from the towed upon Powered Watercraft EV either to (a) power the motor controller and/or electric motor of the towed upon Powered Watercraft EV; or, (b) charge the battery of the towing EV, and when the battery of the towing EV is not being charged by the battery of the towed upon Powered Watercraft EV, using charge from the battery of the towing EV to charge the battery of the towed upon Powered Watercraft EV.
80. The method of example 76 further comprising steps of also charging the battery of the towed upon Powered Watercraft EV by, ceasing to use battery charge from the towed upon Powered Watercraft EV to charge the battery of the towing EV and when the battery of the towing EV is not being charged by the battery of the towed upon Powered Watercraft EV, using charge from the battery of the towing EV to charge the battery of the towed upon Powered Watercraft EV.
81. The method of example 80 comprising subsequent steps of, upon determining that the battery of the towing EV needs to be charged in order to reach a certain destination, ceasing to charge the battery of the towed upon Powered Watercraft EV and using the battery charge of the towed upon Powered Watercraft EV to charge the battery of the towing EV.
82. The method of example 79 further comprising selecting to cease using the battery of the towed upon Powered Watercraft EV to charge the battery of the towing EV by inputting into an onboard computing device of the towing EV a desired destination, the onboard computing device calculating the rate of charge consumption of the towing EV during towing of the towed upon Powered Watercraft EV to the desired destination and comparing that to the charge of the towing EV's battery; and making a determination as to whether or not sufficient charge exists in the towing EV's battery to reach the desired destination taking into account the rate of charge consumption of the towing EV during towing of the towed upon Powered Watercraft EV; and when the determination is that sufficient charge does exist to reach the desired destination, consequently routing battery charge from the towing EV to the battery of the towed upon Powered Watercraft EV.
83. The method of example 82 further comprising steps of, prior to the step of consequently routing battery charge from the towing EV to the battery of the towed upon Powered Watercraft EV, first determining that the battery of the towed upon Powered Watercraft EV is not fully charged.
84. The method of example 70 further comprising towing upon the towed upon Powered Watercraft EV with use of the trailer.
85. The method of example 70 further comprising configuring the First EV to be capable of using electrical energy generated by regenerative trailer brakes, and towing upon the Powered Watercraft EV with use of a trailer equipped with regenerative trailer brakes, and using electrical energy generated by the trailer's regenerative brakes to charge the towing EV's battery pack.
86. The method of example 73 further comprising towing upon the towed upon Powered Watercraft EV with use of a trailer equipped with regenerative trailer brakes, and using electrical energy generated by the trailer's regenerative brakes to charge the towing EV's battery pack.
87. The method of example 76 further comprising towing upon the towed upon Powered Watercraft EV with use of a trailer equipped with regenerative trailer brakes, and using electrical energy generated by the trailer's regenerative brakes to charge the towing EV's battery pack.
88. The method of example 79 further comprising steps of obtaining electrical energy for the charging of the battery of the towed upon Powered Watercraft EV by steps including towing upon the towed upon Powered Watercraft EV with use of a trailer equipped with regenerative trailer brakes, and using electrical energy generated by the trailer's regenerative brakes to charge the towed upon Powered Watercraft EV's battery pack.
89. The method of example 80 further comprising steps of obtaining electrical energy for the charging of the battery of the towed upon Powered Watercraft EV by steps including towing upon the towed upon Powered Watercraft EV with use of a trailer equipped with regenerative trailer brakes, and using electrical energy generated by the trailer's regenerative brakes to charge the towed upon Powered Watercraft EV's battery pack.
90. The method of example 81 further comprising steps of obtaining electrical energy for the charging of the battery of the towing EV by steps including towing upon the towed upon Powered Watercraft EV with use of a trailer equipped with regenerative trailer brakes, and using electrical energy generated by the trailer's regenerative brakes to charge the towing EV's battery pack.
91. The method of example 82 further comprising steps of obtaining electrical energy for the charging of the battery of the towed upon Powered Watercraft EV by steps including towing upon the towed upon Powered Watercraft EV with use of a trailer equipped with regenerative trailer brakes, and using electrical energy generated by the trailer's regenerative brakes to charge the towed upon Powered Watercraft EV's battery pack.
92. The method of example 70 further comprising towing upon the towed upon Powered Watercraft EV with use of a trailer equipped with regenerative trailer brakes, and using electrical energy generated by the trailer's regenerative brakes to charge the towed upon Powered Watercraft EV's battery pack.
93. The method of example 70 further comprising assembling a trailer capable of carrying a plurality of EVs and also capable of being attached to and towed upon by the first EV, and further selecting to equip the trailer with electronic components enabling the first EV to use battery charge of the plurality of EVs carried by the trailer.
94. A method for assembling a trailer capable of carrying at least a Powered Watercraft EV and also capable of being attached to and towed upon by another EV that is a wheeled EV whose wheels are in contact with a road, the method comprising selecting to equip the trailer with electronic components enabling the another EV to use battery charge of the at least a Powered Watercraft EV carried by the trailer.
95. A method for assembling a trailer capable of carrying at least a plurality of Powered Watercraft EVs and also capable of being attached to and towed upon by another EV that is a wheeled EV whose wheels are in contact with a road, and further selecting to equip the trailer with electronic components enabling the another EV to use battery charge of the at least a plurality of Powered Watercraft EVs carried by the trailer.
96. A method of assembling a first EV that is a wheeled EV having at least a an electric drive system including a battery pack and a motor controller, the method including steps of selecting to equip the first EV with electronic components enabling it to use battery charge contained in a battery pack of at least a Powered Watercraft EV that it tows upon to power the motor controller of the first EV while the first EV is in motion and towing a trailer upon at least a portion of which is removably situated the at least a Powered Watercraft EV.
97. A method of assembling a first EV that is a wheeled EV having at least an electric drive system comprising a battery pack and a motor controller, the method including steps of selecting to equip the first EV with electronic components enabling it to use battery charge contained in battery packs of at least a plurality of Powered Watercraft EVs that it tows upon to charge the battery of the first EV while the first EV is in motion and towing a trailer upon at least portions of which are removably situated the at least a plurality of Powered Watercraft EVs.
98. The method of example 96 further comprising selecting to equip the first EV with electronic components enabling it to use charge contained in the battery pack of the at least a Powered Watercraft EV that it tows to charge the battery of the first EV while the first EV is in motion and towing the trailer upon at least a portion of which is removably situated the at least a Powered Watercraft EV.
99. The method of example 97 further comprising selecting to equip the first EV with electronic components enabling it to use while the first EV is in motion and towing upon the trailer upon at least portions of which are removably situated the at least a plurality of Powered Watercraft EVs battery charge contained in the battery packs of the at least a plurality of Powered Watercraft EVs to power the motor controller system of the first EV.
100. The method of example 78 further comprising equipping the first EV with electronic components enabling it to determine when it needs to use charge contained in the battery pack of the at least a Powered Watercraft EV that it tows upon in order to reach a certain destination while retaining a minimum desired amount of battery charge in the first EV.
101. The method of example 100 further comprising equipping the first EV with electronic components enabling it to determine when it needs to use charge contained in battery packs of the at least a plurality of Powered Watercraft EVs that it tows upon in order to reach a certain destination while retaining a minimum desired amount of battery charge in the first EV.
102. The method of example 96 further comprising equipping the first EV with electronic components that permits it to route battery charge from its own battery to the battery of the at least a Powered Watercraft EV that it tows upon.
103. The method of example 97 further comprising equipping the first EV with electronic components that permits it to route battery charge from its own battery to batteries of the at least plurality of Powered Watercraft EVs that it tows upon.
104. The method of example 102 further comprising equipping the first EV with electronic components that permits it to route battery charge contained in a battery pack of at least a Powered Watercraft EV that it tows upon when the first EV's battery pack is any of:
(I) below a charge level that would permit the first EV to reach a planned destination;
(ii) below a charge level that would permit the first EV to both reach the planned destination as well as to reach a second planned destination.
105. The method of example 103 further comprising equipping the first EV with electronic components that permits it to route battery charge contained in a battery pack of the at least plurality of Powered Watercraft EVs that it tows upon when the first EV's battery pack is any of:
(I) below a charge level that would permit the first EV to reach a planned destination;
(ii) below a charge level that would permit the first EV to both reach the planned destination as well as to reach a second planned destination.
106. A method for powering an electrical component of a first EV selected from a group comprising a motor controller of the first EV; and, a charging system of the first E EV, the first EV configured to be capable of trailering a plurality of other EVs, the method comprising steps of configuring the first EV to be capable of using charge from a battery of at least some of the plurality of other EVs to either or both power the motor controller of the first EV and/or to charge the battery of the first EV.
107. The method of example 105 further comprising equipping the first EV with electronic components that permits it to utilize electrical energy generated by regenerative brakes equipping a trailer that the first EV tows upon and upon which is carried the at least a plurality of Powered Watercraft EVs, and permitting the first EV to selectively direct electrical energy generated by the trailer's regenerative brakes to either its own battery pack or to battery packs of the at least a plurality of Powered Watercraft EVs depending upon whether or not the first EV's battery pack is considered sufficiently charged to permit the first EV to reach at least the planned destination, the electronic components directing and/or supplying electrical energy from the trailer's regenerative brakes to the first EV's battery when the first EV's battery is any of:
(I) below a charge level that would permit the first EV to reach a planned destination;
(ii) below a charge level that would permit the first EV to both reach the planned destination as well as to reach a second planned destination.
108. The method of example 106 wherein the electronic components equipped to the first EV selectively direct electrical energy from the trailer's regenerative brakes to the at least one towed upon Powered Watercraft EV's battery when the at least one towed upon Powered Watercraft EV's battery has insufficient charge to be considered fully charged and when the first EV's battery is any of:
(I) at or above a charge level that would permit the towing EV to reach its planned destination;
(ii) at or above a charge level that would permit the towing EV to both reach its planned destination as well as to reach the second planned destination.
109. The method of example 102 wherein the electronic components equipped to the first EV selectively direct electrical energy from the trailer's regenerative brakes to at least one battery of the batteries of the at least a plurality of towed upon Powered Watercraft EV's when the at least one battery of the at least a plurality of towed upon Powered Watercraft EV's batteries has insufficient charge to be considered fully charged and when the first EV's battery is any of:
(I) at or above a charge level that would permit the towing EV to reach its planned destination;
(ii) at or above a charge level that would permit the towing EV to both reach its planned destination as well as to reach the second planned destination.
110. A method for assembling a first EV having wheels and capable of towing at least a trailer capable of carrying at least a Powered Watercraft EV, the method including steps of selecting to configure the first EV to be capable of Bi-directional charging and selecting to enable the Bi-directional charging capability of the first EV to be electrically communicative through a charge port as well as through a trailer plug distinct from the charge port, where the trailer plug is located proximal the rear of the EV.
111. An EV capable of Bi-directional charging and having wheels and capable of towing at least a trailer, the EV comprising a trailer plug electrically connected to the Bi-directional charging electrical architecture of the EV.
112. The EV of example 11 where the trailer plug is located proximal the rear of the EV.
113. The EV of example 111 further comprising a charge port separate and distinct from the trailer plug, the charge port also connected to the Bi-directional charging electrical architecture of the EV.
114. The EV of example 112 further comprising a charge port separate and distinct from the trailer plug, the charge port also connected to the Bi-directional charging electrical architecture of the EV.
115. A method for forming an EV having Bi-directional charging capability, the method comprising selecting to enable accessing the EV's Bi-directional charging capability through any of (I) a regular charge port, and, (ii) a distinct trailer plug 11, 11′.
116. A method of producing Powered Watercraft EVs comprising producing the Powered Watercraft EVs in pairs where one Powered Watercraft EV of the pair has a charge port located on its left side and the other Powered Watercraft EV of the pair has its charge port located on the right side.
117. A trailer equipped with a control unit configured at least to permit routing of electrical energy to at least one Powered Watercraft EV mounted upon the trailer, where said electrical energy is sourced from a battery pack of an EV configured to be capable of towing upon the trailer.
118. The trailer of example 117 where the control unit is further configured to permit routing of the electrical energy to at least a plurality of Powered Watercraft EVs mounted upon the trailer.
119. The trailer of example 117 where the trailer is equipped with regenerative brakes that are configured to provide electrical energy generated by the regenerative brakes to at least a Powered Watercraft EV mounted upon the trailer.
120. The trailer of example 118 where the trailer is equipped with regenerative brakes that are configured to provide electrical energy generated by the regenerative brakes to the at least a plurality of Powered Watercraft EVs mounted upon the trailer.
121. A first EV comprising a control unit configured to at least cause other equipment integral the first EV to at least receive and employ electrical energy from a battery of at least a Powered Watercraft EV at least so as to charge the battery of the first EV with electrical energy from the battery of the at least a Powered Watercraft EV.
122. The first EV of example 121 where the first EV is further configured to be capable of providing electrical energy from the first EV's battery to the battery of the at least a Powered Watercraft EV so as to at least charge the battery of the at least a Powered Watercraft EV with electrical energy from the battery of the first EV.
123. The first EV of example 121 where the first EV additionally comprises an electrical connector at least configured to at least receive electrical energy from the battery of the at least a Powered Watercraft EV towed by the first EV.
124. The first EV of example 122 where the first EV additionally comprises an electrical connector at least configured to at least transmit electrical energy to the battery of the at least a Powered Watercraft EV towed by the first EV.
125. The first EV of example 123 where the electrical connector is in at least electrical communication with at least the control unit of the first EV.
126. The first EV of example 124 where the electrical connector is in at least electrical communication with at least the control unit of the first EV.
127. The first EV of example 123 where the electrical connector comprises a trailer plug.
128. The first EV of example 124 where the electrical connector comprises a trailer plug.
129. The first EV of example 127 wherein the trailer plug comprises an electrical harness comprising a plurality of distinct electrical conductors each capable of connecting to at least one distinct electrical conductor in communication with at least one of a plurality of electrical features of a trailer.
130. The first EV of example 127 wherein the trailer plug comprises an electrical harness comprising a plurality of distinct electrical conductors each capable of connecting to at least one distinct electrical conductor in communication with at least one of a plurality of electrical features of a trailer.
131. The first EV of example 129 where at least one of the at least one of a plurality of electrical features of a trailer for which the first EV's trailer plug's electrical harness comprises at least one of its plurality of electrical connectors is a charge port for at least one Powered Watercraft EV removably situated upon the at least a portion of the trailer.
132. The first EV of example 129 wherein electrical features of the at least one of a plurality of electrical features of a trailer for which the first EV's trailer plug's electrical harness comprises a plurality of distinct electrical connectors are a plurality of distinct charge ports that each is for at least one distinct Powered Watercraft EV from a plurality of distinct Powered Watercraft EVs.
133. The first EV of example 130 where at least one of the at least one of a plurality of electrical features of a trailer for which the first EV's trailer plug's electrical harness comprises at least one of its plurality of electrical connectors is a charge port for at least one Powered Watercraft EV removably situated upon the at least a portion of the trailer.
134. The first EV of example 130 wherein electrical features of the at least one of a plurality of electrical features of a trailer for which the first EV's trailer plug's electrical harness comprises a plurality of distinct electrical connectors are a plurality of distinct charge ports that each is for at least one distinct Powered Watercraft EV from a plurality of distinct Powered Watercraft Evs.
135. The first EV of any one of examples 123-126 wherein the electrical connector additionally is capable of forming electrical communication with an electrical cable capable of transmitting electrical energy generated by regenerative brakes that are capable of being regenerative trailer brakes.
136. The first EV of example 135 wherein the first EV's control unit is configured to be capable of selectively causing routing of electrical energy generated by regenerative trailer brakes selectively to either the battery of the first EV or to the battery of the at least one Powered Watercraft EV removably situated upon the at least a portion of the trailer.
137. The first EV of example 136 where the first EV's control unit is configured to ascertain whether or not the battery of the first EV or the battery of the at least one Powered Watercraft EV removably situated upon the at least a portion of the trailer is most in need of charging and to be capable of causing electrical energy generated by regenerative trailer brakes to be routed to whichever battery is most in need of charging.
138. The first EV of example 137 where the first EV's control unit is configured to determine the charge level of the battery of the first EV and the charge level of the battery of the at least one Powered Watercraft EV removably situated upon the at least a portion of the trailer, and to be capable of causing electrical energy generated by regenerative trailer brakes to be routed to whichever of such batteries the first EV's control unit has determined has the least charge level.
139. The first EV of example 137 where the first EV's control unit is configured to determine whether to or not to route electrical energy generated by regenerative trailer brakes to the battery of the first EV depending upon whether or not the charge level of the first EV's battery is sufficient to permit the first EV to reach at least one predetermined destination without requiring a recharge event.
140. The first EV of example 139 where the first EV's control unit is configured to determine whether or not the charge level of the first EV's battery is sufficient to permit the first EV to reach the at least one predetermined destination without requiring a recharge event by steps comprising: ascertaining the rate of charge consumption while the first EV is actively towing upon a trailer upon at least a portion of which is removably situated the at least one Powered Watercraft EV; ascertaining the distance to the at least one predetermined destination from when it has ascertained the rate of charge consumption; calculating the charge level needed to reach the at least one predetermined destination factoring in the ascertained rate of charge consumption; comparing the ascertained charge level needed to the actual charge level of the first EV's battery; and, (a) when the first EV's battery charge level is lesser than the actual charge level needed routing electrical energy generated by the regenerative trailer brakes to the battery of the first EV; and, (b) when the first EV's battery meets or exceeds the ascertained charge level needed routing electrical energy generated by the regenerative trailer brakes to the battery of the at least one Powered Watercraft EV removably situated upon the at least a portion of the trailer.
141. The first EV of example 139 wherein the control unit is capable of receiving input identifying the at least one predetermined destination from a portion of the first EV's computer system which is designed and configured to permit a human operator to input data identifying the at least one predetermined destination.
142. The first EV of example 140 wherein the control unit is capable of receiving input identifying the at least one predetermined destination from a portion of the first EV's computer system which is designed and configured to permit a human operator to input data identifying the at least one predetermined destination.
143. The first EV of any one of examples 121 to 142 where the first EV is configured to be readily adaptable to be capable of towing upon a conventional trailer using a conventional trailer hitch.
144. The first EV of any one of examples 121 to 142 where the first EV is configured to be capable of towing upon a trailer.
145. The first EV of any one of examples 121 to 142 where the first EV is configured to tow upon a trailer.
146. The first EV of any one of examples 121 to 145 where the first EV is configured to be capable of Bi-directional charging, and configured to be capable of charging a Powered Watercraft EV, and further is configured to be capable of being charged by a Powered Watercraft EV.
147. The first EV of any one of examples 121 to 145 where the first EV is configured to be capable of Bi-directional charging, and configured to be capable of charging a Powered Watercraft EV, and configured to be capable of being charged by a Powered Watercraft EV, and further is configured to be capable of being charged from a charger through a charge port located on the first EV and is configured to be capable of simultaneously charging any of a group selected from: (I) the at least one Powered Watercraft EV; (ii) at least one of the at least a plurality of Powered Watercraft EVs; and (iii) the at least a plurality of Powered Watercraft EVs, while it is receiving charge from the charger.
148. The at least one Powered Watercraft EV of any one of examples 121 to 145 where the at least one Powered Watercraft EV is configured to be capable of Bi-directional charging, and configured to be capable of charging an EV, and further is configured to be capable of being charged by an EV.
149. At least one of at least a plurality of Powered Watercraft EVs of any one of examples 121 to 145 where the at least one of at least a plurality of Powered Watercraft EV is configured to be capable of Bi-directional charging, and configured to be capable of charging an EV, and further is configured to be capable of being charged by an EV.
150. A trailer comprising a battery charge sharing unit configured to be connectable to at least one Powered Watercraft EV capable of being mounted upon the trailer, the trailer's battery charge sharing unit additionally configured to communicate through a trailer plug with an EV capable of towing upon the trailer.
151. A trailer comprising a regenerative braking system, the trailer capable of carrying at least one Powered Watercraft EV, the regenerative braking system configured to be capable of routing electrical energy generated by the regenerative braking system to an EV capable of towing upon the trailer so as to charge a battery of an EV capable of towing upon the trailer.
152. The trailer of example 151 wherein the regenerative braking system additionally is configured to be capable of routing electrical energy generated by the regenerative braking to at least one Powered Watercraft EV capable of being mounted upon the trailer so as to charge the battery of the at least one Powered Watercraft EV.
153. The trailer of example 152 further configured to route electrical energy generated by the regenerative brakes to at least a plurality of Powered Watercraft EVs capable of being mounted upon the trailer so as to at least charge batteries of the at least a plurality of Powered Watercraft EVs.
154. The trailer of example 153 additionally comprising a plurality of charge ports where each charge port is configured to be capable of electrically connecting to a charge port of one of the at least a plurality of Powered Watercraft EVs capable of being mounted upon the trailer.
155. A method for charging a battery of a first EV, the first EV configured to be capable of towing upon at least one Powered Watercraft EV, the method comprising steps of configuring the first EV to be capable of using charge from a battery of the at least one Powered Watercraft EV to charge the battery of the first EV.
156. The method of example 155 further comprising configuring the first EV to be capable of using charge from the battery of the at least one Powered Watercraft EV to charge the battery of the first EV while the first EV is actively towing upon the at least one Powered Watercraft EV including at speeds from normal road speeds to highway speeds.
157. The method of example 156 further comprising configuring the first EV to be capable of first routing electrical energy from the battery of the at least one Powered Watercraft EV to a equipment that ensures that the electrical energy is compatible with the electrical architecture and/or the voltage architecture of the first EV.
158. The method of example 156 further comprising configuring the first EV to be capable of first routing electrical energy from the battery of the at least one Powered Watercraft EV to a equipment that ensures that the electrical energy of the at least one Powered Watercraft EV is useable by the first EV without causing any harm to the first EV and its electrical architecture and/or its voltage architecture.
159. The method of example 155 further comprising steps of configuring the first EV to further be capable of charging the battery of the at least one Powered Watercraft EV by ceasing to use battery charge from the at least one Powered Watercraft EV to charge the battery of the first EV, and then using charge from the battery of the first EV to charge the battery of the at least one Powered Watercraft EV.
160. The method of example 158 further comprising steps of configuring the first EV to further be capable of charging the battery of the at least one Powered Watercraft EV by ceasing to use battery charge from the at least one Powered Watercraft EV to charge the battery of the first EV, and then using charge from the battery of the towing EV to charge the battery of the at least one Powered Watercraft EV.
161. The method of example 160 comprising subsequent steps of configuring the first EV to be capable of, upon determining that the battery of the towing EV needs to be charged in order to reach a certain destination, ceasing to charge the battery of the at least one Powered Watercraft EV and using the battery charge of the at least one Powered Watercraft EV to charge the battery of the first EV.
162. The method of example 159 further comprising configuring the first EV to be capable of ceasing using charge from the battery of the at least one Powered Watercraft EV to charge the battery of the first EV when an onboard computing device of the first EV receives input identifying a desired destination, the method further comprising configuring the onboard computing device to calculate the rate of charge consumption of the first EV during towing of the at least one Powered Watercraft EV toward the desired destination; identifying from said calculation how much battery charge level is required to reach the desired destination; comparing the identified required level of battery charge to the actual charge level of the first EV's battery in order to make a determination as to whether or not sufficient charge exists in the first EV's battery to reach the desired destination; and when the determination is that sufficient charge does exist to reach the desired destination, consequently routing battery charge from the first EV's battery to the battery of the at least one Powered Watercraft EV.
163. The method of example 162 further comprising steps of configuring the first EV to be capable of, prior to the step of consequently routing battery charge from the first EV to the battery of the at least one Powered Watercraft EV, first determining that the battery of the at least one Powered Watercraft EV is not fully charged.
164. The method of example 155 further comprising configuring the first EV to be capable of towing upon the at least one Powered Watercraft EV with use of a trailer.
165. The method of example 155 further comprising configuring the first EV to be capable of towing upon the at least one Powered Watercraft EV with use of a trailer equipped with regenerative trailer brakes, and, further, to be capable of using electrical energy generated by the trailer's regenerative brakes to charge the first EV's battery pack.
166. The method of example 156 further comprising configuring the first EV to be capable of towing upon the at least one Powered Watercraft EV with use of a trailer equipped with regenerative trailer brakes, and to be capable of using electrical energy generated by the trailer's regenerative brakes to charge the first EV's battery pack.
167. The method of example 158 further comprising configuring the first EV to be capable of towing upon the at least one Powered Watercraft EV with use of a trailer equipped with regenerative trailer brakes, and to be further capable of using electrical energy generated by the trailer's regenerative brakes to charge the first EV's battery pack.
168. The method of example 159 further comprising steps of configuring the first EV to be capable of obtaining electrical energy for the charging of the battery of the at least one Powered Watercraft EV by steps including towing upon the at least one Powered Watercraft EV with use of a trailer equipped with regenerative trailer brakes, and using electrical energy generated by the trailer's regenerative brakes to make available to the at least one Powered Watercraft EV electrical energy suitable to charge the at least one Powered Watercraft EV's battery pack.
169. The method of example 160 further comprising steps of configuring the first EV to be capable of obtaining electrical energy for the charging of the battery of the at least one Powered Watercraft EV by steps including towing upon the at least one Powered Watercraft EV with use of a trailer equipped with regenerative trailer brakes, and using electrical energy generated by the trailer's regenerative brakes to make available to the at least one Powered Watercraft EV electrical energy suitable to charge the at least one Powered Watercraft EV's battery pack.
170. The method of example 161 further comprising steps of configuring the first EV to be capable of obtaining electrical energy for the charging of the battery of the towing EV by steps including the first EV towing upon the at least one Powered Watercraft EV with use of a trailer equipped with regenerative trailer brakes, and using electrical energy generated by the trailer's regenerative brakes to charge the towing EV's battery pack.
171. The method of example 162 further comprising steps of configuring the first EV to be capable of obtaining electrical energy for the charging of the battery of the at least one Powered Watercraft EV by steps including towing upon the at least one Powered Watercraft EV with use of a trailer equipped with regenerative trailer brakes, and using electrical energy generated by the trailer's regenerative brakes to charge the at least one Powered Watercraft EV's battery pack.
172. The method of example 155 further comprising configuring the first EV to be capable of towing upon the at least one Powered Watercraft EV with use of a trailer equipped with regenerative trailer brakes, and using electrical energy generated by the trailer's regenerative brakes to charge the at least one Powered Watercraft EV's battery pack.
173. A method for powering an electrical component of a first EV selected from a group comprising a motor controller of the first EV; and, a charging system of the first EV, the first EV configured to be capable of trailering a plurality of other EVs, the method including steps of configuring the first EV to be capable of using charge from a battery of at least some of the plurality of other EVs to either or both power the motor controller of the first EV and/or to charge the battery of the first EV, the method further comprising steps of assembling a trailer capable of carrying a plurality of other EVs and also capable of being attached to and towed upon by the first EV, and further selecting to equip the trailer with electronic components enabling the first EV to use battery charge from at least the battery packs of multiple of the plurality of other EVs carried by the trailer to either or both power the motor controller of the first EV and/or to charge the battery of the first EV.
174. The method of example 173 further comprising selecting to equip the trailer with electronic components enabling the first EV to use battery charge of the plurality of other EVs carried by the trailer to power the motor controller of the first EV.
175. The method of example 173 further comprising selecting to equip the trailer with electronic components enabling the first EV to use battery charge of the plurality of EVs carried by the trailer to power the motor controller of the first EV while the first EV is in use and in motion towing upon the trailer upon at least portions of said trailer are removably situated the plurality of EVs.
176. A method for powering an electrical component of a first EV, the first EV configured to be capable of towing upon at least one other EV, the method including steps of configuring the first EV to be capable of using charge from a battery of the at least one other EV to charge the battery of the first EV, the method comprising steps of assembling a trailer capable of carrying a plurality of EVs and also capable of being attached to and towed upon by the first EV, and further selecting to equip the trailer with electronic components enabling the first EV to use battery charge of the plurality of EVs carried by the trailer to power the motor controller of the first EV.
177. The method of example 176 further comprising selecting to equip the trailer with electronic components enabling the first EV to use battery charge of the plurality of EVs carried by the trailer to power the motor controller of the first EV while the first EV is in use and in motion towing upon the trailer upon at least portions of which are removably situated the plurality of EVs.
178. The method of example 176 further comprising selecting to equip the trailer with electronic components enabling the first EV to use battery charge of the plurality of EVs carried by the trailer to charge the battery of the first EV.
179. The method of example 178 further comprising selecting to equip the trailer with electronic components enabling the first EV to use battery charge of the plurality of EVs carried by the trailer to charge the battery of the first EV while the first EV is in use and in motion towing upon the trailer upon at least portions of which are removably situated the plurality of EVs.
180. A method for extending the range a first EV is capable of travelling in the event of towing by the first EV of a second EV that is a Powered Watercraft EV, the first EV having at least a primary propulsion apparatus comprising an electric drive system configured to use energy stored in an onboard battery pack and/or batteries to power wheels of the first EV, the Powered Watercraft EV having at least a primary propulsion apparatus comprising an electric drive system configured to use energy stored in an onboard battery pack and/or batteries, the method comprising configuring the first EV to be capable of towing upon a trailer that is capable of having removably situated upon at least a portion of the trailer at least one Powered Watercraft EV, the method further comprising steps of configuring the first EV to be capable of using charge from a battery of the at least one Powered Watercraft EV removably situated upon the at least a portion of the trailer to either or both (a) charge the battery of the towing EV during towing of the at least one Powered Watercraft EV by the first EV; and, (b) power the electrical motor and/or motor controller of the first EV during towing of the at least one Powered Watercraft EV by the first EV.
181. The method of example 180 further comprising configuring the first EV to be capable of using the charge from the battery of the towed upon Powered Watercraft EV removably situated upon the at least a portion of the trailer to charge the battery of the first and towing EV while the first and towing EV either is: (a) not in motion; and, (b) is actively towing upon the towed upon Powered Watercraft EV removably situated upon the at least a portion of the trailer including at speeds from normal road speeds to highway speeds.
182. The method of example 181 further comprising configuring the first EV to be capable of routing electrical energy from the battery of the at least one Powered Watercraft EV removably situated upon the at least a portion of the trailer to equipment that ensures that the electrical energy is compatible with the electrical architecture and the voltage architecture of the first EV.
183. The method of example 180 further comprising configuring the first EV to further be capable of determining when the battery of the first EV has reached and/or is in a desired state-of-charge, and upon making such determination to be capable of using charge from the battery of the first EV to charge the battery of the at least one Powered Watercraft EV removably situated upon the at least a portion of the trailer while (a) the first EV is not in motion (i.e. is stationary); and, (b) during towing of the at least one Powered Watercraft EV by the first EV.
184. The method of any of examples 180 to 183 further comprising configuring the first EV to have a trailer plug, and further comprising configuring the trailer plug to be capable of transmitting electrical energy from the battery of the at least one Powered Watercraft EV removably situated upon the at least a portion of the trailer to any of: (a) the battery of the first EV; and (b) the electrical motor and/or motor controller of the first EV.
185. The method of example 184 further comprising configuring the trailer plug to be capable of transmitting electrical energy from the battery of the first EV to the battery of the at least one Powered Watercraft EV removably situated upon the at least a portion of the trailer in order to charge the battery of the at least one Powered Watercraft EV.
186. The method of any of examples 180 to 183 further comprising configuring the first EV to be capable of charging the battery of the at least one Powered Watercraft EV removably situated upon the at least a portion of the trailer while the first EV is not in motion and is connected to a charger, the method further comprising configuring the first EV to have a trailer plug, and further comprising configuring the trailer plug to be capable of transmitting charge to the battery of the at least one Powered Watercraft EV.
187. The method of any of examples 184 to 185 further comprising configuring the first EV to be capable of charging the battery of the at least one Powered Watercraft EV removably situated upon the at least a portion of the trailer while the first EV is not in motion and is connected to a charger, the method further comprising configuring the first EV's trailer plug to be capable of transmitting charge to the battery of the at least one Powered Watercraft EV.
188. The method of any one of examples 186 and 187. further comprising configuring the first EV to be capable to transmitting electrical energy from a charger directly to the at least one Powered Watercraft EV removably situated upon the at least a portion of the trailer through the trailer plug of the first EV.
189. The method of any one of examples 186 and 187. further comprising configuring the first EV to be capable ascertaining that the battery of the first EV is in a desired state-of-charge and upon making such determination to be capable of transmitting electrical energy from a charger to the at least one Powered Watercraft EV removably situated upon the at least a portion of the trailer without first transmitting the electrical energy from the charger through the battery of the first EV.
190. The method of any one of examples 189 to 189 further comprising configuring the first EV to have a battery charge sharing unit configured to ensure that electrical energy from the first EV flowing to the at least one Powered Watercraft EV removably situated upon the at least a portion of the trailer is compatible with the electrical architecture of the at least one Powered Watercraft EV.
191. The method of any one of examples 180 to 189 further comprising configuring the first EV to have a battery charge sharing unit configured to ensure that electrical energy from the at least one Powered Watercraft EV removably situated upon the at least a portion of the trailer flowing to the first EV is compatible with the electrical architecture of the first EV.
192. The method of any one of examples 180 to 182 further comprising configuring the first EV to further be capable of determining when the battery of the first EV has reached and/or is in a desired state of charge, and upon making such determination to be capable of using charge from the battery of the first EV to charge the battery of the at least one Powered Watercraft EV removably situated upon the at least a portion of the trailer.
193. The method of any one of examples 180 to 192 further comprising configuring the first EV to further be capable of determining when the battery of the at least one Powered Watercraft EV removably situated upon the at least a portion of the trailer has reached and/or is in a desired state-of-charge, and upon making such determination to be capable of using charge from the battery of the at least one Powered Watercraft EV to either (a) charge the battery of the first EV; and, (b) to power the electrical motor and/or motor controller of the first EV.
194. The method of any one of examples 180 to 191 further comprising configuring the first EV to further be capable of determining when the battery of the first EV has reached and/or is in a desired state-of-charge, and upon making such determination to be capable of selecting to use and direct charge from a charger plugged into a charge port of the first EV to charge the battery of the at least one Powered Watercraft EV removably situated upon the at least a portion of the trailer.
195. The method of any one of examples 180 to 192 further comprising configuring the first EV to further be capable of determining when the battery of the at least one Powered Watercraft EV removably situated upon the at least a portion of the trailer has reached and/or is in a desired state-of-charge, and upon making such determination to be capable of selecting to use and direct charge from a charger plugged into a charge port of the first EV to charge the battery of the first EV.
196. The method of any one of examples 180 to 195 further comprising configuring the first EV to be capable of receiving electrical energy from the at least one Powered Watercraft EV removably situated upon the at least a portion of the trailer by means of Vehicle to Vehicle Charging in order to power the electrical motor and/or motor controller of the first EV during towing of the at least one Powered Watercraft EV by the first EV.
197. The method of any one of examples 180 to 196 further comprising configuring the first EV to have a battery charge sharing unit comprising a controller configured to ensure that electrical energy transmitted from the at least one Powered Watercraft EV removably situated upon the at least a portion of the trailer to the first EV is compatible with the voltage architecture and/or electrical architecture of the first EV.
198. The method of any one of examples 180 to 196 further comprising configuring the first EV to have a battery charge sharing unit comprising a controller configured to ensure that electrical energy transmitted from the first EV to the at least one Powered Watercraft EV removably situated upon the at least a portion of the trailer is compatible with the voltage architecture and/or electrical architecture of the at least one Powered Watercraft EV.
199. The method of example 198 where the electrical energy transmitted from the first EV to the at least one Powered Watercraft EV removably situated upon the at least a portion of the trailer is electrical energy transmitted from the battery of the first EV to the at least one Powered Watercraft EV.
200. The method of example 198 where the electrical energy transmitted from the first EV to the at least one Powered Watercraft EV removably situated upon the at least a portion of the trailer is electrical energy transmitted from regenerative brakes of the first EV to the at least one Powered Watercraft EV.
201. The method of example 198 where the electrical energy transmitted from the first EV to the at least one Powered Watercraft EV removably situated upon the at least a portion of the trailer is electrical energy transmitted from a charger plugged into the first EV directly to the at least one Powered Watercraft EV along conductors contained in the first EV that bypass the battery of the first EV.
202. The method of any one of examples 198 to 201 where electrical energy transmitted between the first EV and the at least one Powered Watercraft EV removably situated upon the at least a portion of the trailer is transmitted through a trailer plug integral with the first EV, where the trailer plug integral with the first EV is designed to mate with an electrical plug that is attached to a trailer upon which the at least one Powered Watercraft EV is carried, and where such electrical plug that is attached to trailer upon which the at least one Powered Watercraft EV is carried is connected to both the electrical equipment of the trailer as well as to a charge plug that is capable of connecting to a charge port integral with the at least one Powered Watercraft EV.
203. The method of any one of examples 180 to 202 further comprising selecting for the first EV an EV selected from a group consisting of an EV Pickup Truck; an EV SUV; and EV Van; and, an EV sedan, the method further comprising selecting for the at least one Powered Watercraft EV removably situated upon the at least a portion of the trailer a Powered Watercraft EV selected from a group consisting of an EV Powerboat; and, and EV Jet Ski.
204. The method of any one of examples 180 to 203 further comprising further configuring the first EV to be capable of receiving and using electrical energy generated by regenerative brakes integral with the trailer towed upon by the first EV just as if said electrical energy was either: (a) generated by regenerative brakes integral with the first EV; and, (b) stored in the first EV's battery.
205. The method of any one of examples 180 to 204 further comprising the additional step of selecting a battery pack for the at least one Powered Watercraft EV that is a battery pack capable of storing and providing electrical energy suitable powering for the motor controller comprising the primary propulsion apparatus of the first EV.
206. A method for transmitting electrical energy from an external charger detachably connected to a first EV to charge either or both a battery of the First EV or a battery of at least one Powered Watercraft EV that is removably situated upon at least a portion of a trailer that is capable of being attached to and towed upon by the first EV, where the first EV is a wheeled EV selected from a group comprising an EV Pickup Truck; an EV SUV; an EV Van; and, an EV sedan, the first EV having at least an electric drive system comprising a battery pack and a motor controller, the at least one Powered Watercraft EV also having at least an electric drive system comprising a battery pack, the method comprising configuring the first EV to be capable of transmitting electrical energy from the external charger that is detachably connected to a charge port of the first EV to the at least one Powered Watercraft EV through a plug and/or connector and/or trailer plug connected to and/or integral with the first EV.
207. The method of example 206 further comprising configuring the first EV to be capable ascertaining that the battery of the first EV is in a desired state-of-charge and upon making such determination to be capable selecting to direct and to transmit electrical energy to the at least one Powered Watercraft EV from the external charger detachably connected to the first EV.
208. The method of any one of examples 206 and 207 further comprising configuring the first EV to be capable ascertaining that the battery of the first EV is in a desired state-of-charge and upon making such determination to be capable selecting to direct and to transmit electrical energy from the charger detachably connected to the first EV directly to the at least one Powered Watercraft EV removably situated upon the at least a portion of the trailer without first transmitting the electrical energy from the external charger through the battery of the first EV.
209. The method of any one of examples 206 and 207 further comprising configuring the first EV to have equipment configured to ensure that electrical energy from the first EV and/or from the external charger detachably connected to the first EV is compatible with the electrical architecture of the at least one Powered Watercraft EV removably situated upon the at least a portion of the trailer.
210. The method of any one of examples 206 to 207 further comprising configuring the trailer to have equipment configured to ensure that electrical energy flowing from the first EV to the at least one Powered Watercraft EV removably situated upon the at least a portion of the trailer is compatible with the electrical architecture of the least one Powered Watercraft EV.
211. The method of any one of examples 206 to 210 further comprising configuring the first EV to further be capable of determining when the battery of the first EV has reached and/or is in a desired state-of-charge, and upon making such determination to be capable of using charge from the battery of the first EV to charge the battery of the at least one Powered Watercraft EV by transmitting electrical energy from the battery of the first EV to the at least one Powered Watercraft EV through a trailer plug integral with the first EV.
212. The method of any one of examples 206 to 211 further comprising configuring the first EV to further be capable of determining when the battery of the first EV has reached and/or is in a desired state-of-charge, and upon making such determination to be capable of selecting to use and direct electrical energy from the external charger detachably connected to the charge port of the first EV to charge the battery of the at least one Powered Watercraft EV removably situated upon the at least a portion of the trailer.
213. The method of any one of examples 206 to 212 further comprising configuring the first EV to further be capable of determining when the battery of the at least one Powered Watercraft EV removably situated upon the at least a portion of the trailer has reached and/or is in a desired state-of-charge, and upon making such determination to be capable of selecting to use and direct electrical energy from the external charger detachably connected to the charge port of the first EV to charge the battery of the first EV.
214. A Powered Watercraft EV comprising an electrical lead electrically connecting a battery of the Powered Watercraft EV to a terminal end of the electrical lead, where said terminal end is configured to be detachably connectable to a connector that is capable of being connected to an EV.
215. The Powered Watercraft EV of example 214 where the electrical lead electrically connecting the battery of the Powered Watercraft EV to the terminal end of the electrical lead is included in a bundle with other electrical conductors used for operating the onboard charging system of the Powered Watercraft EV.
216. The Powered Watercraft EV of any one of examples 213 to 215 where the terminal end of the electrical lead is incorporated into a terminal end configured to serve as the plug end of an electrical bundle and harness of the Powered Watercraft EV's onboard charging system.
217. A Powered Watercraft EV having a port accessible from external the Powered Watercraft EV, the port having at least one electrically conductive structure configured to be detachably mated to a plug, the Powered Watercraft EV comprising an electrical conductor electrically connecting a battery pack of the Powered Watercraft EV to the electrically conductive structure of the port.
218. A Powered Watercraft EV having a charge port configured to permit at least supplying electrical power from a source not integral the Powered Watercraft EV to an onboard charging system of the Powered Watercraft EV, the Powered Watercraft EV comprising an electrical conductor that:
   a) electrically connects a battery pack of the Powered Watercraft EV to the at least one electrically conductive structure of the port integral with the Powered Watercraft EV; and
   b) lacks an electrical connection to the onboard charging system of the Powered Watercraft EV.
219. A wheeled EV having a port accessible from external the wheeled EV, the port having at least one electrically conductive structure configured to be detachably mated to a plug, the wheeled EV comprising an electrical conductor electrically connecting a motor controller of the wheeled EV to the electrically conductive structure of the port.
220. The wheeled EV of example 219 where the port is configured to detachably connect to a pliable electrically conductive cable that is configured with a first terminal end and a second terminal end, the first terminal end of the pliable electrically conductive cable configured to detachably electrically connect and mate to at least an electrically conductive structure of the wheeled EV at its port, the second terminal end of the pliable electrically conductive cable configured to detachably connect and mate to at least an electrically conductive structure of a Powered Watercraft EV at a port integral with the Powered Watercraft EV, the port integral with the Powered Watercraft EV having at least one electrically conductive structure configured to be detachably mated and connected to the second terminal end of the pliable electrically conductive cable, the Powered Watercraft EV comprising an electrical conductor that:
   a) electrically connects a battery pack of the Powered Watercraft EV to the at least one electrically conductive structure of the port integral with the Powered Watercraft EV; and
   b) lacks an electrical connection to the onboard charging system of the Powered Watercraft EV.
221. A wheeled EV having a charge port configured to permit at least supplying electrical power from a source not integral the wheeled EV to an onboard charging system of the wheeled EV, the charge port also configured to detachably connect to a terminal end of a charging cable, the wheeled EV comprising an electrical conductor electrically connecting a motor controller of the wheeled EV to at least a portion of the charge port.
222. The wheeled EV of example 221 where the charge port is configured to detachably connect to a pliable electrically conductive cable that is configured with a first terminal end and a second terminal end, the first terminal end of the pliable electrically conductive cable configured to detachably electrically connect and mate to at least electrically conductive structures of the wheeled EV at its charge port, the second terminal end of the pliable electrically conductive cable configured to detachably connect and mate to at least electrically conductive structures of a Powered Watercraft EV at a charge port integral with the Powered Watercraft EV, the charge port integral with the Powered Watercraft EV configured to permit at least supplying electrical power from a source not integral the Powered Watercraft EV to an onboard charging system of the Powered Watercraft EV, the Powered Watercraft EV comprising an electrical conductor that:
   a) electrically connects a battery pack of the Powered Watercraft EV to at least a portion of the charge port integral with the Powered Watercraft EV; and
   b) lacks an electrical connection to the onboard charging system of the Powered Watercraft EV.
223. A combination of a first EV that is a wheeled EV and a Powered Watercraft EV, the combination comprising an electrical connection between at least a battery pack of the Powered Watercraft EV and at least a motor controller of the first EV.
224. The combination of example 223 further comprising an electrical connection that bypasses an onboard charging system of the Powered Watercraft EV.
225. The combination of any one of examples 223 to 224 further comprising an electrical connection that bypasses an onboard charging system of the first EV.
226. The combination of example 223 further comprising an electrical connection that connects at least an onboard charging system of the Powered Watercraft EV to at least an onboard charging system of the first EV.
227. The combination of example 223 further comprising an electrical connection that connects at least an onboard charging system of the Powered Watercraft EV to at least a motor controller of the first EV.
228. The combination of any one of examples 223 to 227 further comprising a system controller integral the first EV where the system controller is configured to permit the first EV to source electrical energy contained within the battery pack of the Powered Watercraft EV while the first EV is in motion and driving.
229. The combination of any one of examples 223 to 228 further comprising a system controller integral the Powered Watercraft EV where the system controller is configured to permit the first EV to source electrical energy contained within the battery pack of the Powered Watercraft EV while the first EV is in motion and driving.
230. The combination of any one of examples 223 to 229 further comprising a system controller integral the first EV where the system controller is configured to permit the first EV to deliver electrical energy contained within a battery pack of the first EV to the Powered Watercraft EV while the first EV is in motion and driving.
231. The combination of any one of examples 223 to 230 further comprising a system controller integral the Powered Watercraft EV where the system controller is configured to permit the Powered Watercraft EV to source electrical energy contained within a battery pack of the first EV to the Powered Watercraft EV while the first EV is in motion and driving.
232. A method for powering a first EV comprising steps of:
   detachably connecting the first EV to a trailer adapted to detachably connect to at least a Powered Watercraft EV;
   detachably connecting at least a Powered Watercraft EV to the trailer;
   detachably connected at least the Powered Watercraft EV to the first EV in such a fashion so as to connect at least electrical architecture integral the Powered Watercraft EV with electrical architecture integral the first EV;
   sourcing electrical energy contained in at least a battery pack of the Powered Watercraft EV to power at least a motor controller of the first EV.
233. The method of example 232 further comprising configuring a system controller of at least the first EV to permit the first EV to source said electrical energy while the first EV is in motion and driving.
234. The method of any one of examples 232 to 233 further comprising configuring a system controller of at least the Powered Watercraft EV to permit the first EV to source electrical energy from a battery pack of the Powered Watercraft EV while the first EV is in motion and driving.
235. A charger for EVs comprising a shape of a speed bump.
235. The charger of example 235 wherein the speed bump shape is above the level of the surface upon which the EVs are capable of being situated.
236. The charger for EVs of example 235 wherein the charger comprises the shape of a coffin with a ridged top portion, the ridged top portion situated above the level of the surface upon which the EV's are capable of being situated, the ridged top portion shaped as a speed bump.
237. The charger for EVs of example 235 wherein the charger comprises a mushroom shape when viewed in a cross sectional view taken in a plane bisecting the longitudinal axis of the charger, where the upper portion of the charger comprises a ridged top portion situated above the level of the surface upon which the EV's are capable of being situated, the ridged top portion shaped as a speed bump.
238. A charger for EVs comprising a domed shape situated above the level of a surface upon which the EV's are capable of being situated.
239. A parking lot for vehicles, the parking lot comprising external chargers for EVs wherein the external chargers for EVs comprise the shape of a speed bump, wherein the charger is configured so as to be capable of being driven over by the vehicles without incurring damage and without imparting damage to the vehicles.
240. The parking lot of example 239 wherein the parking lot is a parking lot configured for vehicles towing a trailer.
241. The parking lot of example 240 wherein the parking lot is a parking lot configured for trucks.
242. The parking lot of example 240 wherein the parking lot is a parking lot configured for vehicles towing a boat trailer.
243. The parking lot of example 242 wherein the parking lot is a boat launch parking lot.
244. The parking lot of example 239 wherein the parking lot is a parking lot configured for a shopping center.

Although the present disclosure has been described in terms of the presently preferred embodiment, it is to be understood that such disclosure is purely illustrative and is not to be interpreted as limiting. Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art is likely to recognize that the invention may be embodied in other specific forms, for example to adapt to a particular system or apparatus or situation or material or component, without departing from the spirit or essential characteristics thereof, the Therefore, disclosures and descriptions herein are intended to be illustrative, but not limiting, of the scope of the invention. Consequently, without departing from the spirit and scope of the disclosure, various alterations, modifications and/or alternative applications of the disclosure are, no doubt, able to be understood by those ordinarily skilled in the art upon having read the preceding disclosure. Accordingly, it is intended that the following claims be interpreted as encompassing all alterations, modifications or alternative applications as fall within the true spirit and scope of the disclosure.

1.-69. (canceled)

70. A method for powering at least one Power Electronics Controller of a first EV, the method comprising steps of supplying electrical energy from a Powered Watercraft EV's battery pack to the first EV's at least one Power Electronics Controller.

71. The method of claim 70 wherein the Powered Watercraft EV has at least a primary propulsion apparatus comprising an electric drive system having at least the battery pack and configured at least to power at least a propeller and/or impeller of the Powered Watercraft EV.

72. The method of claim 70 wherein the first EV has at least a primary propulsion apparatus comprising an electric drive system comprising at least the battery pack and the Power Electronics Controller, the first EV's electric drive system configured to at least power at least a wheel of the first EV.

73. The method of claim 71 wherein the first EV has at least a primary propulsion apparatus comprising an electric drive system comprising at least the battery pack and the Power Electronics Controller, the first EV's electric drive system configured to at least power at least a wheel of the first EV.

74. The method of claim 72 wherein the first EV's primary propulsion apparatuses battery pack comprises a traction battery.

75. The method of claim 73 wherein the first EV's primary propulsion apparatuses battery pack comprises a traction battery.

76. The method of claim 70 comprising additional steps of selecting to supply the electrical energy from the Powered Watercraft EV's battery pack to the first EV's at least one Power Electronics Controller while the first EV is in motion and driving.

77. The method of claim 71 comprising additional steps of selecting to supply the electrical energy from the Powered Watercraft EV's battery pack to the first EV's at least one Power Electronics Controller while the first EV is in motion and driving.

78. The method of claim 74 comprising additional steps of selecting to supply the electrical energy from the Powered Watercraft EV's battery pack to the first EV's at least one Power Electronics Controller while the first EV is in motion and driving.

79. The method of claim 75 comprising additional steps of selecting to supply the electrical energy from the Powered Watercraft EV's battery pack to the first EV's at least one Power Electronics Controller while the first EV is in motion and driving.

80. The method of claim 74 comprising additional steps of selecting to supply the electrical energy from the Powered Watercraft EV's battery pack to the first EV's at least one Power Electronics Controller while the first EV is in motion and driving.

81. The method of claim 70 comprising additional steps of selecting to supply the electrical energy from the Powered Watercraft EV's battery pack to the first EV's at least one Power Electronics Controller while bypassing the first EV's charging system.

82. The method of claim 71 comprising additional steps of selecting to supply the electrical energy from the Powered Watercraft EV's battery pack to the first EV's at least one Power Electronics Controller while bypassing the first EV's charging system.

83. The method of claim 74 comprising additional steps of selecting to supply the electrical energy from the Powered Watercraft EV's battery pack to the first EV's at least one Power Electronics Controller while bypassing the first EV's charging system.

84. The method of claim 75 comprising additional steps of selecting to supply the electrical energy from the Powered Watercraft EV's battery pack to the first EV's at least one Power Electronics Controller while bypassing the first EV's charging system.

85. The method of claim 78 comprising additional steps of selecting to supply the electrical energy from the Powered Watercraft EV's battery pack to the first EV's at least one Power Electronics Controller while bypassing the first EV's charging system.

86. The method of claim 74 further comprising steps of configuring a system controller of at least the first EV to permit the first EV to source the electrical energy from the battery pack of the Powered Watercraft EV while the first EV is in motion and driving.

87. The method of claim 75 further comprising steps of configuring a system controller of at least the first EV to permit the first EV to source the electrical energy from the battery pack of the Powered Watercraft EV while the first EV is in motion and driving.

88. A method of assembling a first EV that is a wheeled EV having at least an electric drive system including at least a battery pack and a Power Electronics Controller, the method comprising steps of selecting to equip the first EV at least with electronic components enabling it to use battery charge contained in a battery pack of at least a Powered Watercraft EV to power the first EV's Power Electronics Controller.

89. The method of claim 88 further comprising steps of selecting to configure the first EV to be capable of Bi-directional charging and having at least one charge port, the method comprising steps of selecting to enable the Bi-directional charging capability of the first EV to be electrically communicative through another plug distinct from the at least one charge port, where the another plug is located proximal the rear of the EV.

90. The method of claim 89 further comprising configuring the first EV to be capable of transmitting electrical energy from an external charger detachably connected to the at least one charge port of the first EV to charge either or both the battery of the First EV or the battery of the at least one Powered Watercraft EV, the method comprising configuring the first EV to be capable of transmitting electrical energy from the external charger when it is detachably connected to the at least one charge port of the first EV to the at least one Powered Watercraft EV through the another plug and/or connector and/or trailer plug connected to and/or integral with the first EV.
